(19) United States
(12) Patent Application Publication
(10) Pub. No.: US 2016/0253669 A1
(43) Pub. Date: Sep. 1, 2016

(54) METHOD FOR PROVIDING PAYMENT SERVICE AND ELECTRONIC DEVICE THEREOF

(71) Applicant: Samsung Electronics Co., Ltd., Suwon-si (KR)

(72) Inventors: Seokhyun YOON, Yongin-si (KR); Saeah OH, Seoul (KR); Byoungtack ROH, Suwon-si (KR); Yo-Han LEE, Seongnam-si (KR); Seong-Min JE, Suwon-si (KR)

(21) Appl. No.: 15/054,601

(22) Filed: Feb. 26, 2016

Related U.S. Application Data
(60) Provisional application No. 62/126,121, filed on Feb. 27, 2015.

(30) Foreign Application Priority Data
Jan. 29, 2016 (KR) 10-2016-0011127

(51) Int. Cl. G06Q 20/40; G06Q 20/32; G06Q 20/34

(52) U.S. Cl. CPC G06Q 20/4014; G06Q 20/34; G06Q 20/327

(57) ABSTRACT

An electronic device and a method for providing a payment service in the electronic device are provided. The method includes receiving a first user input through an input device of the electronic device, receiving information on at least one of the transaction merchandise or a payment card through a second communication circuit, selecting, after receiving the first user input, one of a plurality of payment cards based on, at least in part, at least one of the received information or a payment history, displaying the selected card on the display, receiving user authentication information through a authentication device, and transmitting, after receiving the authentication information, a magnetic signal, which is generated based on token information, to an external payment device through a first communication circuit and a conductive pattern of the electronic device.

### CROSS REFERENCE TO RELATED APPLICATION(S)

This application claims the benefit under 35 U.S.C. §119(e) of a U.S. provisional patent application filed on Feb. 27, 2015 in the U.S. Patent and Trademark Office and assigned Ser. No. 62/126,121, and under 35 U.S.C. §119(a) of a Korean patent application filed on Jan. 29, 2016 in the Korean Intellectual Property Office and assigned Serial number 10-2016-0011127, the entire disclosure of each of which is hereby incorporated by reference.

### TECHNICAL FIELD

The present disclosure relates to a device and a method for providing a payment service in an electronic device. More particularly, the present disclosure relates to a device and a method for recommending card information that is to be used for payment in the electronic device.

### BACKGROUND

With the development of information communication technology and semiconductor technology, electronic devices have been developed into multimedia devices that provide various services. For example, the portable electronic devices may provide various services, such as a broadcast service, a wireless Internet service, a camera service, or an electronic payment service.

In the case where the user of the electronic device purchases goods at the store, the user may make the payment for the goods by using an electronic card that is registered in the electronic device through the electronic payment service instead of using a physical card (e.g., a credit card).

The above information is presented as background information only to assist with an understanding of the present disclosure. No determination has been made, and no assertion is made, as to whether any of the above might be applicable as prior art with regard to the present disclosure.

### SUMMARY

The user of an electronic device may execute a payment application in order to thereby select a card (e.g., a credit card or a gift card) that is to be used for payment. The electronic device may provide the payment service by using the card that is selected by the user. However, as the number of cards that are registered in the electronic device increases, it is inconvenient for the user of the electronic device to select the card to be used for payment.

Therefore, a need exists for a device and a method for recommending card information that is to be used for payment in the electronic device. Aspects of the present disclosure are to address at least the above-mentioned problems and/or disadvantages and to provide at least the advantages described below. Accordingly, an aspect of the present disclosure is to provide a device and a method for providing a payment service in the electronic device.

Another aspect of the present disclosure is to provide a device and a method for recommending card information that is to be used for payment in the electronic device.

In accordance with an aspect of the present disclosure, an electronic device is provided. The electronic device includes a housing, a display exposed on one side of the housing, an input device integrally formed with the display, mounted on the housing, or wirelessly connected to the electronic device, a user authentication device integrally formed with the display, or mounted on the housing, a conductive pattern positioned inside the housing, and configured to transmit a signal to an external transaction device, a first communication circuit electrically connected to the conductive pattern, a second communication circuit configured to provide at least one of cellular or short-range communication, a processor electrically connected to the display, the authentication device, the first communication circuit, and the second communication circuit, and a memory electrically connected to the processor, and configured to store token information used for payment, wherein the memory stores instructions that, when executed, cause the processor to receive a first user input through the input device, display, after receiving the first user input, in a selected array of a plurality of images representing a plurality of payment cards used for the payment using the first communication circuit, wherein at least one image of the plurality of images is larger in size than other images of the plurality of images, receive a second user input for selecting one of the plurality of images, receive user authentication information through the user authentication device, and transmit, at least partly in response to the second user input and the authentication information, a signal generated based on the token information, to the external transaction device through the first communication circuit and the conductive pattern.

In accordance with another aspect of the present disclosure, an electronic device is provided. The electronic device includes a housing, a display exposed on one side of the housing, an input device integrally formed with the display, mounted on the housing, or wirelessly connected to the electronic device, a user authentication device integrally formed with the display, or mounted on the housing, a conductive pattern positioned inside the housing, and configured to transmit a signal to an external transaction device, a first communication circuit electrically connected to the conductive pattern, a second communication circuit configured to provide at least one of cellular or short-range communication, a processor electrically connected to the display, the user authentication device, the first communication circuit, and the second communication circuit, and a memory electrically connected to the processor, and configured to store token information used for payment and information on a plurality of payment cards, wherein the memory stores instructions that, when executed, cause the processor to receive a first user input through the input device, receive information on at least one of the transaction merchandise or a payment card through the second communication circuit, select, after receiving the first user input, one of the plurality of payment cards based at least partly on at least one of the received information or a payment history, display the selected card on the display, receive user authentication information through the authentication device, and after receiving the authentication information, transmit a signal generated based on the token information, to the external transaction device through the first communication circuit and the conductive pattern.

In accordance with another aspect of the present disclosure, an electronic device is provided. The electronic device includes a housing, a display exposed on one side of the housing, an input device integrally formed with the display, mounted on the housing, or wirelessly connected to the electronic device, a user authentication device integrally formed with the display, or mounted on the housing, a conductive pattern positioned inside the housing, and configured to transmit a signal to an external transaction device, a first communication circuit electrically connected to the conductive pattern, a second communication circuit configured to provide at least one of cellular or short-range communication, a processor electrically connected to the display, the user authentication device, the first communication circuit, and the second communication circuit, and a memory, electrically connected to the processor, and configured to store token information used for payment and information on one or more membership accounts, wherein the memory stores instructions that, when executed, cause the processor to receive a first user input through the input device, receive user authentication information through the authentication device, after receiving the authentication information, transmit a signal generated based on the token information, to the external transaction device through the first communication circuit and the conductive pattern, receive information indicating the completion of payment through the second communication circuit, display, on the display, first information related to a membership account, the first information having been created based on the information indicating the completion of the payment, receive a second user input through the input device, and in response to the second user input, transmit second information related to the membership account through the second communication circuit.

In accordance with another aspect of the present disclosure, a method of operating an electronic device, which includes a display, an input device, a user authentication device, a conductive pattern configured to transmit a magnetic signal to an external payment device, a first communication circuit electrically connected to the conductive pattern, a second communication circuit configured to provide at least one of cellular or short-range communication, a memory, and a processor is provided. The method includes receiving a first user input through the input device, displaying, after receiving the first user input, in a selected array, a plurality of images representing a plurality of payment cards used for the payment by using the first communication circuit such that at least one of the plurality of images is greater than other images, receiving a second user input for selecting one of the plurality of images, receiving user authentication information through the user authentication device, and transmitting, based on, at least in part, the second user input and the authentication information, a magnetic signal, which is generated based on token information, to the external payment device through the first communication circuit and the conductive pattern.

In accordance with another aspect of the present disclosure, a method of operating an electronic device, which includes a display, an input device, a user authentication device, a conductive pattern configured to transmit a magnetic signal to an external payment device, a first communication circuit electrically connected to the conductive pattern, a second communication circuit configured to provide at least one of cellular or short-range communication, a memory, and a processor is provided. The method includes receiving a first user input through the input device, receiving information on at least one of the transaction merchandise or the payment card through the second communication circuit, selecting, after receiving the first user input, one of a plurality of payment cards based on, at least in part, at least one of the received information or a payment history, displaying the selected card on the display, receiving user authentication information through the authentication device, and transmitting, after receiving the authentication information, a magnetic signal, which is generated based on the token information, to the external payment device through the first communication circuit and the conductive pattern.

In accordance with another aspect of the present disclosure, a method of operating an electronic device, which includes a display, an input device, a user authentication device, a conductive pattern configured to transmit a magnetic signal to an external payment device, a first communication circuit electrically connected to the conductive pattern, a second communication circuit configured to provide at least one of cellular or short-range communication, a memory, and a processor is provided. The method includes receiving a first user input through the input device, receiving user authentication information through the authentication device, transmitting, after receiving the authentication information, a magnetic signal, which is generated based on token information, to the external payment device through the first communication circuit and the conductive pattern, receiving information indicating the completion of the payment through the second communication circuit, displaying, on the display, the first information related to a membership account created based on the information indicating the completion of the payment, receiving a second user input through the input device, and transmitting, in response to the reception of the second user input, the second information related to the membership account through the second communication circuit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a block diagram of a network environment according to various embodiments of the present disclosure;

FIG. 2 illustrates a block diagram of an electronic device according to various embodiments of the present disclosure;

FIG. 3 illustrates a block diagram of a program module according to various embodiments of the present disclosure;

FIG. 4 illustrates a block diagram of a rich execution environment (REE) and a trusted execution environment (TEE), which operate in an electronic device according to various embodiments of the present disclosure;

FIGS. 5A to 5C illustrate block diagrams illustrating a hardware configuration of a TEE according to various embodiments of the present disclosure;

FIG. 6 illustrates a block diagram of a payment system according to various embodiments of the present disclosure;

FIG. 7 illustrates a block diagram of a payment system for performing payment according to various embodiments of the present disclosure;

FIG. 8 illustrates a block diagram of a hardware structure of an electronic device that can perform a payment function according to various embodiments of the present disclosure;

FIGS. 9A to 9C illustrate an internal hardware (H/W) block diagram of an electronic device capable of commonly using at least one module among a plurality of magnetic security transmit (MST) modules in common with another short-range communication network device according to various embodiments of the present disclosure;

FIG. 10 illustrates a block diagram of program modules to be executed in an execution environment of an electronic device capable of performing a payment function according to various embodiments of the present disclosure;

FIGS. 11A to 11D illustrate payment user interfaces (UI) of an electronic device according to various embodiments of the present disclosure;

FIG. 12 illustrates a structure for generating a token cryptogram according to various embodiments of the present disclosure;

FIG. 13 illustrates a payment system according to various embodiments of the present disclosure;

FIG. 14 illustrates a flowchart of a token payment according to various embodiments of the present disclosure;

FIG. 15 illustrates a flowchart of payment system elements according to various embodiments of the present disclosure;

FIG. 16A illustrates a flow diagram of a first token issuance operation of an electronic device according to various embodiments of the present disclosure;

FIG. 16B illustrates a flow diagram of a second token issuance operation of an electronic device according to various embodiments of the present disclosure;

FIG. 16C illustrates a flow diagram of a third token issuance operation of an electronic device according to various embodiments of the present disclosure;

FIG. 17 illustrates a flowchart for providing card recommendation information in an electronic device according to various embodiments of the present disclosure;

FIG. 18 illustrates a screen configuration for displaying card recommendation information in an electronic device according to various embodiments of the present disclosure;

FIG. 19 illustrates a flowchart for selecting a recommended card based on location information in an electronic device according to various embodiments of the present disclosure;

FIG. 20 illustrates a flowchart for selecting a recommended card based on a payment history in an electronic device according to various embodiments of the present disclosure;

FIG. 21 illustrates a flowchart for changing a recommended card in an electronic device according to various embodiments of the present disclosure;

FIGS. 22A and 22B illustrate screen configurations for changing a recommended card in an electronic device according to various embodiments of the present disclosure;

FIG. 23 illustrates a flowchart for providing an electronic card list in an electronic device according to various embodiments of the present disclosure;

FIGS. 24A to 24D illustrate screen configurations for displaying an electronic card list in an electronic device according to various embodiments of the present disclosure;

FIG. 25 illustrates a flowchart for providing card information selected based on the location information in an electronic device according to various embodiments of the present disclosure;

FIGS. 26A and 26B illustrate screen configurations for configuring a menu in order to select an electronic card based on location information in an electronic device according to various embodiments of the present disclosure;

FIG. 27 illustrates a flowchart for providing card information that is selected based on a payment history in an electronic device according to various embodiments of the present disclosure;

FIG. 28 illustrates a flowchart for providing an electronic card based on a voice instruction in an electronic device according to various embodiments of the present disclosure;

FIG. 29 illustrates a screen configuration for displaying an electronic card that is selected based on a voice instruction in an electronic device according to various embodiments of the present disclosure;

FIG. 30 illustrates a flowchart for selecting an electronic card based on a voice instruction and location information in an electronic device according to various embodiments of the present disclosure;

FIG. 31 illustrates a flowchart for selecting an electronic card based on a voice instruction and a payment history in an electronic device according to various embodiments of the present disclosure;

FIG. 32 illustrates a flowchart for providing membership information in an electronic device according to various embodiments of the present disclosure;

FIGS. 33A to 33D illustrate screen configurations for displaying membership information in an electronic device according to various embodiments of the present disclosure;

FIG. 34 illustrates a flowchart for providing payment information in an electronic device according to various embodiments of the present disclosure;

FIGS. 35A to 35C illustrate screen configurations of payment information in an electronic device according to various embodiments of the present disclosure; and

FIGS. 36A to 36G illustrate a UI for registering a membership card in an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the expression “have”, “may have”, “include”, or “may include” refers to the existence of a corresponding feature (e.g., a numerical value, a function, an operation, or a constituent element, such as a component), and does not exclude one or more additional features.

Throughout the specification, the expressions “A or B,” “at least one of A or/and B,” “one or more of A or/and B,” and the like may include all combinations of the listed items. For example, “A or B,” “at least one of A and B,” or “at least one of A or B” may refer to all cases of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. The above-described expressions may be used to distinguish an element from another element. For example, a first user device and a second user device indicate different user devices although both of them are user devices. For example, a first element may be termed a second element, and similarly, a second element may be termed a first element without departing from the scope of the present disclosure.

It will be understood that when an element (e.g., the first element) is referred to as being “(operatively or communicatively) coupled with/to” or “connected to” another element (e.g., the second element), it can be directly connected to the other element, or can be connected to the other element through another element (e.g., a third element). In contrast, it could be understood that when an element (e.g., the first element) is referred to as being “directly connected to” or “directly coupled to” another element (e.g., the second element), there is no intervening element (e.g., the third element) between the element and the other element.

The expression “configured (or set) to”, used in this specification, may be interchangeably used with, for example, “suitable for,” “having the capacity to,” “designed to,” “adapted to,” “made to,” or “capable of” according to circumstances. The term “configured (or set) to” may not necessarily mean “specifically designed to” in hardware. Instead, in some cases, the expression “device configured to” may mean that the electronic device “can ˜” together with other electronic devices or components. For example, the phrase “processor adapted (or configured) to perform A, B, and C” may mean a dedicated processor (e.g., an embedded processor) only for performing the corresponding operations or a generic-purpose processor (e.g., a central processing unit (CPU) or an application processor (AP)) that can perform the corresponding operations by executing one or more software programs stored in a memory device.

The terms used in the present disclosure are only used to describe specific embodiments, and are not intended to limit the present disclosure. As used herein, singular forms may include plural forms as well unless the context clearly indicates otherwise. Unless defined otherwise, all terms used herein, including technical terms and scientific terms, may have the same meaning as commonly understood by a person of ordinary skill in the art to which the present disclosure pertains. Terms, such as those defined in commonly used dictionaries, should be interpreted as having a meaning that is the same or similar to their meaning in the context of the relevant art and will not be interpreted in an idealized or overly formal sense unless expressly so defined herein. In some cases, eve the terms defined herein may not be construed to exclude embodiments of the present disclosure.

An electronic device according to various embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), a moving picture experts group (MPEG-1 or MPEG-2) audio layer 3 (MP3) player, a mobile medical appliance, a camera, and a wearable device (e.g., smart glasses, a head-mounted-device (HIVID), electronic clothes, an electronic bracelet, an electronic necklace, an electronic appcessory, an electronic tattoo, a smart mirror, a smart watch, and the like).

According to various embodiments of the present disclosure, the electronic device may be a smart home appliance. The home appliance may include at least one of, for example, a television (TV), a digital video disc (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (e.g., a blood glucose monitoring device, a heart rate monitoring device, a blood pressure measuring device, a body temperature measuring device, and the like), a magnetic resonance angiography (MRA), a MR imaging (MRI), a computed tomography (CT) machine, and an ultrasonic machine), a navigation device, a global positioning system (GPS) receiver, an event data recorder (EDR), a flight DR (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, and the like).

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

Hereinafter, an electronic card may include a card for payment, a bank card, a membership card, and a personal information management card. For example, the card for payment may include at least one of a credit card, a registered prepaid card (e.g., a gift card), a check card, and a debit card. The membership card may include a card for providing membership management services, such as using or saving points, and the like. The bank card may include a cash card that is used for depositing or withdrawing money through an automated teller machine. The personal information management card may include at least one of a certificate of resident registration, a driver's license, and a passport, which show personal information of a user.

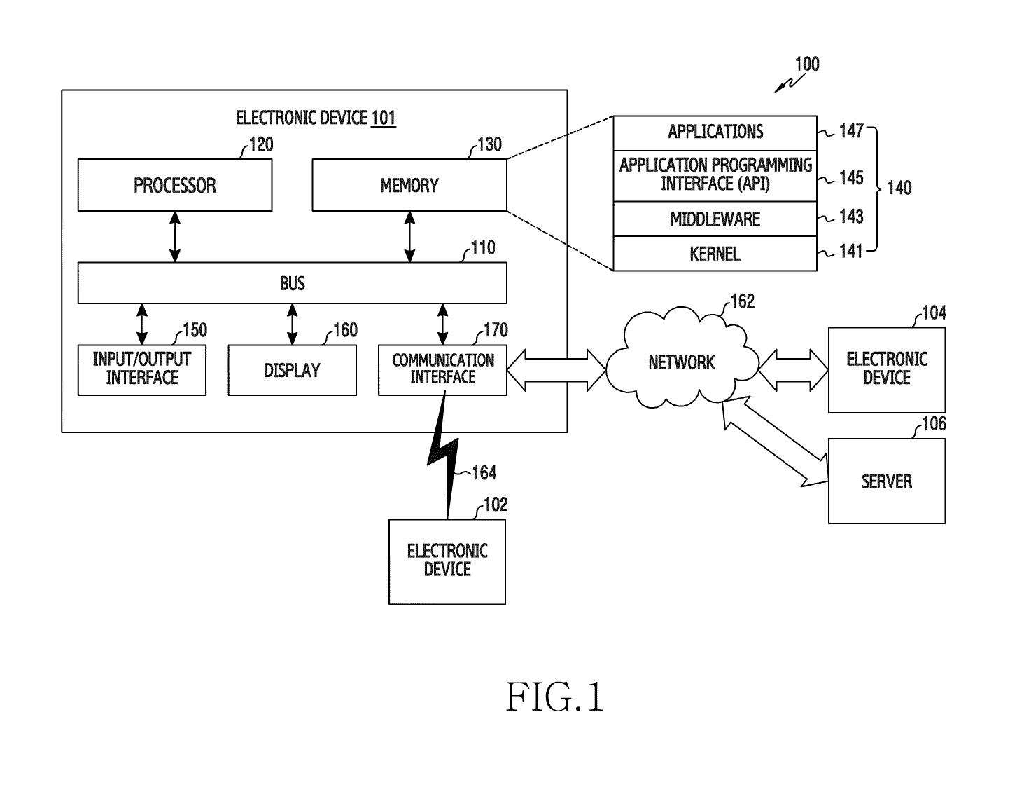

FIG. 1 illustrates a block diagram of a network environment according to various embodiments of the present disclosure.

Referring to FIG. 1, an electronic device 101 within a network environment 100, according to various embodiments of the present disclosure, will be described. The electronic device 101 may include a bus 110, a processor 120 (e.g., including processing circuitry), a memory 130, an input/output interface 150 (e.g., including input/output circuitry), a display 160 (e.g., including a display panel and display circuitry), and a communication interface 170 (e.g., including communication circuitry). In various embodiments of the present disclosure, the electronic device 101 may omit at least one of the elements, or may further include other elements.

The bus 110 may include, for example, a circuit that interconnects the elements 120 to 170 and delivers communication (e.g., a control message and/or data) between the elements.

The processor 120 may include one or more of a CPU, an AP, and a communication processor (CP). For example, the processor 120 may carry out operations or data processing relating to the control and/or communication of at least one other element of the electronic device 101.

According to various embodiments of the present disclosure, the processor 120 may recommend one or more electronic cards for payment among the electronic cards that are registered in the electronic device 101. For example, when the processor 120 executes a payment application, the processor 120 may select one or more electronic cards to be recommended for payment among one or more electronic cards that are registered in the electronic device 101 based on at least one piece of transaction merchandise information, electronic card information, a payment history, or location information. The processor 120 may control the display 160 to display one or more pieces of electronic card information to be recommended for payment. For example, when a card list display event occurs, the processor 120 may select one or more electronic cards to be recommended to the user among one or more electronic cards that are registered in the electronic device 101 based on at least one piece of the electronic card information, the payment history, or the location information. The processor 120 may control the display 160 to display one or more pieces of electronic card information, the card of which is recommended to the user, to be distinguished from other electronic cards in the card list. For example, the transaction merchandise information may contain at least one of the price of the purchased merchandise, the purchase terms, or the total purchased amount. The electronic card information may contain at least one of the total purchased amount, a payment limit, a point collection rate, or discount policies of the corresponding electronic card. The payment history may contain at least one of the electronic card that has been previously used for payment, the payment amount, the payment location, or the transaction merchandise. The location information may contain the place that provides the payment service through the electronic device 101.

According to various embodiments of the present disclosure, the processor 120 may control to output the electronic card information corresponding to a voice instruction that is obtained through the input/output interface 150 or an external device (e.g., a wearable device), which is functionally connected to the electronic device 101. For example, when a voice instruction is detected, the processor 120 may select one or more electronic cards corresponding to the voice instruction from among one or more electronic cards that are registered in the electronic device 101 (or the payment application). The processor 120 may control the display 160 to display one or more pieces of electronic card information corresponding to the voice instruction. Additionally or alternatively, the processor 120 may select one or more electronic cards to be recommended to the user from among one or more electronic cards corresponding to the voice instruction based on at least one of the location information or the payment history of the electronic device. The processor 120 may control the display 160 to display one or more pieces of electronic card information to be recommended to the user. For example, if there is no electronic card corresponding to the voice instruction, the processor 120 may control the display 160 to display payment-related information corresponding to the voice instruction. For example, the payment-related information may contain discount coupon information corresponding to the voice instruction.

According to various embodiments of the present disclosure, the processor 120 may provide a payment service by using one or more electronic cards that are registered in the electronic device 101. For example, the processor 120 may select the electronic card for payment based on input information that is detected through the input/output interface 150. The processor 120 may perform the user authentication, and if the user authentication is successful, the processor 120 may provide the payment service through the electronic card for the payment service. For example, the user authentication may be carried out by using at least one of a password authentication function or a biometric recognition function (e.g., a fingerprint recognition function, an iris recognition function, and the like). For example, the processor 120 may provide the payment service by using one or more payment schemes among a magnetic security transmit (MST) scheme, a near field communication (NFC) scheme, or a bar code scheme. The MST scheme may include a payment scheme in which the payment information on the electronic card is output to the payment terminal {for example, POS} through a magnetic field. The NFC scheme may include a payment scheme in which the payment information on the electronic card is output to the payment terminal through an NFC communication method. The bar code scheme may include a payment scheme in which the payment information on the electronic card is displayed in the form of a bar code on the display 160 in order to thereby provide the payment service.

According to various embodiments of the present disclosure, the processor 120 may provide membership information corresponding to the payment service. For example, in the case where the processor 120 provides the payment service by using one or more electronic cards, the processor 120 may control the display 160 to display one or more pieces of membership information that are related to the corresponding payment. For example, the processor 120 may control to display the membership card information that is related to at least one of the transaction merchandise, the electronic card, or the payment location. The processor 120 may control to display the membership card information that is registered in the electronic device 101 or is able to be registered therein. For example, the membership card information may contain membership information, which is collected or is able to be collected in relation to the corresponding payment, cancelled membership information, and the like. Additionally or alternatively, processor 120 may control to collect the membership related to the corresponding payment through the membership information that is displayed on the display 160. The processor 120 may control to register a new membership card through the membership card information displayed on the display 160.

According to various embodiments of the present disclosure, when the processor 120 provides the payment service, the processor 120 may provide the payment information. For example, when the processor 120 provides the payment service by using the electronic card, the processor 120 may control the display 160 to display the payment information that is obtained from at least one of the financial server or the payment server. For example, the payment information may include a receipt that contains the transaction date and time, the approval number, the electronic card information, the transaction amount, and the membership information. Additionally or alternatively, if the payment information displayed on the display 160 contains the membership information, the processor 120 may control to perform the collection of the membership in relation to the corresponding payment through the payment information. The processor 120 may control to register a new membership card through the payment information displayed on the display 160.

The memory 130 may include a volatile and/or non-volatile memory. The memory 130, for example, may store instructions or data related to one or more other elements of the electronic device 101. For example, the memory 130 may store information that is related to the payment process of the electronic device the 101. For example, the information related to the payment process may be stored, for security purposes, to be separated from other data stored in the memory 130.

The memory 130 may store, for example, instructions or data (e.g., pre-stored location information, location information matched to a network, and the like) that is associated with at least one other element of the electronic device 101. According to an embodiment of the present disclosure, the memory 130 may store software and/or a program 140. For example, the program may include a kernel 141, middleware 143, an application programming interface (API) 145, application (or “application programs”) 147, and the like. At least some of the kernel 141, the middleware 143, and the API 145 may be referred to as an operating system (OS).

The kernel 141 may control or manage, for example, system resources (e.g., the bus 110, the processor 120, the memory 130, and the like) that are used to perform operations or functions implemented in the other programs (e.g., the middleware 143, the API 145, or the application 147). Furthermore, the kernel 141 may provide an interface through which the middleware 143, the API 145, or the application 147 may access the individual elements of the electronic device 101 to control or manage the system resources.

For example, the middleware 143 may function as an intermediary for allowing the API 145 or the application 147 to communicate with the kernel 141 to exchange data.

In addition, the middleware 143 may process one or more task requests received from the application 147 according to priorities thereof. For example, the middleware 143 may assign, to one or more of the application 147, priorities to use the system resources (e.g., the bus 110, the processor 120, the memory 130, and the like) of the electronic device 101. For example, the middleware 143 may perform scheduling or loading balancing on the one or more task requests by processing the one or more task requests according to the priorities assigned to the one or more applications.

The API 145 is an interface through which the application 147 control functions provided from the kernel 141 or the middleware 143, and may include, for example, at least one interface or function (e.g., an instruction) for file control, a window control, an image processing, a text control, and the like.

The input/output interface 150, for example, may function as an interface that may forward instructions or data, which is input from a user or another external device, to the other element(s) of the electronic device 101. Furthermore, the input/output interface 150 may output instructions or data, which is received from the other element(s) of the electronic device 101, to the user or the other external device.

The display 160 may include, for example, a liquid crystal display (LCD), a light-emitting diode (LED) display, an organic LED (OLED) display, a microelectromechanical systems (MEMS) display, and an electronic paper display. The display 160 may display, for example, various types of contents (e.g., text, images, videos, icons, or symbols) to the user. The display 160 may include a touch screen and receive, for example, a touch, gesture, proximity, or hovering input by using an electronic pen or the user's body part.

The communication interface 170, for example, may set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, long term evolution (LTE), LTE-advance (LTE-A), code division multiple access (CDMA), wideband CDMA (WCDMA), universal mobile telecommunications system (UMTS), WiBro (Wireless Broadband), and global system for mobile communications (GSM), as a cellular communication protocol. In addition, the wireless communication may include, for example, a short range communication 164. The short-range communication 164 may be performed by using at least one of, for example, Wi-Fi, Bluetooth (BT), BT low energy (BLE), NFC, MST, and global navigation satellite system (GNSS).

For example, an MST may generate a pulse based on transmission data by using an electromagnetic signal, and the pulse may generate a magnetic signal. Accordingly, the electronic device 101 may transmit, to a POS, the magnetic signal generated through the MST. The POS may detect the magnetic signal using an MST reader, and may convert the detected magnetic signal into an electric signal, so as to restore data.

The GNSS may include at least one of, for example, a GPS, a global navigation satellite system (Glonass), a Beidou navigation satellite system (hereinafter, referred to as “Beidou”), and Galileo (European global satellite-based navigation system). Hereinafter, in the present disclosure, the “GPS” may be interchangeably used with the “GNSS”. The wired communication may include at least one of, for example, a universal serial bus (USB), a high definition multimedia interface (HDMI), recommended standard-232 (RS-232), and a plain old telephone service (POTS). The network 162 may include at least one of a communication network, such as a computer network (e.g., a local area network (LAN) or a wide area network (WAN)), the Internet, and a telephone network.

Each of the first external electronic devices 102 and the second external electronic device 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be performed in another electronic device or a plurality of electronic devices (e.g., the first external electronic device 102 and the second external electronic device 104 or the server 106). According to an embodiment of the present disclosure, when the electronic device 101 has to perform some functions or services automatically or in response to a request, the electronic device 101 may make a request for performing at least some functions relating thereto to another device (e.g., the first external electronic device 102 or the second external electronic device 104 or the server 106) instead of performing the functions or services by itself or in addition. Another electronic device (e.g., the first external electronic device 102 or the second external electronic device 104 or the server 106) may execute the requested functions or the additional functions, and may deliver a result of the execution to the electronic device 101. The electronic device 101 may process the received result as it is or additionally to provide the requested functions or services. To achieve this, for example, cloud computing, distributed computing, or client-server computing technology may be used.

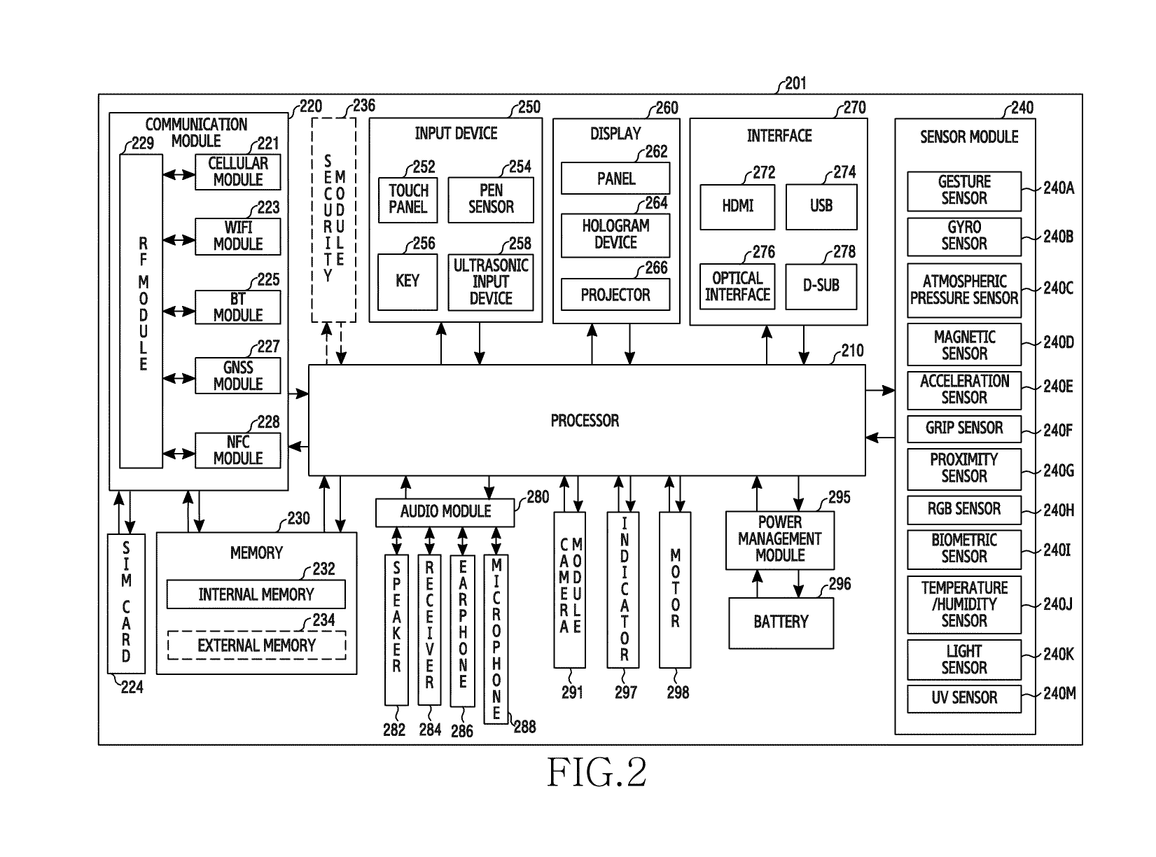

FIG. 2 illustrates a block diagram of an electronic device according to various embodiments of the present disclosure.

Referring to FIG. 2, an electronic device 201 may include, for example, all or a part of the electronic device 101 illustrated in FIG. 1. The electronic device 201 may include at least one AP 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may, for example, control a plurality of hardware or software elements connected thereto and perform a variety of data processing and calculations by driving an OS or application programs. The AP 210 may be implemented as, for example, a system on chip (SoC). According to an embodiment of the present disclosure, the AP 210 may further include a graphics processing unit (GPU) and/or an image signal processor. The AP 210 may include at least some of the elements (e.g., a cellular module 221) illustrated in FIG. 2. The AP 210 may load commands or data, received from at least one other element (e.g., a non-volatile memory), in a volatile memory to process the loaded commands or data, and may store various types of data in the non-volatile memory.

The communication module 220 may have a configuration that is the same as or similar to that of the communication interface 160 of FIG. 1. The communication module 220 may include, for example, a cellular module 221, a Wi-Fi module 223, a BT module 225, a GPS module 227, an NFC module 228, and a radio frequency (RF) module 229. The communication module 220 provides a function of transmitting/receiving a signal. Accordingly, the communication module 220 may be referred to as a “reception unit”, a “transmission unit”, a “transmission and reception unit”, a “communication unit”, and the like.

The cellular module 221 may provide, for example, a voice call, a video call, a text message service, or an Internet service through a communication network. According to an embodiment of the present disclosure, the cellular module 221 may distinguish and authenticate the electronic device 201 in the communication network by using a SIM (e.g., the SIM card 224). According to an embodiment of the present disclosure, the cellular module 221 may perform at least some of the functions that the AP 210 may provide. According to an embodiment of the present disclosure, the cellular module 221 may include a CP.

The Wi-Fi module 223, the BT module 225, the GPS module 227, or the NFC module 228 may include, for example, a processor for processing data transmitted/received through the corresponding module. According to an embodiment of the present disclosure, at least some (e.g., two or more) of the cellular module 221, the Wi-Fi module 223, the BT module 225, the GPS module 227, and the NFC module 228 may be included in a single integrated chip (IC) or IC package.

The RF module 229 may, for example, transmit/receive a communication signal (e.g., an RF signal). The RF module 229 may include, for example, a transceiver, a power amp module (PAM), a frequency filter, a low noise amplifier (LNA), or an antenna. According to another embodiment of the present disclosure, at least one of the cellular module 221, the Wi-Fi module 223, the BT module 225, the GPS module 227, and the NFC module 228 may transmit/receive an RF signal through a separate RF module.

The SIM card 224 may include, for example, a card including a SIM and/or an embedded SIM, and may further include unique identification information (e.g., an integrated circuit card identifier (ICCID)) or subscriber information (e.g., international mobile subscriber identity (IMSI)).

The memory 230 may include, for example, an internal memory 232 or an external memory 234. The internal memory 232 may include, for example, at least one of a volatile memory (e.g., a dynamic random access memory (DRAM), a static RAM (SRAM), a synchronous DRAM (SDRAM), and the like) and a non-volatile memory (e.g., a one-time programmable read only memory (OTPROM), a programmable ROM (PROM), an erasable and programmable ROM (EPROM), an electrically EPROM (EEPROM), a mask ROM, a flash ROM, a flash memory (e.g., a NAND flash memory or a NOR flash memory), a hard disc drive, or a solid state drive (SSD)).

The external memory 234 may further include a flash drive, for example, a compact flash (CF), a secure digital (SD), a micro SD (Micro-SD), a mini SD (Mini-SD), an extreme digital (xD), a memory stick, and the like. The external memory 234 may be functionally and/or physically connected to the electronic device 201 through various interfaces.

The security module 236 may be a module that includes a storage space having a relatively higher security level than the memory 230, and may be a circuit that ensures safe data storage and secure execution environment. The security module 236 may be embodied as a separate circuit, and may include a separate processor. The security module 236, for example, may be included in a detachable smart chip or a SD card, or may include an embedded secure element (eSE) that is contained in a fixed chip of the electronic device 201. In addition, the security module 236 may be driven in an OS that is different from the OS of the electronic device 201. For example, the security module 236 may be driven based on a java card open platform (JCOP) OS.

The sensor module 240 may measure, for example, physical quantity or detect an operational status of the electronic device 201, and may convert the measured or detected information into an electric signal. The sensor module 240 may include, for example, at least one of a gesture sensor 240A, a gyro sensor 240B, a pressure sensor 240C, a magnetic sensor 240D, an accelerometer 240E, a grip sensor 240F, a proximity sensor 240G, a color sensor 240H (e.g., a red, green, blue (RGB) sensor), a bio sensor 240I, a temperature/humidity sensor 240J, an illumination sensor 240K, and an ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris sensor, a force touch sensor, and/or a fingerprint sensor. The sensor module 240 may further include a control circuit for controlling at least one or more sensors included therein. In a certain embodiment of the present disclosure, the electronic device 201 may further include a processor configured to control the sensor module 240 either separately or as a part of the processor 210, and may control the sensor module 240 while the processor 210 is in a sleep state.

The input device 250 may include, for example, a touch panel 252, a (digital) pen sensor 254, a key 256, or an ultrasonic input device 258. The touch panel 252 may use at least one of, for example, a capacitive type, a resistive type, an IR type, and an ultrasonic type. In addition, the touch panel 252 may further include a control circuit. The touch panel 252 may further include a tactile layer to provide a tactile reaction to a user.

The (digital) pen sensor 254 may be, for example, a part of the touch panel, or may include a separate recognition sheet. The key 256 may include, for example, a physical button, an optical key, or a keypad. The ultrasonic input device 258 may identify data by detecting acoustic waves with a microphone (e.g., a microphone 288) of the electronic device 201 through an input unit for generating an ultrasonic signal.

The display 260 (e.g., the display 160) may include a panel 262, a hologram device 264, or a projector 266. The panel 262 may include a configuration that is the same as or similar to that of the display 160 of FIG. 1. The panel 262 may be implemented to be, for example, flexible, transparent, or wearable. The panel 262 may be configured as a single module integrated with the touch panel 252. The hologram device 264 may show a stereoscopic image in the air using interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 160 illustrated in FIG. 1. Additionally or alternatively, the interface 270 may include, for example, a mobile high-definition link (MHL) interface, a SD card/multi-media card (MMC) interface, or an IR data association (IrDA) standard interface.

The audio module 280 may, for example, convert a sound into an electrical signal, and vice versa. At least some elements of the audio module 280 may be included in, for example, the input/output interface 140 illustrated in FIG. 1. The audio module 280 may, for example, process sound information that is input or output through a speaker 282, a receiver 284, earphones 286, the microphone 288, and the like.

The camera module 291 may be, for example, a device that can take a still image or a moving image, and according to an embodiment of the present disclosure, the camera module 291 may include one or more image sensors (e.g., a front sensor or a rear sensor), a lens, an image signal processor (ISP), or a flash (e.g., an LED or a xenon lamp).

The power management module 295 may, for example, manage power of the electronic device 201. According to an embodiment of the present disclosure, the power management module 295 may include a power management integrated circuit (PMIC), a charger IC, or a battery or fuel gauge. The PMIC may use a wired and/or wireless charging method. Examples of the wireless charging method may include, for example, a magnetic resonance scheme, a magnetic induction scheme, an electromagnetic wave scheme, and the like. Further, the power management module 295 may further include additional circuits (e.g., a coil loop, a resonance circuit, a rectifier, and the like) for wireless charging. The battery gauge may measure, for example, a residual quantity of the battery 296, and a voltage, a current, or a temperature during the charging. The battery 296 may include, for example, a rechargeable battery and/or a solar battery.

The indicator 297 may indicate a specific state of the electronic device 201 or a part thereof (e.g., the AP 210), for example, a booting state, a message state, a charging state, and the like. The motor 298 may convert an electrical signal into a mechanical vibration, and may generate a vibration or haptic effect. Although not illustrated, the electronic device 201 may include a processing unit (e.g., a GPU) for mobile TV support. The processing device for mobile TV support may, for example, process media data according to a standard of digital multimedia broadcasting (DMB), digital video broadcasting (DVB), media flow, and the like.

Each of the components of the electronic device according to the present disclosure may be implemented by one or more components and the name of the corresponding component may vary depending on a type of the electronic device. In various embodiments of the present disclosure, the electronic device may include at least one of the above-described elements. Some of the above-described elements may be omitted from the electronic device, or the electronic device may further include additional elements. Further, some of the elements of the electronic device according to various embodiments of the present disclosure may be coupled to form a single entity while performing the same functions as those of the corresponding elements before the coupling.

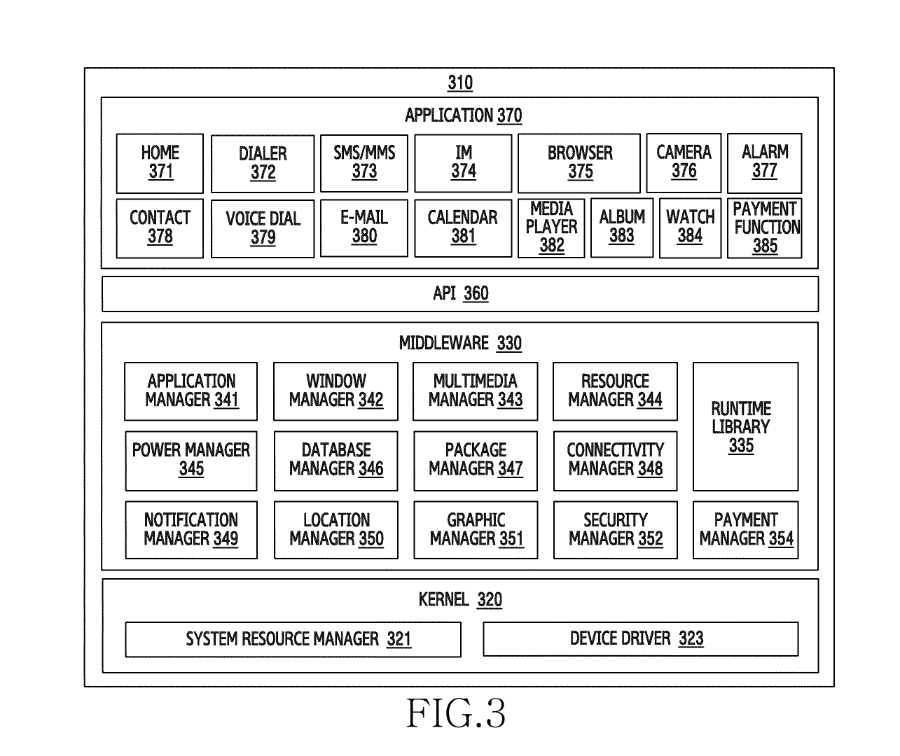

FIG. 3 illustrates a block diagram of a program module according to various embodiments of the present disclosure.

Referring to FIG. 3, a program module 310 (e.g., the program 140) may include an OS that controls resources relating to an electronic device (e.g., the electronic device 101) and/or various applications (e.g., the application 147) executed in the OS. The OS may be, for example, Android, iOS™, Windows™, Symbian™, Tizen™, Bada™, and the like.

The programming module 310 may include a kernel 320, middleware 330, an API 360, and/or applications 370. At least some of the program module 310 may be preloaded in the electronic device, or may be downloaded from an external electronic device (e.g., the first external electronic device 102 or the second external electronic device 104, and the server 106).

The kernel 320 (e.g., the kernel 141 of FIG. 1) may include, for example, a system resource manager 321 or a device driver 323. The system resource manager 321 may control, allocate, or collect system resources. According to an embodiment of the present disclosure, the system resource manager 321 may include a process management unit, a memory management unit, or a file system management unit. The device driver 323 may include, for example, a display driver, a camera driver, a BT driver, a shared-memory driver, a USB driver, a keypad driver, a Wi-Fi driver, an audio driver, or an inter-process communication (IPC) driver.

The middleware 330 may provide a function required by the applications 370 in common, or may provide various functions to the applications 370 through the API 360 to enable the applications 370 to efficiently use limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and payment manager 354.

The runtime library 335 may include, for example, a library module used by a complier in order to add a new function through a programming language during the execution of the applications 370. The run time library 335 may perform input/output management, memory management, or a function for an arithmetic function.

The application manager 341 may manage, for example, a life cycle of at least one of the applications 370. The window manager 342 may manage graphical user interface (GUI) resources used by a screen. The multimedia manager 343 may identify a format required for reproducing various media files, and may encode or decode a media file using a codec suitable for the corresponding format. The resource manager 344 may manage resources of at least one of the applications 370, such as a source code, a memory, a storage space, and the like.

The power manager 345 may operate together with, for example, a basic input/output system (BIOS) to manage a battery or power and provide power information required for an operation of the electronic device. The database manager 346 may generate, search, or change a database to be used by at least one of the applications 370. The package manager 347 may manage installation or update of an application distributed in the format of a package file.

The connectivity manager 348 may manage, for example, a wireless connection, such as Wi-Fi or BT. The notification manager 349 may display or notify of an event, such as a received message, an appointment, and a proximity notification, in such a manner as not to disturb a user. The location manager 350 may manage location information of the electronic device. The graphic manager 351 may manage a graphic effect to be provided to a user, or a user interface (UI) related thereto. The security manager 352 may provide all security functions required for system security or user authentication. According to an embodiment of the present disclosure, in cases where the electronic device (e.g., the electronic device 101) has a telephone call function, the middleware 330 may further include a telephony manager for managing a voice or video call function of the electronic device.

The payment manager 354 may relay information for payment obtained from an application 370, to another application 370 or the kernel 320. In addition, the payment manager 354 may store information associated with payment received from an external device in the electronic device 30, or may transfer information stored in the electronic device 30 to the external device.

The middleware 330 may include a middleware module that forms combinations of various functions of the aforementioned elements. The middleware 330 may provide specialized modules according to the types of OSs in order to provide differentiated functions. In addition, the middleware 330 may dynamically delete some of the existing elements, or may add new elements.

The API 360 (e.g., the API 145) may be, for example, a set of API programming functions, and may be provided with different configurations according to OSs. For example, in the case of Android or iOS, one API set may be provided for each platform, and in the case of Tizen, two or more API sets may be provided for each platform.

The applications 370 (e.g., the application 147) may include, for example, one or more applications that can provide functions, such as a home application 371, a dialer application 372, a short message service (SMS)/multimedia messaging service (MMS) application 373, an instant message (IM) application 374, a browser application 375, a camera application 376, an alarm application 377, a contact application 378, a voice dialer application 379, an e-mail application 380, a calendar application 381, a media player application 382, an album application 383, a clock application 384, a payment application 385, a health care application (e.g., to measure exercise quantity or blood sugar), or environment information (e.g., atmospheric pressure, humidity, temperature information, and the like).

According to an embodiment of the present disclosure, the applications 370 may include an application (hereinafter, referred to as an “information exchange application” for convenience of the description) that supports information exchange between the electronic device (e.g., the electronic device 101) and external electronic devices (e.g., the first external electronic device 102 and the second external electronic device 104). The information exchange application may include, for example, a notification relay application for transmitting specific information to the external electronic device, or a device management application for managing the external electronic device.

For example, the notification relay application may include a function of transferring, to an external electronic device (e.g., the first external electronic device 102 or the second external electronic device 104), notification information generated from other applications of the electronic device (e.g., an SMS/MMS application, an e-mail application, a health management application, or an environmental information application). Furthermore, the notification relay application may, for example, receive notification information from an external electronic device and provide the received notification information to a user. The device management application may, for example, manage (e.g., install, delete, or update) at least one function of an external electronic device (e.g., the second external electronic device 104) communicating with the electronic device (e.g., a function of turning on/off the external electronic device itself (or some elements thereof), or a function of adjusting luminance (or a resolution) of the display), applications operating in the external electronic device, or services provided by the external electronic device (e.g., a telephone call service or a message service).

According to an embodiment of the present disclosure, the applications 370 may include an application (e.g., a health care application) specified according to attributes (e.g., attributes of the electronic device, such as the type of electronic device which corresponds to a mobile medical device) of the external electronic device (e.g., the first external electronic device 102 or the second external electronic device 104). According to one embodiment of the present disclosure, the applications 370 may include an application received from an external electronic device (e.g., the server 106 or the first external electronic device 102 or the second external electronic device 104). According to an embodiment of the present disclosure, the applications 370 may include a preloaded application or a third party application that can be downloaded from a server. The names of the elements of the program module 310, according to an embodiment of the present disclosure illustrated in the drawing, may vary according to the type of OS.

According to an embodiment of the present disclosure, the applications 370 may include at least one application related to setting a geo-fence.

According to various embodiments of the present disclosure, at least a part of the programming module 310 may be implemented in software, firmware, hardware, or a combination of two or more thereof. At least some of the programming module 310 may be implemented (e.g., executed) by, for example, the processor (for example, the AP 210). At least some of the programming module 310 may include, for example, a module, program, routine, sets of instructions, process, and the like, for performing one or more functions.

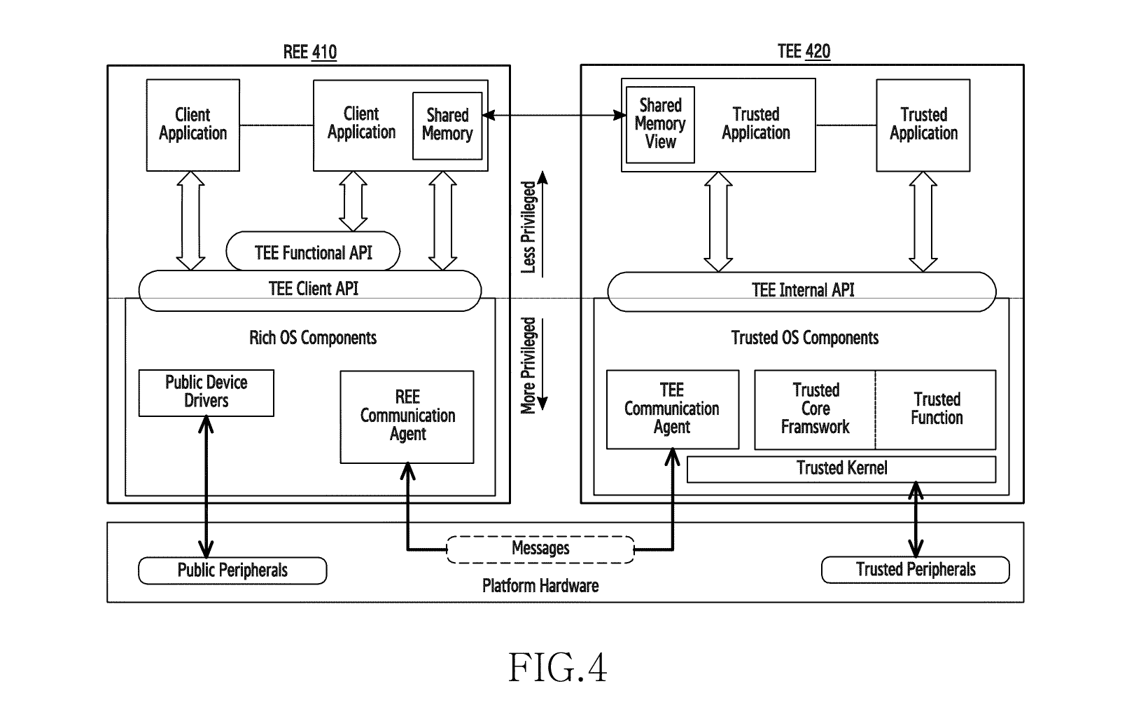

FIG. 4 illustrates a block diagram of a rich execution environment (REE) and a trusted execution environment (TEE) operated in an electronic device according to various embodiments of the present disclosure.

Referring to FIG. 4, the electronic device may operate a plurality of execution environments having security levels in order to reinforce the security. The plurality of execution environments may include, for example, an REE 410 and a TEE 420. The REE 410 may be, for example, a first execution environment having a first security level. The TEE 420 may be, for example, a second execution environment having a second security level different from (e.g., higher than) the first security level. According to one embodiment of the present disclosure, the electronic device 101 may include another execution environment (e.g., a third execution environment) having a third security level, without being limited thereto.

The TEE 420 may store data requiring a relatively high security level and perform related operations in a safe environment. The TEE 420 may operate on an AP of an electronic device and operate based on the reliable hardware structure determined in the process of manufacturing the electronic device. The TEE 420 may divide the AP or memory into a general area and a security area and operate in the security area. The TEE 420 may configure software or hardware requiring security, to operate in only a security area. The electronic device may operate the TEE 420 through a physical change of hardware or a logical change of software.

The TEE 420 may be separated from the REE 410 through hardware restrictions, or they may be separated in view of software and operate in the same hardware. At least one application (e.g., an Application for payment, a contact, an e-mail, a browser, and the like) operating in an REE 410 may use an API (e.g., TEE-functional API or TEE-client API) allowed to access the TEE 420. The at least one application may transfer, using the API, a message from a communication agent (REE communication agent) of REE 410 to a communication agent (TEE communication agent) of TEE 420. The message may be implemented to be transferred to only the TEE 420 in view of hardware. The communication agent of the TEE 420 may receive the message and transfer the message to a security application (trusted application (TA), e.g., digital rights management (DRM), security payment module, or security biological information module) related to the message. The security application may perform an operation related to the message, and transfer a result of the operation to the communication agent of the REE 410 through the communication agent of the TEE 420. The communication agent of the REE 410 may transfer the result to at least one application being operated in the REE 410.

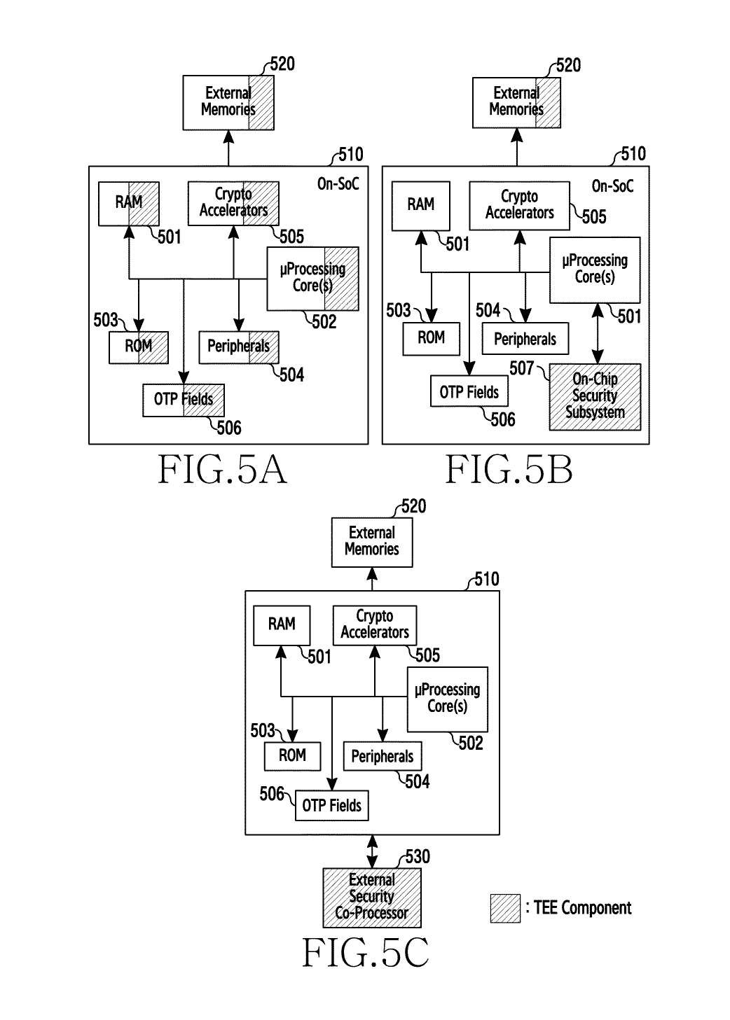

FIGS. 5A to 5C illustrate block diagrams illustrating a hardware configuration of a TEE according to various embodiments of the present disclosure.

Referring to FIG. 5A, a case (e.g., trust zone (TZ) of ARM) where one processor and one memory are divided in use into REE and TEE in view of hardware is illustrated. According to an embodiment of the present disclosure, the hardware structure of the TEE may include an On-SoC 510 and external memories 520. The On-SoC 510 may include a micro-processing core 502, a RAM 501, a ROM 503, a peripheral 504, a crypto accelerator 505, or one time password (OTP) fields 506. In order to operate two or more execution environments, the TZ may temporally divide the processors and separately use the REE and the TEE. Further, the TZ may divide one memory into an area accessible in the REE and an area accessible in the TEE and separately use the areas.

Referring to FIG. 5B, a case where a processor for a TEE is implemented together with a processor for operating an REE in the form of on-chip but is implemented in a separate processing core set is illustrated. According to an embodiment of the present disclosure, the On-SoC 510 may further include an On-chip security sub-system 507 including one or more processors in addition to the micro processing core 501. In this case, the On-SoC 510 may be configured to operate the REE while the On-chip security sub-system 507 is configured to operate the TEE. Likewise in FIG. 5A, one memory may be divided into an area accessible in the REE and an area accessible in the TEE and the areas may be separately used in the case of FIG. 5B.

Referring to FIG. 5C, a case where a processor for the TEE is implemented in a separate chip in view of hardware and is separated from a chip in which a processor for operating the REE is illustrated. Referring to FIG. 5C, the On-SoC 510 may be configured to operate the REE and one or more external security co-processors 530 disposed outside of the On-SoC 510 may be configured to operate the TEE.

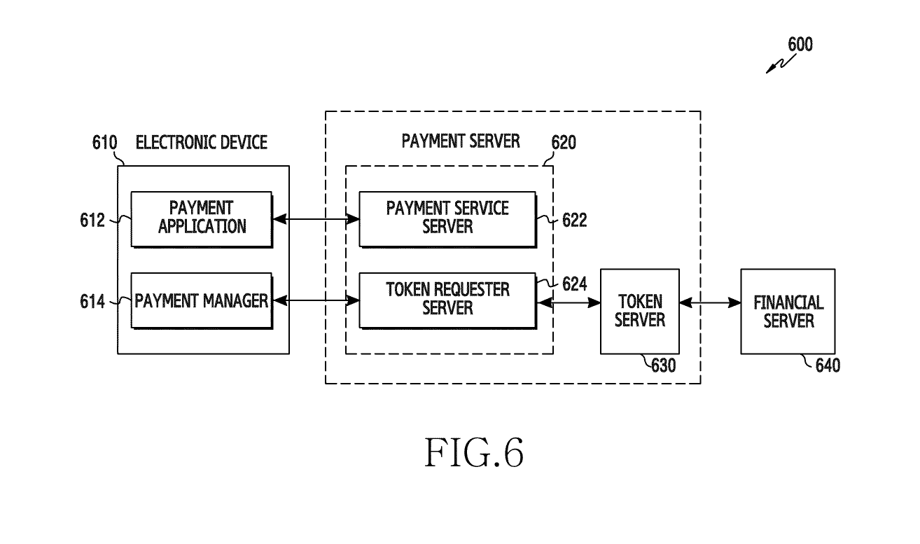

FIG. 6 illustrates a block diagram of a payment system according to various embodiments of the present disclosure.

Referring to FIG. 6, according to various embodiments of the present disclosure, a payment system 600 may include an electronic device 610 and/or a server. Further, the server may include, for example, a payment server 620, a token server (token service provider) 630, or a financial server (issuer) 640. The electronic device 610 may include, for example, a payment application (wallet application) 612 and/or a payment manager 614. The payment server 620 may include, for example, a payment service server 622 and/or a token requester server 624.

According to various embodiments of the present disclosure, the payment application 612 may include, for example, Samsung Pay application. The payment application 612 may provide, for example, a UI (or User experience (UX)) related to payment. The UI related to payment may include a wallet UI/UX. For example, the payment application 612 may provide, for example, a UI related to card registration, payment, or transaction. The payment application 612 may provide, for example, an interface related to card registration through an external input (e.g., user input) or a text reader (e.g., optical character reader/recognition (OCR)). Further, the payment application 612 may provide, for example, an interface related to user authentication through identification and verification (ID&V).

According to various embodiments of the present disclosure, the payment application 612 may perform payment transaction. For example, the payment application 612 may provide a user with a payment function through execution of Simple Pay, Quick Pay, or a designated application. Using the payment application 612, a user may perform a payment function and receive information associated with the payment function.

According to various embodiments of the present disclosure, the payment manager 614 may include information associated with a card company. For example, the payment manager 614 may include a card company software development kit (SDK).

According to various embodiments of the present disclosure, the payment server 620 may include a management server for electronic payment or mobile payment. The payment server 620 may, for example, receive information related to payment from the electronic device 610 and transmit the information to the outside or process the information in itself.

According to various embodiments of the present disclosure, the payment server 620 may transmit or receive information between the electronic device 610 and the token server 630, using the payment service server 622 and/or the token requester server 624. The payment service server 622 may include, for example, a payment server (e.g., Samsung payment server) 620. The payment service server 622 may manage, for example, card information linked to a service account (e.g., Samsung account) or user account. Further, the payment service server 622 may include an API server related to the payment application 612. Further, the payment service server 622 may provide, for example, an account management module (e.g., account integration or Samsung account integration).

According to various embodiments of the present disclosure, the token requester server 624 may provide an interface for processing information relating to payment. For example, the token requester server 624 may perform issuance, deletion, or activation of information (e.g., token) related to payment. In addition, the token requester server may be functionally connected to the payment manager 614 to control the information required for the payment.

According to various embodiments of the present disclosure, the payment application 612 included in the electronic device 610 and the payment service server 622 included in the payment server 620 may be functionally connected with each other. For example, the payment application 612 may transmit or receive information relating to payment to or from the payment server 620. According to an embodiment of the present disclosure, the payment manager 614 included in the electronic device 610 and the token requester server 624 included in the payment server 620 may be functionally connected with each other. For example, the payment manager 614 may transmit or receive information relating to payment to or from the token requester server 624.

According to various embodiments of the present disclosure, the token server 630 may issue or manage information (e.g., token) relating to payment. For example, the token server 630 may control the operation cycle (like cycle) of a token. The operation cycle may include a generation, revision, or deletion cycle. Further, the token server 630 may include, for example, a token management server and perform token provisioning, ID&V, replenishment, or life cycle management. Further, the token server 630 may integrate information relating to the financial server.

According to various embodiments of the present disclosure, the payment server 620 and/or the token server 630 may be located in an identical area, similar areas, or separated areas. For example, the payment server 620 may be included in a first server while the token server 630 is included in a second server. Further, for example, the payment server 620 and/or the token server 630 may be distinguishably implemented in one server (e.g., the first server or second server).

According to various embodiments of the present disclosure, the financial server 640 may perform issuance of a card. For example, the financial server 640 may include a card issuing bank. Further, the financial server 640 may generate information required for the payment provided to the user. The user may store, in the electronic device 610, the information required for the payment generated in the financial server 640, using the payment application 612. In addition, the financial server 640 may be functionally connected to the token server 630 to transmit or receive the information required for the payment.

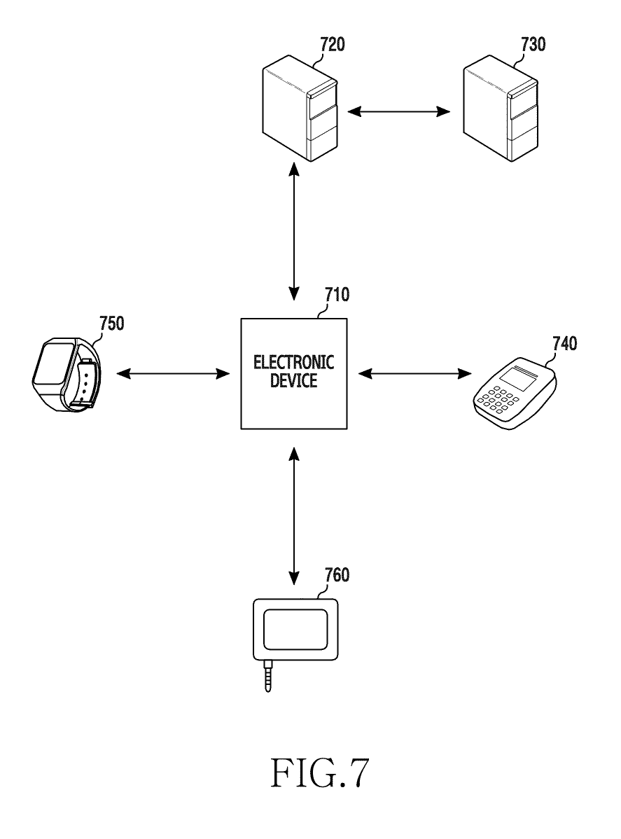

FIG. 7 illustrates a block diagram illustrating a payment system for performing payment according to various embodiments of the present disclosure.

Referring to FIG. 7, the payment system may include an electronic device 710 (e.g., the electronic device 101), a payment server 720 (e.g., the server 106), a token service provider (TSP) 730 (e.g., the server 106 or another server (not shown)), and a POS device 740 (e.g., the first external electronic device 102). According to an embodiment of the present disclosure, the payment system may include one or more additional electronic device 750 or 760. The one or more additional electronic device may include a wearable device 750 (e.g., a smart watch) or an accessory device 760 (e.g., a fob type device of the LoopPay™ company), which can be functionally (e.g., communication) connected with the electronic device 710. According to an embodiment of the present disclosure, the fob type device of the LoopPay™ company may include an external payment module connected to the electronic device 710 through a microphone.

According to an embodiment of the present disclosure, the electronic device 710 may perform a payment function. The electronic device 710 may register a card (e.g., a credit card, such as a master card or a visa card) in the electronic device 710 or the payment server 720 in order to perform the payment function. The payment server 720 may manage information on a plurality of registered cards including a card registered through another electronic device (e.g., the electronic device 750) of the user corresponding to the electronic device 710 or another card registered through an electronic device of another user as well as a card registered through the electronic device 710.

According to an embodiment of the present disclosure, the payment server 720 may acquire token information corresponding to registered card information from the token service provider 730 and transfer the acquired information to the electronic device 710. The payment server 720 may include, for example, a payment service server or token requester server. The payment service server may manage card information of the user. The payment service server may provide a service related to payment based on an account. The token requester server may request the token service provider 730 to provide token information necessary for the payment operation and acquire the token information.

The token service provider 730 may issue a token used in a payment process. According to an embodiment of the present disclosure, the token may have a value replacing a primary account number (PAN), which is information of a card. According to one embodiment of the present disclosure, a token may be generated using a bank identification number (BIN). Further, the generated token may be encrypted by the token service provider 730, or may be encrypted by the payment server 730 after being sent to the payment server 730 without being encrypted. The encrypted token information may be transferred to the electronic device 710 through the payment server 720 and decrypted by the electronic device 710. According to an embodiment of the present disclosure, the token may be generated and encrypted in the token service provider 730 and may be transferred to the electronic device 710 without passing through the payment server 720. According to an embodiment of the present disclosure, the payment server 720 may include a token generation function. In this instance, the payment system may omit a separate token service provider 730.

The electronic device 710 may perform payment using, for example, at least one electronic device among one or more other electronic devices 750 or 760 functionally connected thereto based on a short range communication (e.g., BT or WiFi). According to an embodiment of the present disclosure, the at least one electronic device 750 may be a wearable device (e.g., a smart watch) and, in this instance, the electronic device 710 may transmit the token received from the token service provider 730 to the wearable device. According to an embodiment of the present disclosure, the at least one electronic device 760 may be an accessory device (e.g., a fob type device of the LoopPay™ company) and, in this instance, the electronic device 710 may be functionally connected with the accessory device (e.g., a fob type device of the LoopPay™ company) through its input/output interface 150 (e.g., the earphone 286).

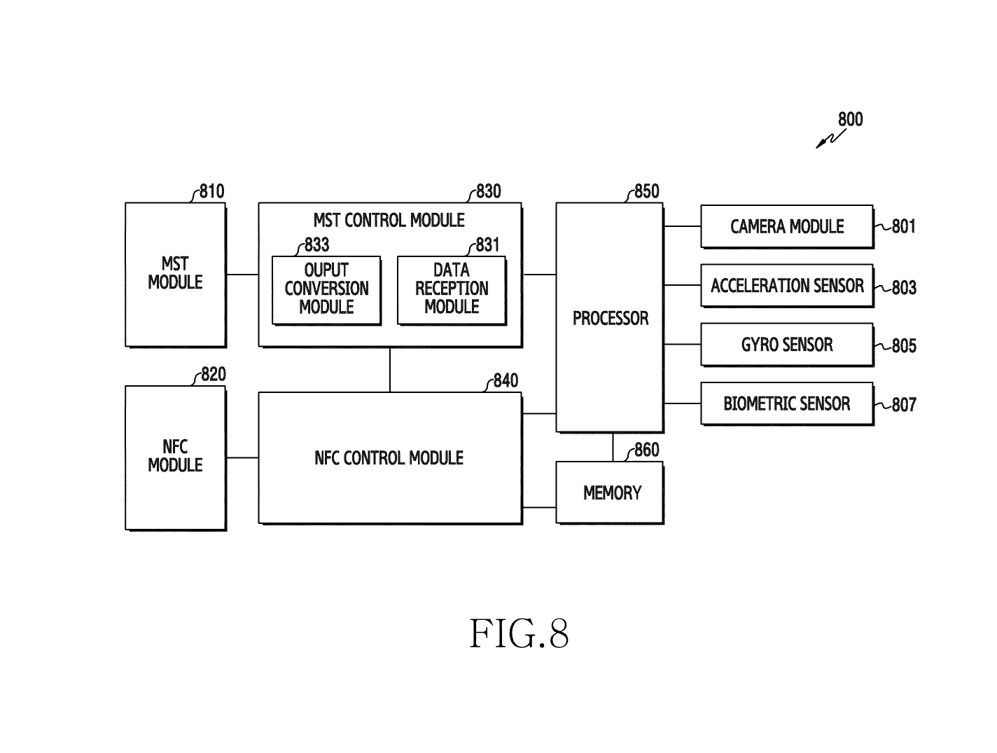

FIG. 8 illustrates a block diagram of a hardware structure of an electronic device capable of performing a payment function according to various embodiments of the present disclosure.

Referring to FIG. 8, an electronic device 800 may include, for example, a camera module 801, an acceleration sensor 803, a gyro sensor 805, a biometric sensor 807, an MST module 810, an NFC module 820, an MST control module 830, an NFC control module 840, a processor 850, and a memory 860. The camera module 801 may photograph a card required for payment to acquire card information. The camera module 801 may recognize, through an OCR function, card information (e.g., card company, card number, card expiration date, or card owner) recorded in the card. Otherwise, a user may input necessary card information to the electronic device, using an input device (e.g., a touch panel, a pen sensor, a key, an ultrasonic input device, or a microphone input device) included in the electronic device 800.

According to an embodiment of the present disclosure, the acceleration sensor 803 or gyro sensor 805 may acquire location state of the electronic device 800 at the time of payment. The acquired location information of the electronic device 800 (e.g., electronic device 101) is transferred to the processor 850, and the processor 850 may adjust the intensity (current intensity) of the magnetic field transmitted from the MST module 810 to a POS device, based on the acquired location state of the electronic device 800. When there are a plurality of coil antennas, the processor 850 may select a used coil antenna. According to an embodiment of the present disclosure, the MST control module 830 may include a data reception module 831 and an output conversion module 833. The data reception module 831 may receive a pulse signal in the form of logical low/high, which includes payment information transmitted from the processor 850 or the security module (e.g., an eSE).

The output conversion module 833 may include a circuit for converting data recognized by the data reception module 831 into necessary types in order to transfer the data to the MST module 810. The circuit may include an H-Bridge for controlling the direction of the voltage supplied to opposite ends of the MST module 810. The H-Bridge may include a circuit structure connected in a shape like H using four switch structures.

According to an embodiment of the present disclosure, based on the card information input through the camera module 801 or an input device (e.g., a touch panel or a pen sensor), the electronic device 800 may receive the payment information (e.g., track 1/2/3 or token information) included in the magnetic stripe of a magnetic card from a card company/bank server through a communication module (not shown). The electronic device 800 may store the received payment information in a necessary form in a memory 860 or a separate security module (e.g., an eSE).

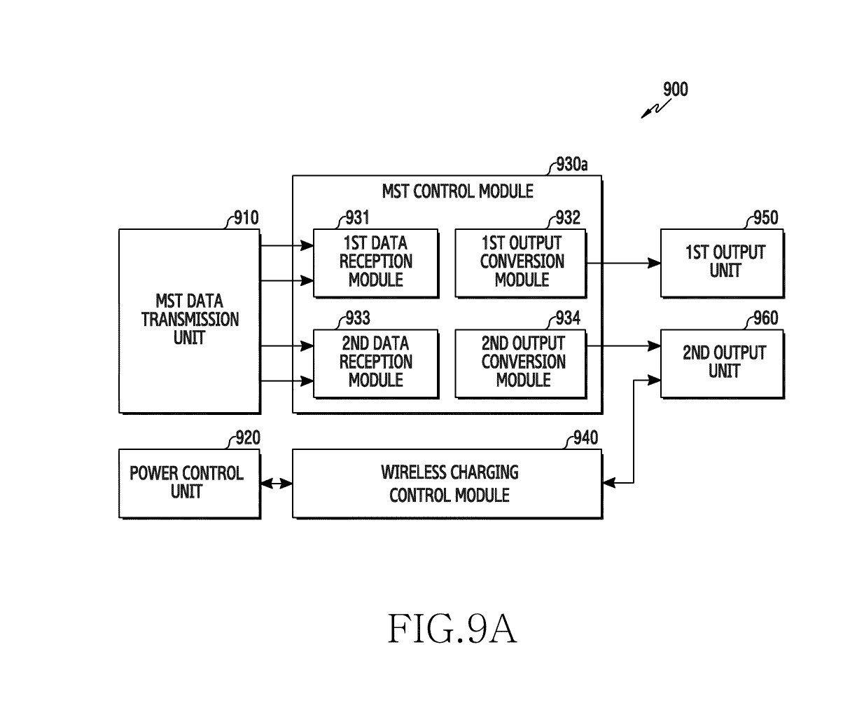

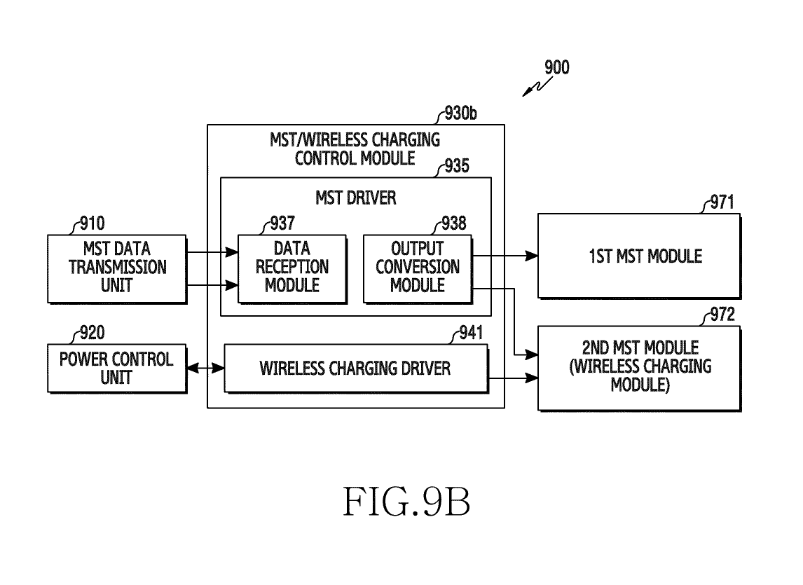

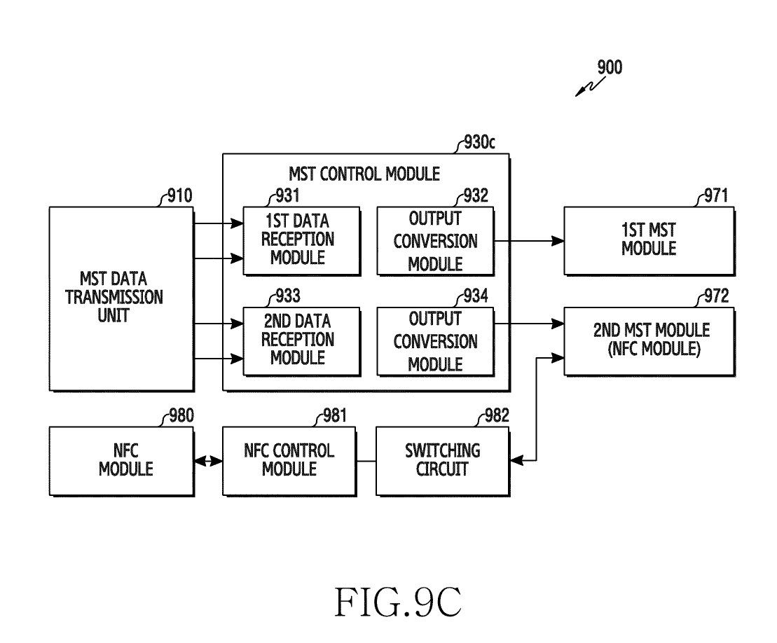

FIGS. 9A to 9C illustrate an internal hardware block diagram of an electronic device capable of commonly using at least one module among a plurality of MST modules in common with another short-range communication network device according to various embodiments of the present disclosure.

Referring to FIG. 9A, an electronic device 900 may include an MST data transmission unit 910, an MST control module 930a, a first output unit 950, a power controller 920, a wireless charging control module 940, and a second output unit 960. The MST control module 930a may include a first data reception unit 931, a first output conversion module 932, a second data reception module 933, and a second output conversion module 934. The MST data transmission unit 910 transfers a signal to one of the first data reception module 931 and the second data reception module 933, and the signal may be converted by the first output conversion module 932 and the second conversion module 934 and be transmitted through the first output unit 950 or second output unit 960. The second output unit 960 may be connected with the wireless charging control module 940 to be used for charging of wireless power. The power control unit 920 may include a power management module 295 included in the terminal. According to one embodiment of the present disclosure, the MST module corresponding to the first output unit 950 may include a coil antenna having an inductance value of about 10 pH. The wireless charging module 940 may include an alternating current/direct current (AC/DC) converter or a rectifying unit.

Referring to FIG. 9B, the electronic device 900 may include an MST data transmission unit 910, an MST/wireless charging control module 930b, a power controller 920, a first MST module 971, and a second MST module 972. The MST/wireless charging control module 930b may include an MST driver 935 and a wireless charging driver 941. The MST driver 935 may include a data reception module 937 and an output conversion module 938. The wireless charging driver 941 may include an AC/DC converter or a rectifying unit. The electronic device 900 as described above may use at least one MST module among a plurality of MST modules 971 and 972 as a wireless charging coil antenna of a resonance type. When the second MST module 972 is connected with the wireless charging driver 941 and operates as a wireless charging module (wireless charging coil antenna), a switching unit may be further disposed between the second MST module 972 and the MST driver 935 to selectively establish a connection therebetween (e.g., an open state).

Referring to FIG. 9C, the electronic device 900 may include an MST data transmission unit 910, an MST control module 930c, a first MST module 971, a second MST module 972, an NFC module 980, an NFC control module 981, and a switching circuit 982. Similarly to the MST control module 930a in FIG. 9A, the MST control module 930c may include a first data reception module 931, a second data reception module 933, and output conversion modules 932 and 934. The second MST module 972 may be selectively used for MST data transmission or NFC data transmission or reception. When the second MST module 972 is used as an NFC coil antenna, the electronic device 900 may operate a switching circuit 982 in order to adjust the inductance value or the number of turns of the coil antenna.

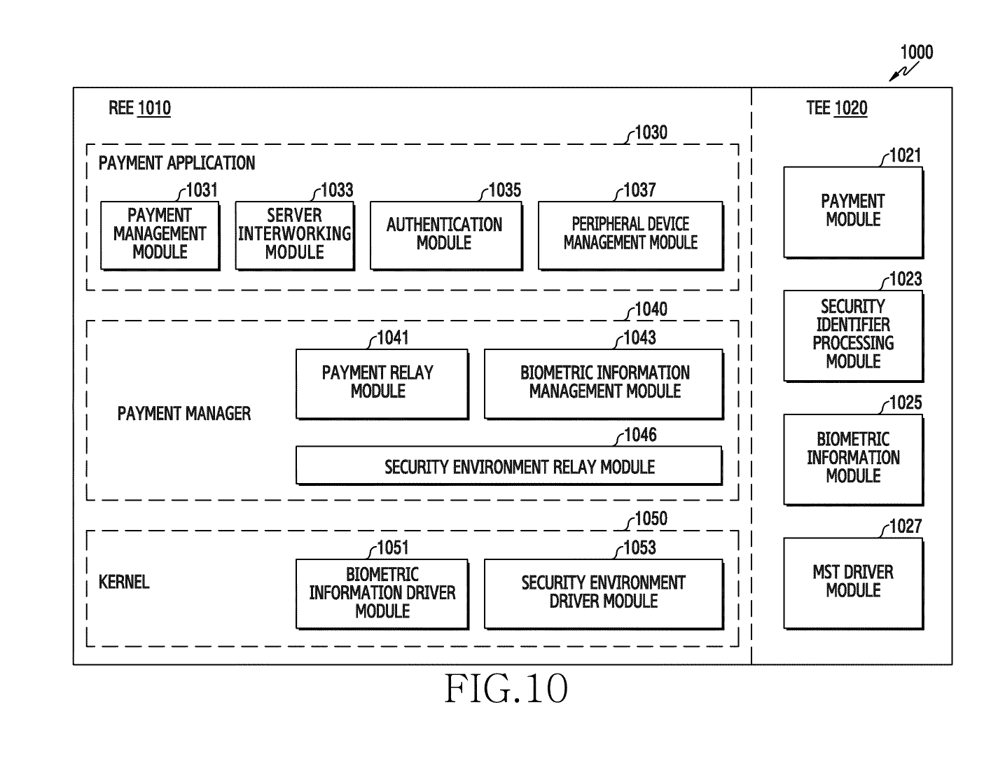

FIG. 10 illustrates a block diagram of program modules to be executed in an execution environment of an electronic device capable of performing a payment function according to various embodiments of the present disclosure.

Referring to FIG. 10, the execution environment of an electronic device 1000 may include, for example, an REE 1010 and a TEE 1020.

According to an embodiment of the present disclosure, the REE 1010 may include, for example, a payment application 1030 (e.g., the payment application 385), a payment manager 1040 (e.g., the payment manager 354), and a kernel 1050 (e.g., the kernel 320). According to an embodiment of the present disclosure, the payment application 1030 may include a payment management module 1031, a server interworking module 1033, an authentication module 1035, and a peripheral device management module 1037.

According to an embodiment of the present disclosure, the payment management module 1031 may perform operations for card registration, card authentication, card de-registration, and payment. The payment management module 1031 may register a user's card. The electronic device 1000 (e.g., the electronic device 101) may receive a card registration request from a user. The electronic device 1000 may acquire a card image, using a camera module. The payment management module 1031 may acquire a card image through an OCR module. The payment management module 1031 may receive a user's input of information (e.g., a secret code, a home address, an e-mail address, a phone number, or an account ID) associated with the card information or acquire the information from the payment server 720.

According to an embodiment of the present disclosure, the payment management module 1031 may display a registered card to the user through a display (e.g., the display 160). The user may revise at least a part of the information (e.g., a card name, a home address, a phone number, the number of times of payment trials, or information on whether payment notification information has been received or not) of the registered card. The payment management module 1031 may display transaction details of each card. The payment management module 1031 may display the registered card information in a wearable device (e.g., a smart watch) functionally connected to the electronic device.

According to an embodiment of the present disclosure, the payment management module 1031 may perform a payment operation using a registered card. For payment, the user may select one card among a plurality of registered card. The user may take the electronic device 1000 to a POS device 740. The payment management module 1031 may display product information (e.g., price) received from the POS device 740 through the display 160. The payment management module 1031 may perform user authentication (e.g., fingerprint authentication) through the authentication module 1035 for payment. When the authentication has been completed, the payment management module 1031 may display notification information reporting completion of payment through the display 160.

According to an embodiment of the present disclosure, the electronic device 1000 may transmit payment information to the POS device 740, using at least one module among the MST module and the NFC module. In order to raise the recognition rate, the electronic device 1000 may transmit the payment information to the POS device 740, simultaneously using the MST module and the NFC module. Otherwise, the electronic device 1000 may use the MST module in transmission and may use the NFC module in the transmission when the payment has failed. A method of recognizing a case wherein the payment has failed may include reception of a notification from the POS device 740 or a 3rd party (e.g., financial institution) or lapse of a certain time. Various embodiments are not limited to the sequence described above and allows an opposite sequence.

According to an embodiment of the present disclosure, an electronic device 1000 may receive a request for removal of at least one card among already registered cards from a user. The payment management module 1031 may delete information corresponding to the at least one card from the memory 130. The payment management module 1031 may request the payment server 720 to delete the information corresponding to the at least one card.

According to an embodiment of the present disclosure, the payment management module 1031 may determine whether the owner of the card is identical to the user performing the card registration. The payment management module 1031 may include, for example, an ID&V module. The payment management module 1031 may perform user authentication through text messages, an e-mail, an automatic route selection (ARS), a phone call, and the like. Further, the authentication may be performed through an application issued by a card company or bank. The card registered through the payment management module 1031 may be used after being authenticated.

According to an embodiment of the present disclosure, the payment management module 1031 may include an OCR module. The OCR module may acquire, through a scanner, an image of a letter written by a human or printed by a machine and convert the image to a machine-readable letter. The electronic device 1000 may acquire an image of a card possessed by a user, through a camera module. The OCR module may convert an image, a letter, or a number written in a card, obtained from a card image, to a machine-readable letter. The OCR module may acquire card information (e.g., card number, user name, or valid period) of the user from converted letters. The electronic device 1000 may acquire the card information of the user through the OCR module and perform a card registration process.

According to an embodiment of the present disclosure, the payment management module 1031 may display a bar code generated for payment through the display 160. For example, the payment management module 1031 may receive a command indicating generation of a bar code for payment through a bar code reader from the POS device 740. The payment management module 1031 may generate a bar code based on the command.

According to an embodiment of the present disclosure, the server interworking module 1033 may receive a payment-related message, a device-related message, or a service-related message from the payment server 720 or the token service provider 730. The server interworking module 1033 may transfer the message to the payment management module 1031.

According to an embodiment of the present disclosure, the server interworking module 1033 may include, for example, a push management module and an account management module. For example, a message received from the payment server 720 may be processed by the push management module when the message is in the form of a push notification associated with a token, and may be processed by the account management module when the message relates to account-related information (e.g., Samsung account).

According to an embodiment of the present disclosure, the push management module may calculate or handle the push notification or push message information received from the payment server 720. The push message may be transferred to the server interworking module 1033 within the payment application 1030 through a payment relay module 1041 within the payment manager 1040 or 354 or directly transferred to the payment application 1030. At least some messages among transferred push messages may be transferred to the payment management module 1031 to update card-related information and be synchronized with the payment server 720.

According to an embodiment of the present disclosure, the payment server 720 may include an account server for managing account-related information or a token requester server for providing payment-related information. The account server and the token requester server may be implemented as a separate device (e.g., the server 106) and may be included in a single device.

According to an embodiment of the present disclosure, the message information received by the push management module may include token and payment related information, such authority configuration (e.g., token provisioning), suspension (e.g., token suspension), disposal (e.g., token disposal), state change (e.g., token status change), additional issuance (e.g., token replenishment), and payment identification (e.g., transaction notification), as shown in Table 1 below.

The messages transmitted/received by the account management module may include at least a part of electronic device-related information, a lost electronic device identification function (e.g., lost device, find my mobile), remote blocking (e.g., remote lock/unlock), membership management (e.g., loyalty/membership cards), a web-linked function (e.g., website portal-on-line).

TABLE 1

| Push | | |
|---|---|---|
| management | Use case | details |
| Token | Token provisioning with | Card information for identification or |
| | ID & V | verification is sent down for installation and |
| | | authentication of a token from an external |
| | | server to a push management module within an |
| | | electronic device |
| | Token suspension | Transferred, for interruption of use of a token, |
| | | from an external server to a push management |
| | | module within an electronic device |
| | Token resume | Transferred from an external server to a push |
| | | management module within an electronic |
| | | device, for restart of use of a token |
| | Token disposal | Transferred from an external server to a push |
| | | management module within an electronic |
| | | device, for removal of a token |
| | Token status change | Transferred from an external server to a push |
| | | management module within an electronic |
| | | device, for card state change |
| | Token Replenishment | Transferred from an external server to a push |
| | | management module within an electronic |
| | | device, for additional issuance of a token |
| | Transaction Notification | Token payment details are transferred from an |
| | | external server to a push management module |
| | | within an electronic device |
| Device | Lost Device (Find my | Transfer of loss history information between an |
| | mobile) | external server (service server) and an account |
| | | management module within an electronic |
| | | device |
| | Remote lock/unlock | Transfer of a remote device blocking command |
| | | between an external server (service server) and |
| | | an account management module within an |
| | | electronic device |
| | Loyalty/Membership | Transfer of membership information between |
| | cards | an external server (service server) and an |
| | | account management module within an |
| | | electronic device |
| | Website (online) | Support of a Web-linked function between an |
| | | external server (service server) and an account |
| | | management module within an electronic |
| | | device |

According to an embodiment of the present disclosure, when token provisioning ID&V information acquired by the payment management module is successfully transferred to an external server through the payment server 720 and the transferred token-related information is valid, the server interworking module 1033 may receive, for example, a “push token {id} status changed” message and transfer the received message to the payment management module 1031.

According to an embodiment of the present disclosure, in regard to card information temporal suspension information (e.g., token suspension) acquired by the payment management module 1031 of the electronic device 1000, a use stop command of the payment server 720 may be transferred to the payment application 1030 to switch the card configuration state for mobile payment from the active state to the inactive state.

According to an embodiment of the present disclosure, when the electronic device 1000 is lost, the payment server 720 may delete or temporarily stop all token information associated with the electronic device 1000 stored in the payment server 720. In order to synchronize the deleted or temporarily stopped information with the payment application 1030, the payment server 720 may transmit a push message. For example, the payment server 720 may transfer information necessary for the synchronization to the payment application 1030 through the payment management module 1031 or the server interworking module (e.g., a Push management module or an account management module) 1033.

Referring to Table 2, showing contents of push APIs supported by an electronic device and the payment management module 1031, the APIs may be distinguishably and separately implemented according to the payment management module 1031.

TABLE 2

| API | Description | type | validation |
|---|---|---|---|
| device.push | Contains push | Json | required |
| | platform | | |
| device.push.spp.id | Samsung Push Id. | String | required |
| device.push.gcm.id | Google Push Id. | String | optional |

According to an embodiment of the present disclosure, the account management module may transfer, to the payment application 1030, information including a user-specific identifier (e.g., Samsung account ID or device ID), card, or membership which the module exchanges with the payment server 720, and the payment application 1030 may manage the received information. The user identifier may include an account, which a user has joined in order to manage cards (e.g., a VISA card or a MASTER card) of various business providers, a portal account associated with an electronic device, or a unique identifier (e.g., a model name, a MAC address, an international mobile equipment identity (IMEI), a serial number, a universally unique ID (UUID), an ID, and the like) of an electronic device. In addition, the unique identifier may have a value which has been generated by and transferred from the payment server 720 through the account.

The account management module may manage registration, addition, deletion, repeated registration, use suspension, or use restart of a card, using the account of the user or the identifier of the electronic device. Moreover, in the case of transmitting (importing/exporting) card information between an electronic device and a wearable device also, the account management module may manage registration, addition, deletion, repeated registration determination, use suspension, or use restart of a card, based on the generated account or electronic device identifier.

Here, a management method based on an account may manage a plurality of electronic devices or a plurality of users sharing one account to use a unique account (e.g., Samsung account) for each electronic device or synthetically manage a plurality of electronic devices by one account.

According to an embodiment of the present disclosure, information of a first card (e.g., VISA™ card) and a second card (e.g., MASTER™ card) generated through an OCR module of the payment management module 1031 may be used to register the cards based on an account (e.g., registration02@samsung.com) generated at the time of joining the Samsung account. The registered information may be synchronized based on the generated account and the payment server 720.

According to an embodiment of the present disclosure, membership information generated through a bar code interface may be used to register the first card (e.g., Samsung point card) and the second card (e.g., CJ membership point card) based on an account (e.g., registration01@samsung.com) generated at the time of joining the Samsung account. The registered information may be synchronized based on the generated account and the payment server 720.

Further, the user may determine the active/inactive states of the card based on the account after logging-in through the payment application and transfer the determination to the payment server 620 or 720 using the account management module 1031, and on the contrary, may change the management of the card state based on an account in a server management web page (e.g., a server portal).

Further, the account management module may manage, while interworking with the server, the card information (e.g., VISA™ card ID&V) and membership information (e.g., membership points, registraion001@Cj.com) associated with a service account (e.g., registration01@samsung.com). The membership information may be linked, at the time of card payment, to payment processing information (e.g., payment amount) and membership accumulation information (e.g., points or mileage) to automatically accumulate or subtract the points or mileage.

In the account management method described above, when a payment application including an account management module has been installed, the configuration state of a part or all of an existing registered card can be continuously linked and used by only one time of an account login (or sign-in) process by a user in any device. Further, in the account management method, even membership information having a relatively low authentication security level can be registered and linked based on an account of the user to reduce additional authentication processes.

According to an embodiment of the present disclosure, the authentication module 1035 may display a UI for authentication of a user or a card for payment through the display 160. The authentication module may include, for example, a biometric information module.

According to an embodiment of the present disclosure, the biometric information module may acquire biometric information of a user. The biometric information of the user may include, for example, information of, a fingerprint, an iris, a face image, voice, cardiac impulse, or blood pressure. The electronic device may acquire biometric information of a user through a sensor module. For example, the electronic device may acquire fingerprint information of a user through a fingerprint sensor. Otherwise, the electronic device may acquire iris information of a user through a camera module. The biometric information module may display a UI for acquiring biometric information of a user through the display 160.

According to an embodiment of the present disclosure, when a user tries payment using card information registered in an electronic device, the biometric information module may perform an authentication in order to acquire security data (e.g., token) from a security memory (e.g., eSE or memory accessible in a secure environment) functionally connected to the electronic device. The electronic device may acquire biometric information (e.g., fingerprint or iris) of the user through the biometric information module for user authentication. The acquired biometric information may be transferred to a biometric information management module 1043 of the payment manager 1040. According to one embodiment of the present disclosure, the security memory may be a memory including data stored by encryption key.

According to an embodiment of the present disclosure, the biometric information management module 1043 may proceed with payment, using card information and biometric information registered in the electronic device, when the user proceeds with electronic payment on an Internet web page. In order to acquire security data (e.g., token) from a memory or security module (e.g., an eSE or a memory accessible in a secure environment) functionally connected to the electronic device, the user may perform an authentication. When user authentication has successfully progressed in an electronic device, the electronic device may be linked to an external server to enable fast automatic authentication (e.g., fast ID online (FIDO)) of the processed authentication information, without electronic payment on a separate Internet web page. For example, instead of an authentication process required at the time of on-line payment, the electronic device may perform a fast authentication by liking with the biometric information management module 1043.

According to an embodiment of the present disclosure, the electronic device may previously appoint a fingerprint of a user and a card to be used for payment. For example, when the user performs authentication using a fingerprint in the payment application, the user may appoint his or her right hand thumb to VISA™ card and his or her right hand index finger to MASTER™ card, and the electronic device 1000 may distinguish the types of information according to user authentication and support payment by a related card based on the distinguished information.

According to an embodiment of the present disclosure, the peripheral device management module 1037 may manage an external device functionally connected to an electronic device. The peripheral device management application 1037 may include, for example, an MST surrounding device module and a wearable device module.

According to an embodiment of the present disclosure, the MST peripheral device module may determine whether an MST accessory (e.g., fob type device of LoopPay™) and the electronic device are wirelessly or wiredly connected or not, and may provide a UI proper for the user on the basis thereof. The UI may progress and output information associated with a process of card registration or deletion, or payment in a state where the MST accessory has been connected thereto. The MST peripheral device module may store various card information necessary for payment in the electronic device or a separate memory within the electronic device or MST accessory, in a state where the electronic device is connected to the MST accessory. As a result, the electronic device or MST accessory can independently progress the payment in a state where the MST accessory is not connected.

The wearable device module may determine whether a wearable device (e.g., watch, headset, glasses, or ring) and the electronic device are wirelessly or wiredly connected or not, and may provide a UI proper for the user on the basis thereof. The wired or wireless connection may include various interface connections, such as BT, BLE, WiFi, Zigbee, or Z-wave, and may be implemented by applying a particular accessory protocol (samsung accessory protocol (SAP)). The UI may progress and output information associated with a process of card registration or deletion, or payment in a state where the wearable device has been connected thereto. In the process of card registration, deletion, or payment, the wearable device module may output information on whether to generate a short range-based secure session with the wearable device, transmit or receive a user input value on the electronic device or wearable device, and display a result of the transmission or reception. The input of the user may include various card information required for payment and other additional authentication information (e.g., personal ID number (PIN), user-specific pattern-related data, fingerprint recognition-related data, a touch input value of the display 160 or wearable device bezel unit).

According to an embodiment of the present disclosure, the electronic device may share one piece of payment information with the wearable device or accessory. For example, information on one VISA™ card may be stored in both the wearable device and the electronic device. According to an embodiment of the present disclosure, the electronic device may store different pieces of card information generated from one piece of card information in the wearable device and the accessory, respectively. For example, among different tokens issued from one piece of VISA™ card information, one token may be stored in the electronic device while the other token is stored in the accessory or wearable device. According to an embodiment of the present disclosure, when a different token issued from one piece of card information is stored in the electronic device while the other token is stored in the accessory or wearable device, if a payment module of one device is activated, a payment module of the other device may be deactivated. For example, among different tokens issued from one piece of VISA™ card information, if one token is stored in the electronic device while the other token is stored in the accessory or wearable device, payment of the electronic device may be deactivated when the payment is performed by the wearable device. In addition, when the payment is performed by the electronic device, payment by the wearable device may be deactivated.

According to an embodiment of the present disclosure, the payment manager 1040 may include, for example, a payment relay module 1041, a biometric information management module 1043, and a security environment relay module 1046. According to an embodiment of the present disclosure, the payment relay module 1041 may relay a card or information (e.g., token) corresponding to the card to the payment application, kernel, or payment server 720. The payment relay module 1041 may perform off-line payment through a communication module (e.g., NFC module or MST module). A payment method using the NFC may be operated through a POS device, and a payment method using the MST may be operated by a user input. Further, the payment relay module 1041 may perform on-line payment through a communication module (e.g., a cellular module, an RF module, a Wi-Fi module, and the like).

According to an embodiment of the present disclosure, the payment relay module 1041 may perform state management (e.g., card/token life cycle management) of a card or information (e.g., token) corresponding to the card. The payment relay module 1041 may provide at least one API associated with payment to the payment application 1030.

According to an embodiment of the present disclosure, the payment relay module 1041 may further include at least one interface provided by system services associated with payment, and system service interfaces, which provide security UIs for a payment service for access to a payment module, trustzone-based integrity measurement architecture (TIMA) for kernel integrity authentication, fingerprint recognition result inquiry (e.g., supporting both the security and non-security mode), and a PIN or a PAN input. The payment relay module 1041 may include an encryption library in order to transfer a message or command to the TEE 1020. The payment relay module 1041 may transmit or receive a message or command with the TEE 1020 through the encryption library.

According to an embodiment of the present disclosure, the payment relay module 1041 may perform a card management function which provides functions of addition, deletion, or update of a card, as general card management functions. The payment relay module 1041 may include a first payment SDK or a second payment SDK. The first payment SDK (e.g., Samsung SDK) may be embedded in an electronic device. The second payment SDK may be provided by a card company or bank and may be installed in an electronic device. From the first payment SDK or second payment SDK, the payment relay module 1041 may select a payment SDK corresponding to card information. Further, the payment relay module 1041 may set a basic card or select another card other than the basic card.

According to an embodiment of the present disclosure, the payment relay module 1041 may transmit messages, such as token provisioning, token replenishment, token suspension, token resume, and token disposal, as a general token and key management function, to the payment server 620 or 720.

According to an embodiment of the present disclosure, a payment module 1021 may acquire a token and a token cryptogram from the electronic device or another external electronic device. A key (e.g., limited used key (LUK) or single used key) capable of generating the token or token cryptogram may be stored in the REE 1010 or TEE 1020. Moreover, when the token and the key are stored in the REE 1010, the payment module of the TEE may encrypt and store the token and key, using the key (e.g., device root key (DRK)) of the TEE 1020. When the electronic device performs payment, the payment relay module 1041 may acquire the encrypted token in a decrypted state through the payment module. When the token or key capable of generating the token cryptogram is stored in the TEE, the electronic device may store the token or key in an encrypted form, using the key of the TEE.

According to an embodiment of the present disclosure, the payment relay module 1041 may receive a push message from the TSP 730 and transfer the push message to the payment application 1030.

According to an embodiment of the present disclosure, when the first payment SDK (provided by a card company or bank) provides a self-token management function, the payment relay module 1041 may further include a function of relaying a token management function request to the second payment SDK when receiving the request. For example, the payment relay module having acquired a token or key, using an SDK of VISA™ card, may transfer the token or key to the payment module within the TEE 1020, using a Samsung™ SDK. According to one embodiment of the present disclosure, the payment relay module 1041 may further include, on a payment framework, a host card emulation (HCE) function which enables a virtual card to be used in an electronic device by only software without a separate hardware device (e.g., a security module or a secure element (SE)) at the time of payment. The HCE function may transfer a token and a token cryptogram through a communication module (e.g., NFC), using a message standard (e.g., application protocol data unit (APDU)) associated with POS.

According to an embodiment of the present disclosure, the payment relay module 1041 may include a function of processing a message received from a POS device. The POS-related message processing function may include a function of managing payment data to be sent to the POS device as a response. The POS-related message analysis function may include a function of, when the first payment SDK provides a self POS-related message processing function, relaying the POS-related message to the first payment SDK. According to an embodiment of the present disclosure, the payment relay module 1041 may include at least one database for storing the card data, token data, or transaction data.

According to an embodiment of the present disclosure, the payment relay module 1041 may select at least one method among a payment method using NFC and a payment method using MST. For example, the payment relay module 1041 may select one method among a method of first performing payment using NFC and performing payment using MST, a method of first performing payment using MST and performing payment using NFC, and a method of performing payment simultaneously using NFC and MST. According to an embodiment of the present disclosure, in the case of first performing payment through one communication module and performing payment through another communication module, the payment relay module 1041 may perform payment through the another communication module when there is no response to a result of payment performance from the communication module having first performed the payment or after passage of a certain time.

According to an embodiment of the present disclosure, in the case of having both token information and PAN information for one card, the payment relay module 1041 may use at least one of the token information and PAN for payment. The payment relay module 1041 may determine whether a POS device can perform payment using PAN or using a token. For example, the electronic device may receive payable information through BLE, and the payment relay module 1041 may identify the information. Based on the identified information, the payment relay module 1041 may perform the payment using a toke when the token is available for the payment and using PAN when the PAN is available for the payment.

According to an embodiment of the present disclosure, the payment relay module 1041 may further include an SDK provided by a payment network. The SDK may further include token management, POS-related message processing, or token/card databases.

According to an embodiment of the present disclosure, the security environment relay module 1046 may further include a function enabling a payment application to access a biometric information driver module 1051 or a security environment driver module 1053 in order to use functions provided by the payment module 1021 or a biometric information module 1025. The payment relay module 1041 may include an encryption library in order to transfer a message or command to the security environment relay module 1046. The payment relay module 1041 may transmit or receive a message or command with the security environment relay module 1046 through the encryption library.

Various embodiments of the present disclosure may further include a security environment relay module 1046 connected to enable the payment application to use functions of the security identifier processing module of the TEE, in the payment manager 1040.

According to an embodiment of the present disclosure, the payment relay module 1041 may include a function of relaying an authentication request through a PIN input by the payment application 1030 to a security identifier processing module 1023 of the TEE 1020.

When there is a request for fingerprint recognition, a general application may acquire information on whether the recognition is success or failure. The security payment application (payment trusted app) may acquire a security biometric result (secure fingerprint result). The security biometric result may have a form encrypted by combining a disposable random number and information of success/failure. The disposable random number may be encrypted through a hardware key (e.g., DRK) of the TEE 1020.

According to an embodiment of the present disclosure, the payment relay module 1041 may transfer a message requiring execution of payment to the payment module 1021 through the security environment driver module 1053 in order to perform payment. The payment module 1021 may notify the payment relay module 1041, through the security environment driver module 1053, that an authentication operation is necessary. The payment relay module 1041 may issue a command requiring the biometric sensor 2401 to acquire biometric information through the biometric information management module 1043 and the biometric information driver module 1051. In addition, the payment relay module 1041 may transfer an authentication identification message to the biometric information module 1025 of the TEE 1020 through the biometric information management module 1043 and the security environment driver module 1053.

The biometric sensor 240I may be included in the biometric information module 1025 of the TEE 1020. The biometric information module 1025 may identify a user's identity by comparing pre-stored biometric information of the user and information acquired by the biometric sensor. Based on the identified information, the biometric information module 1025 may transfer success or failure of authentication to the biometric information management module 1043 through the security environment driver module 1053, and the biometric information management module 1043 may transfer the received information to the payment relay module 1041. The payment relay module 1041 and the biometric information management module 1043 may be configured to be integrated in a single construction or configured as separate modules.

According to an embodiment of the present disclosure, the payment relay module 1041 may perform an authentication through an external device. For example, the electronic device 1000 may request the payment server (e.g., Samsung account server or token requester server) 720 to authenticate biometric information (e.g., fingerprint or iris). The payment server 720 may perform authentication of biometric information of a user and transfer a result of the authentication to the electronic device 1000. When the authentication has been completed, the payment relay module 1041 may perform a token provisioning process by transferring data including information that the authentication has been completed to the token service provider. Further, according to a result of the authentication, the electronic device 1000 may perform payment when the authentication is successfully completed, or may not perform payment when the authentication fails or is not completed.

According to an embodiment of the present disclosure, the kernel 1050 may include, for example, the biometric information driver module 1051 and the security environment driver module 1053. The biometric information driver module 1051 may transfer a message transferred from the biometric information management module 1043 of the payment manager 1040 to the biometric sensor 240I. The biometric information obtained by the biometric sensor may be transferred to the biometric information module 1025 within the TEE 1020 instead of being transferred to a module within the REE 1010 through the biometric information driver module.

According to an embodiment of the present disclosure, the security environment driver module 1053 may perform as an interface for transfer from a module in the REE 1010 to a module in the TEE 1020. For example, in the case of the Trustzone of ARM, which is an embodiment of the TEE, an AP time-divisionally performs the operations of the REE and the TEE, and a separate data path for transferring a message from the REE to the TEE may be implemented by hardware. In this event, a driver module for accessing the hardware may be the security environment driver module 1053. The security environment driver module may transfer a message relating to an operation of a module in the TEE to a module in the REE.

According to an embodiment of the present disclosure, the TEE may include, for example, the payment module 1021, the security identifier processing module 1023, the biometric information module 1025, and an MST driver module 1027. The electronic device 710 may store data requiring a relatively high security and perform related operations in a safe environment through the TEE 1020. The TEE 1020 may operate on an AP of an electronic device, and a reliable TEE determined in the step of manufacturing an electronic device may refer to a security area within the electronic device. The electronic device may process data requiring a relatively high security based on a safe hardware structure through the TEE. The TEE may enable the AP and the memory area to operate in a state of being divided into a general area and a security area. Moreover, the TEE may enable software or hardware requiring security to operate in only the security area. When the REE 1010 is required to perform an operation related to sensitive information, the electronic device may be allowed to access the TEE 1020 only through an API and a driver capable of accessing the TEE 1020. The TEE 1020 may hand over limited data on related information to the REE. The TEE may encrypt internally stored data through a hardware key (e.g., DRK). Without a separate decryption process, the REE may unable to interpret data within the TEE.

An application (e.g., a security application (a trusted application) or a payment module) within the TEE 1020 may transfer a message to another electronic device (e.g., the token service provider 730) outside of the electronic device.

According to an embodiment of the present disclosure, the TEE may include a trusted OS and a security application (trusted application). In addition, the TEE may include an encryption module related to the security, a driver capable of collecting data in hardware requiring security, and the like. The security application (trusted application) may include a payment module. In addition, the trusted application may transfer payment information to the outside through a communication module. For example, the trusted application may transfer the payment information to the MST controller through the MST driver or the NFC controller through the NFC driver to transmit the information to a POS device.

According to an embodiment of the present disclosure, the trusted application may determine whether the REE 1010 has an integrity. The electronic device may store, in the TEE 1020, information on whether the REE has an integrity. According to a booting sequence in the case of an REE booting that supports the TEE, when a boot loader is executed, the TEE may be first booted and the REE is booted. When the TEE is booted, the integrity information of the REE is identified in the TEE, and the identified information may be reported to a user after the REE booting. According to one embodiment of the present disclosure, when the image of REE has been damaged due to hacking or rooting, the REE may determine that the integrity thereof is problematic. When the integrity is problematic, the REE may be prohibited to access the TEE. For example, when the payment relay module 1041 tries to transfer a message or command to the TEE through the security environment driver module 1053, a kernel of the TEE may disregard the message or command or deny to receive the message.

According to an embodiment of the present disclosure, the payment module 1021 may be an application installed by a bank or card company (e.g., VISA™ card or MASTER™ card). There may be at least one payment module. When a user accesses, in an electronic device, the payment server (e.g., mobile application platform, payment gateway, token requester, token service provider, trusted service manager, or bank server) 720 or the token service provider 730, using the payment management module 1031, and approves to install the payment mobile 1021, the token service provider 730 may perform operations associated with the installation. For example, the payment management module 1031 may acquire a card number and valid term information of a plastic card through OCR, and perform a card registration operation for installing the payment module 1021 in the server. The payment management module may connect to the token service provider 730 in the network through the payment relay module 1041 having connection information of the token service provider 730 according to each card/bank company to receive an installation file, and the payment relay module 1041 may transfer the information to the TEE to install the payment module 1021. The process described above may be called a provisioning process or card registration process. There may be a plurality of payment modules 1021 of the TEE. Each payment module is unable to exchange data within the TEE and may be configured in an isolated form.

According to an embodiment of the present disclosure, the payment module 1021 may be an application to be used for data communication with the payment server 720. The payment module may include information of a credit card, a debit card, a membership card, and the like. The payment module may communicate with another external electronic device through encryption. The encryption process may be different according to the card manufacturing company having transferred the payment module. The server may control the state of the payment module. For example, the server may activate, temporarily suspend, resume, or delete (dispose) the payment module.

According to an embodiment of the present disclosure, the payment module 1021 may store information related to the card information. For example, the stored information may include at least one among a token, a token reference ID, a part of a PAN, a PAN product ID, a token requester ID, a token assurance level, token assurance data, a valid term of a token, an encryption key, and a value (e.g., OTP) provided by the token service provider 730, which correspond to the card information (e.g., PAN). The token may be controlled by the state of the token service provider 730. For example, the token may be activated, temporarily suspended, resumed, or deleted (disposed). The token may be static information basically corresponding to the card information (e.g., PAN).

According to an embodiment of the present disclosure, the payment module 1021 may determine a card to be used for payment. For example, a payment module corresponding to a card selected by the user in at least one payment management module 1031 may be determined according to a user's selection. The payment management module may transfer the determined card to the payment relay module 1041. The payment relay module may transfer the determined card information to the payment module 1021 through the security environment driver module 1053. The payment module may manage a list of cards actually used in the payment among possessed cards. The list of cards actually used in the payment may be changed based on the determined card information. The changing may include a method of raising the priority of the determined card information in the card list or a method of deleting the other card information except for the determined card information.

According to an embodiment of the present disclosure, the payment module may generate information used for the payment based on the information associated with the card information when the payment is executed. The information used for the payment may include a token, a token reference ID, a part of a PAN, a PAN product ID, a token requester ID, a token assurance level, token assurance data, a valid term of a token, a token cryptogram, a POS entry mode, a token requester indicator, and the like, as shown in Table 3 below.

TABLE 3

| Field Name | Comment |
|---|---|
| Payment | The Payment Token number refers to a surrogate value for a PAN that is a |
| Token | 13 to 19-digit numeric value that passes basic validation rules of an account |
| | number, including the Luhn check digit. Payment Tokens are generated |
| | within a BIN range or Card range that has been designated as a Token BIN |
| | Range and flagged accordingly in all appropriate BIN tables. Payment |
| | Tokens are generated such that they will not have the same value as or |
| | conflict with a real PAN. |
| | Transaction messages |
| | The Payment Token number will be passed through the authorization, |
| | capture, clearing, and exception messages in lieu of the PAN. |
| | The Payment Token number may optionally be passed from the Token |
| | Service Provider to the Card Issuer as part of the authorization request. |
| Token Expiry | The expiration date of the Payment Token that is generated by and |
| Date | maintained in the Token Vault. The Token Expiry Date field carries a 4- |
| | digit numeric value that is consistent with the ISO 8583 format. |
| | Transaction messages |
| | The Token Expiry Date is passed in lieu of PAN Expiry Date. |
| | The value is replaced by the Token Service Provider with the PAN Expiry |
| | Date which is then passed to the Card Issuer as part of the authorization |
| | request. |
| Last 4 Digits | The last four digits of the PAN to be provided optionally through the |
| of PAN | Acquirer to the Merchant for customer service usage, such as being printed |
| | on the consumer receipt. |
| PAN Product | The last four digits of the PAN to be provided optionally through the |
| ID | Acquirer to the Merchant for customer service usage, such as being printed |
| | on the consumer receipt. |
| PAN Product | The PAN Product ID is an optional identifier used for determining the type |
| ID | of Card product that was tokenized. It may be included in cases where |
| | transparency of this information is necessary. |
| | Transaction messages |
| | The PAN Product ID may optionally be passed from the Token Service |
| | Provider to the Acquirer as part of the authorization response. |
| POS Entry | This specification uses the POS Entry Mode field to indicate the mode |
| Mode | through which the Payment Token is presented for payment. Each Payment |
| | Network will define and publish any new POS Entry Mode values as part |
| | of its existing message specifications and customer notification procedures. |
| | Transaction messages |
| | POS Entry Mode is an existing field that will be passed through the |
| | authorization, capture, clearing, and exception messages. |
| Token | This value uniquely identifies the pairing of Token Requestor with the |
| Requestor ID | Token Domain. Thus, if a given Token Requestor needs Tokens for |
| | multiple domains, it will have multiple Token Requestor IDs, one for each |
| | domain. It is an 11-digit numeric value assigned by the Token Service |
| | Provider and is unique within the Token Vault: |
| | Positions 1-3: Token Service Provider Code, unique to each Token Service |
| | Provider |
| | Positions 4-11: Assigned by the Token Service Provider for each |
| | requesting entity and Token Domain |
| | Transaction messages |
| | Token Requestor ID can be optionally passed through the authorization, |
| | capture, clearing, and exception messages. |
| Token | Token Assurance Level is a value that allows the Token Service Provider |
| Assurance | to indicate the confidence level of the Payment Token to PAN/Cardholder |
| Level | binding. It is determined as a result of the type of ID&V performed and the |
| | entity that performed it. |
| | The Token Assurance Level is set when issuing a Payment Token and may |
| | be updated if additional ID&V is performed. It is a two-digit value ranging |
| | from 00 which indicates the Payment Token has no ID&V that has been |
| | performed to a value of 99 indicating the highest possible assurance. The |
| | specific method to produce the value is defined by the Token Service |
| | Provider. |
| | Transaction messages |
| | Token Assurance Level will be provided by the Token Service Provider. |
| | The value may be optionally passed to the Card Issuer as part of the |
| | authorization request. |
| | The value may optionally be passed to the Acquirer/Merchant in the |
| | authorization response, capture, clearing, and exception processing |
| | messages. |
| Token | This data provided by the Token Service Provider contains supporting |
| Assurance | information for the Token Assurance Level. |
| Data | Transaction messages |
| | This data may be optionally passed to the Card Issuer as part of the |
| | authorization request. |
| Token | This cryptogram is uniquely generated by the Token Requester to validate |
| Cryptogram | authorized use of the Token. The cryptogram will be carried in different |
| | fields in the transaction message based on the type of transaction and |
| | associated use case: |
| | NFC contactless transactions will carry the Token Cryptogram in existing |
| | chip data fields. |
| | Other transactions, such as those originating from a digital wallet, may |
| | carry the Token Cryptogram in an existing field. |
| | Transaction messages |
| | The Token Cryptogram will be passed in the authorization request and |
| | validated by the Token Service Provider and/or the Card Issuer. |
| Token | An indicator used to indicate that the message is intended to authenticate |
| Request | the Cardholder during a Payment Token Request. |
| Indicator | |

According to an embodiment of the present disclosure, the payment module 1021 may receive a key (e.g., LUK or single used key), by which a token cryptogram can be generated, through the token service provider 730 or the payment server 720 (e.g., payment service server or token requester server). The key may be transferred and received through a data network or an SMS.

The key may be exchanged using a security channel between the electronic device and the token service provider 730. The security channel may be a logical channel for encrypting data, which is exchanged by a separate key (e.g., a method using a public key or private key) different from the key described above. Moreover, the payment module may include a module for generating a key capable of generating a token cryptogram. The electronic device may receive the module for generating the key, through the token service provider 730 or the payment server 720. Otherwise, the module may be included in the step of manufacturing the electronic device.

According to an embodiment of the present disclosure, the payment module may generate a token cryptogram, using a key (e.g., LUK or single used key) capable of generating the token cryptogram. The payment module may use different keys according to a certain rule, for example, in each transaction, in a certain number of times of transaction, or a transaction within a particular time. The token service provider 730 may possess a key paired with the above-described key. The token service provider 730 may decrypt the encrypted token cryptogram through the paired key.

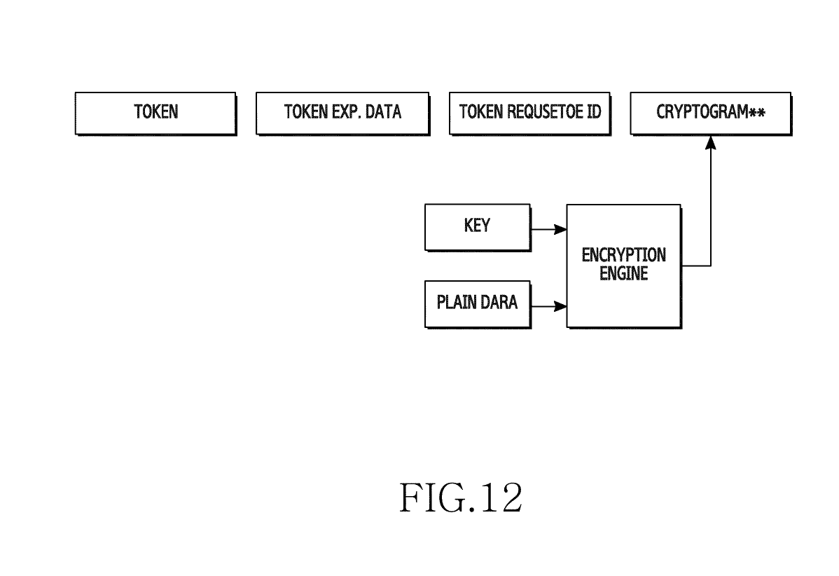

According to an embodiment of the present disclosure, the payment module 1021 may generate a token cryptogram, using a key capable of generating the token cryptogram. A more detailed description thereof will be given later with reference to FIG. 12.

According to an embodiment of the present disclosure, when the payment is performed, the electronic device 1000 may transfer a message reporting that the payment application will perform the payment, to the payment relay module 1041. The payment relay module 1041 may determine whether to use MST or NFC for the payment. In the case of using MST for the payment, the payment relay module may acquire information (e.g., token, token cryptogram, a part of PAN information, token valid period, and the like) necessary for payment from the payment module of the TEE and transfer the information to the MST driver module 1027 in the TEE. The MST driver module 1027 may transfer the information to the MST controller. The MST controller may transmit the information in order to perform the payment.

According to an embodiment of the present disclosure, when using the NFC for the payment, the electronic device 1000 may transfer the information necessary for the payment to the NFC driver module of the TEE. The NFC driver module may transfer the information necessary for the payment to the NFC controller. The NFC controller may perform the payment based on the information.

According to an embodiment of the present disclosure, in the case of using the NFC for the payment, the electronic device 1000 may perform the payment when receiving a certain message from a POS device. For example, when the NFC module detects a certain message transferred from the POS device, the NFC controller may transfer the message to the NFC driver module. The NFC driver module may report to the payment relay module 1041 of the REE that the message transferred from the POS device has been received. The payment relay module 1041 may generate a token cryptogram in order to perform payment. The token cryptogram may be generated in the payment module 1021 of the TEE, using a key (e.g., LUK or single used key) capable of generating the token cryptogram. The generated token cryptogram may be transferred to the REE. The payment relay module 1041 may transfer payment-related information including the token and token cryptogram through a network module (e.g., an NFC-related host card emulation module). The network module may the payment-related information to the POS device through the NFC module.

According to an embodiment of the present disclosure, the payment module 1021 may transfer information including the token, token valid period, token requester ID, and token cryptogram to an external electronic device. For example, the payment module 1021 may transfer the payment information to the POS device 740 through the MST communication module. In addition, the payment module 1021 may transfer the payment information to a POS device through NFC communication modules.

According to an embodiment of the present disclosure, the payment module 1021 may transmit or receive certain information to or from a POS device in the payment operation. In the case of NFC, the payment module may first receive the information from a POS device to perform the payment. In the case of MST, payment-related information including the token and token cryptogram may be transmitted, based on an explicit input from a user or an internal algorithm of the electronic device, to the POS device.

According to an embodiment of the present disclosure, the biometric information module 1025 may store biometric information of a user of the electronic device and compare the biometric information with information obtained by the biometric sensor to authenticate the user. The biometric information module 1025 may include a fingerprint information module or an iris information module. The biometric information module may collect information from the biometric sensor 240I. When the payment application shows, through the display 160, contents requiring authentication of the biometric information of the user, the user may transfer the biometric information through the biometric sensor. The authentication module of the payment application may transfer, through the biometric information management module, a message requiring collection of biometric information to the biometric information driver module 1051. The biometric information driver module may transfer the message to the biometric sensor. The biometric sensor may collect biometric information and transfer the biometric information to the TEE. The biometric information module of the TEE may compare the collected information with the stored biometric information of the user and transfer information on whether to authenticate the collected information, to the authentication module of the payment application through the security environment driver module and the biometric information management module of the REE. The payment application may show, through the display, whether to authenticate. The biometric information of the user may be stored in the TEE, stored in the REE in an encrypted state, or stored in the security module (e.g., an eSE) 236.

According to an embodiment of the present disclosure, the security identifier processing module 1023 may acquire, through a user input, an input value, which is necessary for the electronic device or is associated with payment or authentication. For example, the input value may be a PIN during payment. In addition, the input value may include information related to the card. For example, the information may include a PAN, a card valid term (expiration date), or card verification value (CVV). In addition, the information may include a chip PIN or ATM PIN. The security identifier processing module 1023 may be provided or indicated in the form of an application. A graphic library necessary for illustration of the application of the security identifier processing module 1023 on a screen may be stored in the TEE 1020. The graphic library stored in the TEE may be different from a graphic library in the REE 1010. The security identifier processing module 1023 may perform user authentication by an input value, such as a PIN, and may transfer a result of the authentication to the payment management module 1031 through the payment relay module 1041. According to an embodiment of the present disclosure, the security identifier processing module 1023 may receive an encrypted disposable random number (e.g., nonce) transferred through the security environment driver module 1053 by the security environment relay module 1046. The security identifier processing module 1023 may encrypt the disposable random number and the input value acquired through the user input, using an encryption key (e.g., device root key) in the TEE, and transfer the encrypted information to the security environment relay module 1046. The security environment relay module 1046 may transfer the encrypted input value and disposable random number to the payment module 1021 through the security environment driver module 1053. The payment module 1021 may decrypt the input value and disposable random number, using a hardware key in the TEE. The payment module 1021 may identify that the input value transferred through the REE has an integrity, based on the point that the generated value and the received value of the disposable random number are the same. The payment module 1021 may perform user authentication through the input value, based on the point that the input value has an integrity. The payment module 1021 may perform payment through user authentication. According to one embodiment of the present disclosure, a factory reset refers to an operation of returning a software image of an electronic device to the original state at the time when the electronic device is shipped from a factory. This operation may be performed as an explicit operation of a user through an application. Moreover, a module for determining and monitoring a hacking by a certain condition (e.g., when it is determined that the system has been hacked) may perform a factory reset. When the operation is performed, data stored in the electronic device is reset and the payment-related information of the user also may be thus reset. The payment-related information may be stored in the payment server 720. When the user accesses the payment server 720 based on an account, the electronic device 1000 may be allowed to perform operations of registering a card and installing a payment module again based on the payment-related information. When the data is reset, the payment-related module stored in the electronic device may notify the token service provider 730 of the resetting through the payment server 720 to deactivate the token service provider. When a network of an electronic device has been deactivated, it may be impossible to perform the operation of notification. In this event, the electronic device may perform the factory reset and access the account of the payment server 720 based on an account. The electronic device 1000 may identify a list of pre-registered cards through the payment server 720, and may deactivate a card module or token of the electronic device pre-registered in the token service provider 730 through the payment server 720. In addition, based on the card list of the payment server 720, the electronic device may perform card registration again and receive a payment module, token, and the like.

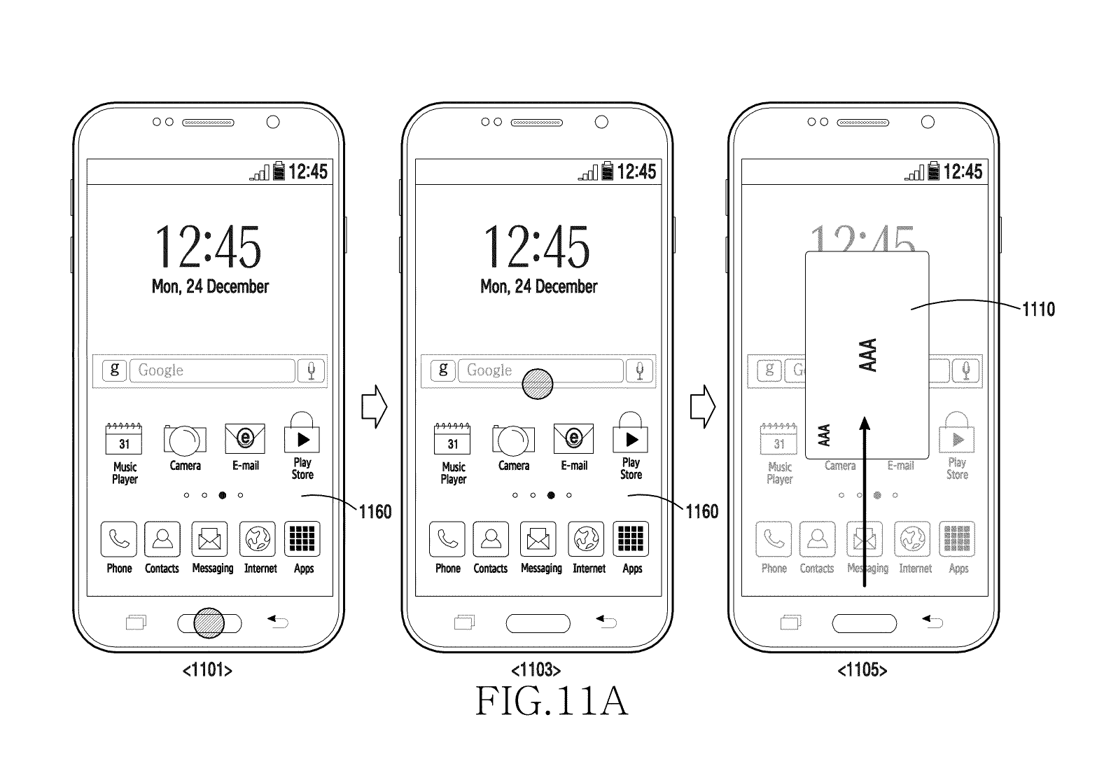

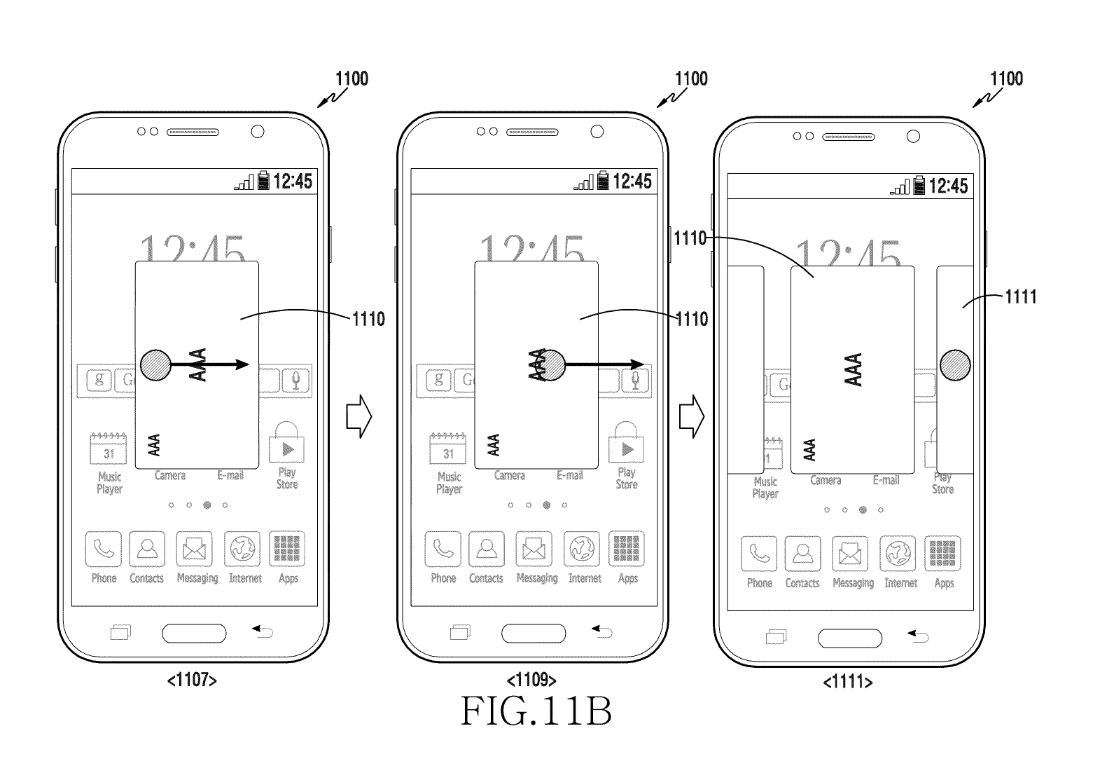

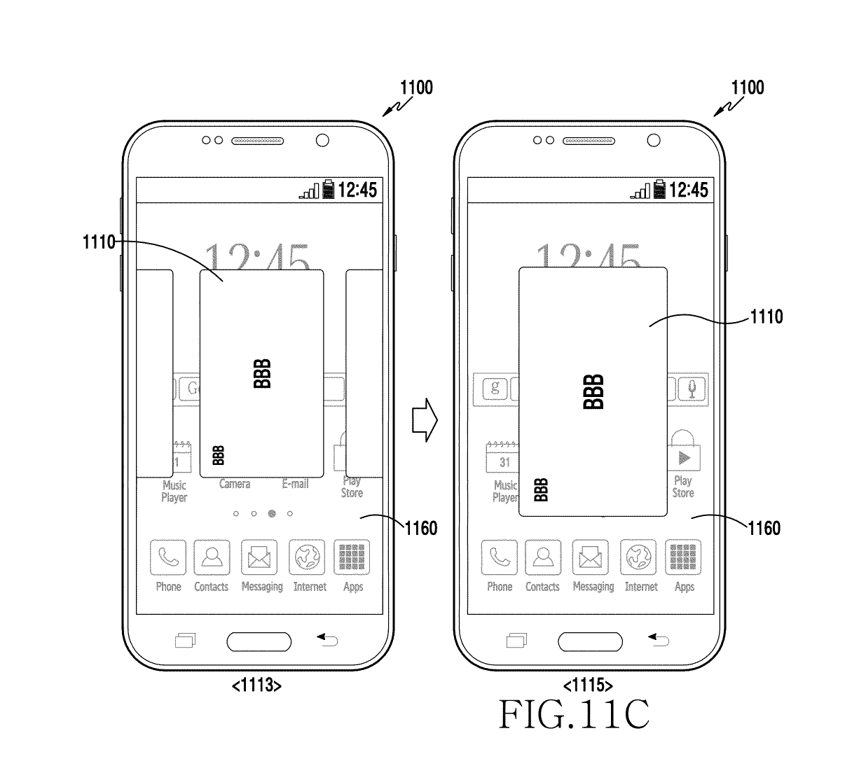

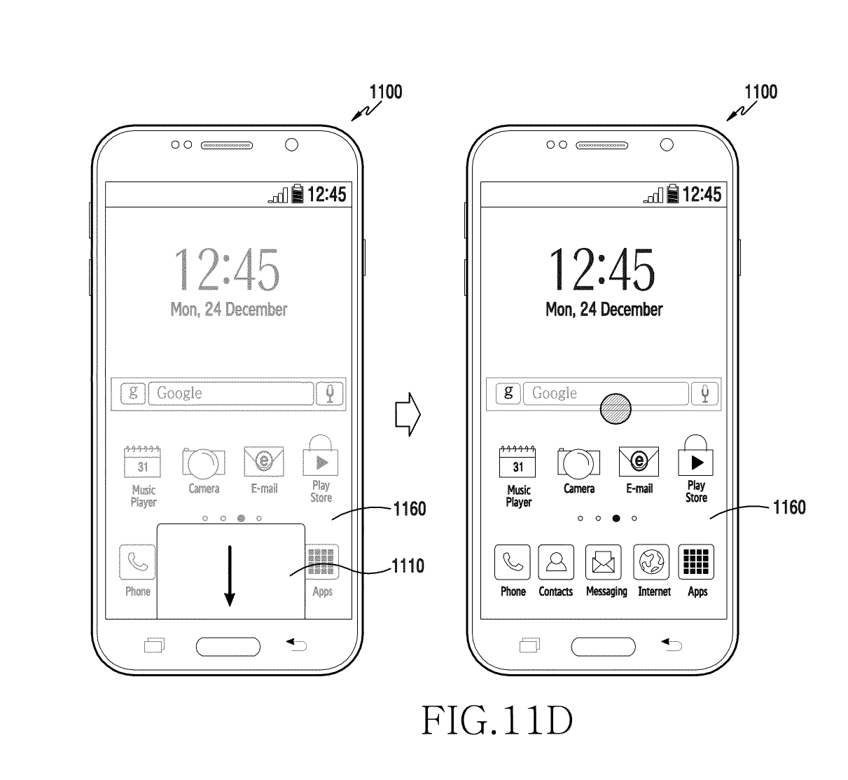

FIGS. 11A to 11D illustrate payment UIs of an electronic device according to various embodiments of the present disclosure.

Referring to FIGS. 11A to 11D, an electronic device 1100 may receive a user input and execute a payment application. For example, as in the states 1101 and 1103, the electronic device 1100 may execute a payment application (e.g., Samsung Pay™) when a user input of sweeping in a display direction from a lower end bezel area of the electronic device is generated. In response to the user input, the electronic device 1100 may display at least one card 1110 among cards already registered in the electronic device, through the display 1160, as in a state 1105.

According to an embodiment of the present disclosure, the electronic device 1100 may receive a user input and select a card to be used for payment among the pre-registered cards. For example, the electronic device 1100 may select a card to be used for payment among a plurality of cards, through a user input of leftward/rightward scrolling, as in the state 1107 or 1109. Otherwise, as in a state 1111, the electronic device 1100 may output a partial image 1120 associated with another card in an area adjacent to the card 1110. When the partial image 1120 is selected, the electronic device 1100 may support operation of a card corresponding to the selected image.

The electronic device 1100 may request authentication from the user for payment of the selected card, as in the state 1113. The authentication method may use, for example, biological information of a user. For example, the electronic device may scan a fingerprint of the user through the fingerprint detection module to perform a payment operation. When payment is in progress or in a standby state for payment, the electronic device 1100 may display the card 1110 on the display 1160, as in the state 1115. When a payment cancellation event (e.g., a sweep event or back key event for removal of the card 1110) is generated, the electronic device 1100 may remove the card 1110 from the display 1160, as in the state 1117. According to the removal of the card 1110, the electronic device 1100 may output a screen, from which the card 1110 has been removed, as in the state 1119.

FIG. 12 illustrates a structure for generating a token cryptogram according to various embodiments of the present disclosure.

Referring to FIG. 12, a payment module (e.g., the payment module 1021) may generate a token cryptogram, using a key capable of generating the token cryptogram. The payment module may use different keys according to a certain rule, for example, in each transaction, in a certain number of times of transaction, or a transaction within a particular time. The token service provider 730 may possess a key paired with the above-described key. The token service provider 730 may decrypt the encrypted token cryptogram through the paired key.

When the payment module makes a token cryptogram using the key, the data encrypted by a key and the encryption engine may be widely different according to the encryption method (e.g., advanced encryption standard (AES), temporal key integrity protocol (TKIP), and the like).

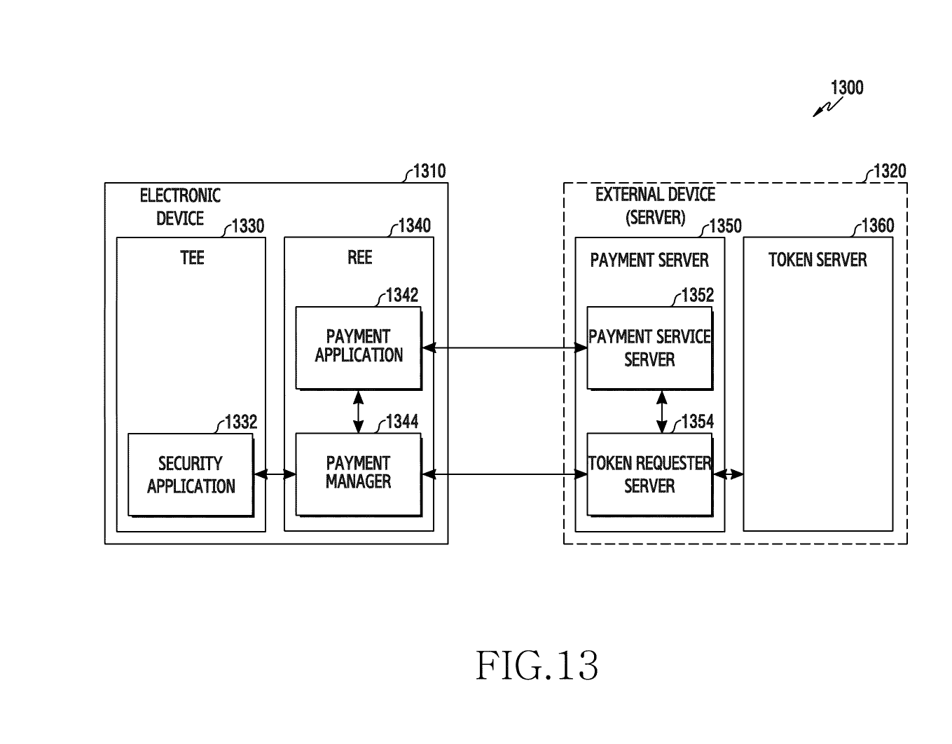

FIG. 13 illustrates a payment system according to various embodiments of the present disclosure.

Referring to FIG. 13, a payment system 1300 may include an electronic device 1310 and/or an external device 1320 (e.g., a server). The electronic device 1310 may include, for example, a TEE 1330 and/or an REE 1340. The external device 1320 may include, for example, a server, and the server may include, for example, a payment server 1350 and/or a token server 1360. The payment server 1350 may include, for example, a payment service server 1352 or token requester server 1354.

According to various embodiments of the present disclosure, the TEE 1330 may include a security system related to the electronic device 1310. For example, the electronic device 1310 may protect information included or stored in the TEE 1330 from a control related to a request, a revision, or an input from the outside, using the TEE 1330.

According to an embodiment of the present disclosure, the TEE 1330 may include, for example, a program mode, the security of which has been reinforced. For example, using the TEE 1330, a normal area (world) and a security area (world) may be distinguished. The normal world may be referred to as the REE 1340. Further, the TEE 1330 may, for example, execute a reliable application or manage encrypted information. For example, the encrypted information may include token or key information.

According to an embodiment of the present disclosure, the TEE 1330 may protect the encrypted information from the outside. The token or key information may be used to encrypt the card information. For example, in relation to the token or key information, when the card information is provided to a device for payment, the card information may be at least partly changed rather than being directly provided to the device for payment. In changing the card information, the token or key information may be used. The key may be acquired from, for example, a service provider who provides a payment service. Further, the key may be managed by the electronic device 1310 or the server. According to an embodiment of the present disclosure, the TEE 1330 may include, for example, a security application (trusted application) 1332. The TEE 1330 may provide, for example, an environment in which the security application 1332 can be executed.

According to various embodiments of the present disclosure, the security application 1332 may include, for example, information related to a card company included in the TEE 1330. The information related to the card company may include, for example, an application related to the card company, and the application may be provided in a packaged form. The packaged form may be provided by a SDK.

According to various embodiments of the present disclosure, the security application 1332 may include, for example, an application or applet which should be executed in a mode, the security of which has been reinforced, likewise in the TEE 1330. Further, the security application 1332 may include, for example, an encryption-related function. For example, the security application 1332 may perform functions of generating, revising, or deleting a cryptogram related to the payment.

According to various embodiments of the present disclosure, the REE 1340 may include an application layer. For example, the REE 1340 may include an application and/or framework. The REE 1340 may allow access thereto from the outside or control thereof, differently from the TEE 1330. The REE 1340 may include, for example, a payment application (wallet application) 1342 and/or a payment manager 1344. The payment application 1342 may perform, for example, functions of identification, OCR, or interfacing for payment by the payment application 1342. For example, the payment application 1342 may perform, for example, functions related to card registration or payment.

According to various embodiments of the present disclosure, the payment manager 1344 may include, for example, information related to a card company included in the REE 1340. The information related to the card company may include, for example, an application related to the card company, and the application may be provided in a packaged form. The packaged form may be provided by an SDK. The payment manager 1344 may include, for example, an encryption-related function. For example, the payment manager 1344 may perform functions of token ID management or card company channel establishment. Further, the payment manager 1344 may perform, for example, interfacing with the external device (e.g., a server) 1320. For example, the payment manager 1344 may provide an interface with a server (e.g., the payment server 1350) for a tokenization service.

According to various embodiments of the present disclosure, the payment manager 1344 may be functionally connected with and share information with the security application 1332. For example, the payment manager 1344 may perform interfacing with the security application 1332 for using (e.g., storing) the token or the key. Further, the security application 1332 may include information associated with a network service provider.

According to various embodiments of the present disclosure, the payment application 1342 and the payment manager 1344 may be functionally connected with each other, and the security application 1332 and the payment manager 1344 may be functionally connected with each other. For example, the payment manager 1344 may transfer received from the outside to the payment application 1342 or the security application 1332 or transfer information received from the payment application 1342 or the security application 1332 to the outside. According to one embodiment of the present disclosure, the payment manager 1344 may share information related to payment with the security application 1332 or the payment application 1342.

According to various embodiments of the present disclosure, the electronic device 1310 may include an additional configuration or module, as well as the TEE 1330, the security application 1332, the REE 1340, the payment application 1342, and the payment manager 1344.

According to various embodiments of the present disclosure, the payment server 1350 is a management server for electronic payment or mobile payment and may transmit or receive information related to payment to or from the electronic device 1310. Further, the payment service server 1352 and the token requester server 1354 included in the payment server 1350 are functionally connected with each other to share information relating to payment.

According to various embodiments of the present disclosure, the token server 1360 may be functionally connected to the token requester server 1354 to transmit or receive the information related to payment. For example, the token requester server 1354 and the token server 1360 may provide an interface for transfer of the token or the key.

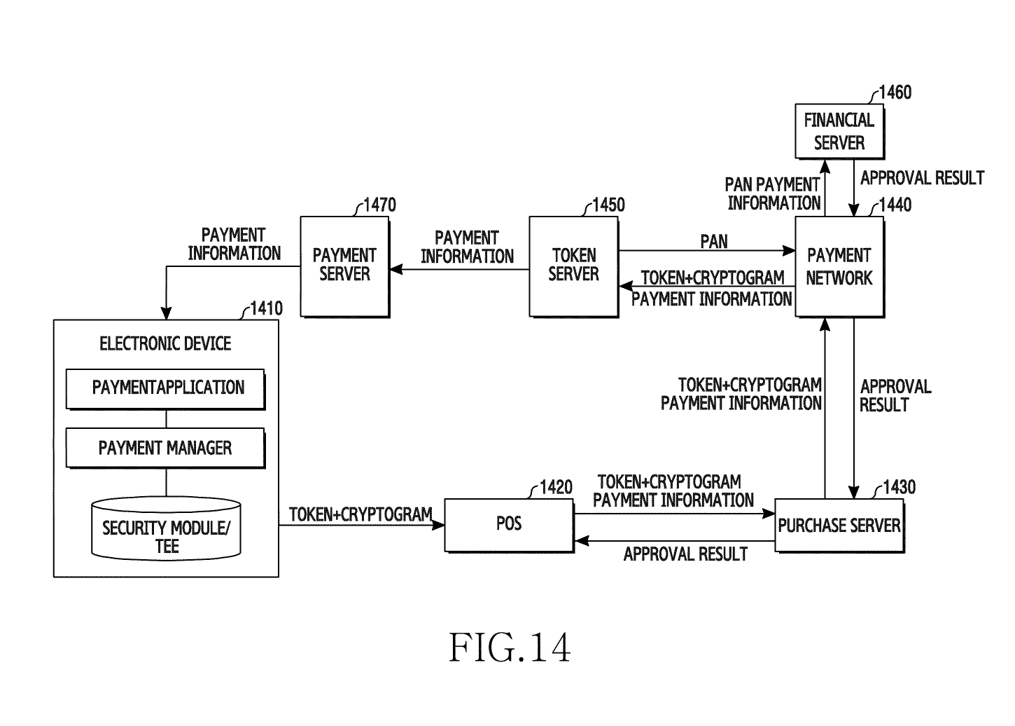

FIG. 14 illustrates a flowchart of a token payment according to various embodiments of the present disclosure.

Referring to FIG. 14, the payment system may include an electronic device 1410, a payment server 1470, a token server 1450, a POS device 1420, a financial server 1460, a purchase server (acquirer) 1430, or a payment network 1440. The electronic device 1410 may include, for example, a payment application, a payment manager, or a security area (e.g., a security module or TEE). The POS device 1420 may include, for example, a sales time point information management system. The POS device 1420 may be, for example, a combination of functions of a cash register and a computer electronic device, and a user can perform a payment function using the POS device 1420. The financial server 1460 may include, for example, a bank or financial company for issuing a card, and may perform identification of the card. Further, the financial server may proceed approval of the card at the time of payment. The purchase server 1430 may include, for example, a bank or financial company which purchases a transaction sheet for the paid card transaction in a shop (e.g., POS device 1420). The payment network 1440 may include, for example, a card network.

According to various embodiments of the present disclosure, the electronic device 1410 may transfer a token and/or encryption information (e.g., cryptogram) to the POS device 1420. For example, the token may be stored in the electronic device 1410. Further, the token may be stored in an encrypted area (e.g., a security module or TEE). For example, the electronic device 1410 may generate encryption information, using a key received from the outside or a key generated by the electronic device 1410. The security information may include a cryptogram. Further, the electronic device 1410 may transfer the cryptogram and/or the token to the POS device 1420.

According to various embodiments of the present disclosure, the electronic device 1410 may use various communication connections in transferring the token and/or cryptogram to the POS device 1420. The communication connections may include, for example, NFC, MST, barcode, or QR code.

According to various embodiments of the present disclosure, the POS device 1420 may transfer at least one among the token, the encryption information, and the payment information to the purchase server 1430. For example, the POS device 1420 may transfer, to the purchase server 1430, the token received by the electronic device 1410 and/or and the cryptogram, and the payment information (e.g., payment details) acquired by the POS device 1420. Further, the payment information may be, for example, acquired from the POS device 1420 or received from an external device, and may include payment details relating to a payment function requested by the user. Further, the payment information may include, for example, payment history performed using the payment system.

According to various embodiments of the present disclosure, the purchase device 1430 may transfer at least one among the token, the encryption information, and the payment information to the payment network 1440. For example, the purchase server 1430 may transfer at least one among the token, the cryptogram, and the payment information, which have been received from the POS device 1420, to the payment network 1440.

According to various embodiments of the present disclosure, the payment network 1440 may include a network associated with a card company. The card company may include, for example, VISA™, Master Card, or Amex™. According to one embodiment of the present disclosure, the payment network 1440 may include or operate the token server 1450. For example, the payment network 1440 may transfer at least one among the token, the cryptogram, and the payment information from the payment network 1440 to the token server 1450 or may perform the functions of the token server 1450.

According to various embodiments of the present disclosure, the token server 1450 may identify information on the token received from the payment network 1440. For example, the token server 1450 may use the token to identify card information (e.g., PAN) corresponding to the token. For example, the token server 1450 may identify a PAN corresponding to the financial server 1460, using information (e.g., Data) included in the token. The token server 1450 may, for example, identify a PAN corresponding to the financial server 1460 and use the PAN to get payment authentication from the financial server 1460. According to various embodiments of the present disclosure, the token server 1450 may use the cryptogram in identifying the PAN. According to various embodiments of the present disclosure, the token server 1450 may transfer the PAN to the payment network 1440.

According to various embodiments of the present disclosure, the payment network 1440 may transfer the PAN and/or the payment information to the financial server 1460. For example, the payment network 1440 may transfer the PAN and/or the payment information received from the purchase server 1430 to the financial server 1460. According to various embodiments of the present disclosure, the payment network 1440 may transfer the information on whether to approve the payment to the payment network 1440.

According to various embodiments of the present disclosure, the financial server 1460 may determine whether to approve the payment, using the PAN and/or the payment information. For example, the financial server 1460 may use the PAN and/or the payment information and may approve the payment when the payment coincides with information included in the financial server 1460. Further, the financial server 1460 may reject use the payment when the PAN and/or the payment information does not coincide (e.g., an Invalid PAN) with information included in the financial server 1460. According to various embodiments of the present disclosure, the financial server 1460 may transfer the information on whether to approve the payment to the payment network 1440. According to various embodiments of the present disclosure, the payment network 1440 may transfer the information on whether to approve the payment to the payment network 1440.

According to various embodiments of the present disclosure, the financial server 1460 may transfer the information on whether to approve the payment to the purchase server 1430. According to various embodiments of the present disclosure, the purchase server 1430 may transfer the information on whether to approve the payment to the POS device 1420. According to various embodiments of the present disclosure, the payment network 1440 may transfer the payment information to the token server 1450, when the information corresponds to approval. According to various embodiments of the present disclosure, the token server 1450 may transfer the payment information to the payment server 1470. According to various embodiments of the present disclosure, the payment server 1470 may transfer the payment information to the electronic device 1410. For example, the payment server 1470 may transfer the payment information to the electronic device 1410, using a certain command (e.g., a push message).

According to various embodiments of the present disclosure, the electronic device 1410 may display the payment information in the electronic device 1410. For example, the electronic device 1410 show the payment information, using the payment application included in the electronic device 1410, or display the payment information through an interface associated with a payment function. The interface associated with the payment function may include a notification bar.

According to various embodiments of the present disclosure, the electronic device 1410 may display the display information or information (e.g., payment state, payment history, or accumulated amount) associated with the payment through a display functionally connected to the electronic device 1410. For example, the electronic device 1410 may use a notification module (e.g., the notification manager 349 of FIG. 3) of the electronic device 1410 to display the payment information or the information associated with the payment. Further, in the electronic device 1410, the payment information or the information associated with the payment may be displayed using at least one among, for example, a notification, an indicator, a status bar, a task bar, an icon, a floating icon, a tile, and a widget, and may be displayed in a partial area of at least one among a home screen, a lock screen, and a curved display.

According to various embodiments of the present disclosure, the electronic device 1410 may output a sound notifying of the payment information or the information associated with the payment through an audio module (e.g., the audio module 280 of FIG. 2 and/or a motor (e.g., the motor 298 of FIG. 2, a tactile feedback device (not shown), a friction display (not shown)) functionally connected to the electronic device 1410, or generate vibration or haptic effect notifying of the information.

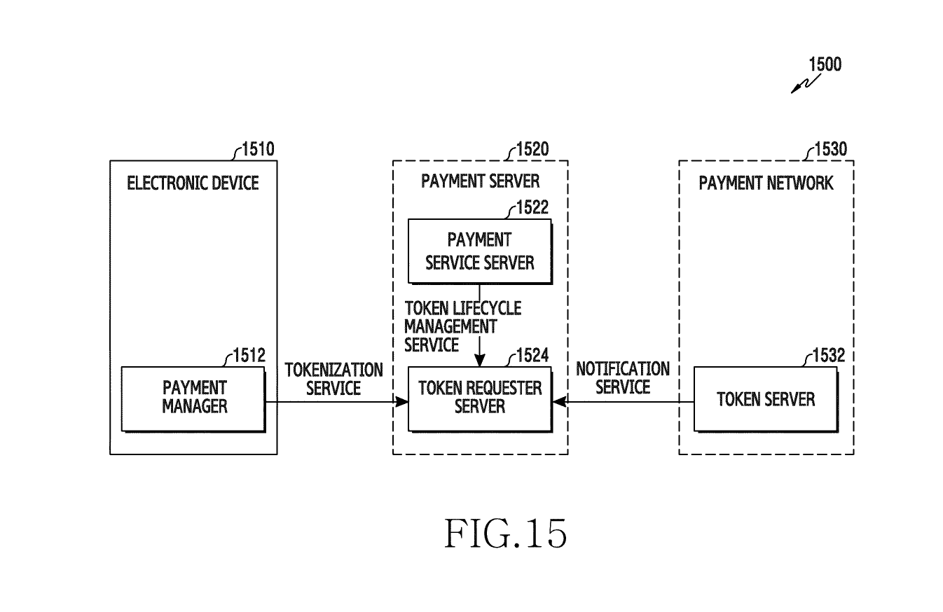

FIG. 15 illustrates a flowchart of payment system elements according to various embodiments of the present disclosure.

Referring to FIG. 15, the payment system may include an electronic device 1510, a payment server 1520, and/or a payment network 1530. The electronic device 1510 may include, for example, a payment manager 1512. The payment server 1520 may include, for example, a payment service server 1522 or token requester server 1524. The payment network 1530 may include, for example, a token server 1532. The payment system may use, for example, the token for the functions performed by each of the electronic device 1510, the payment server 1520, and/or the payment network 1530.

According to various embodiments of the present disclosure, the electronic device 1510 may provide a tokenization service associated with the token, using the payment manager 1512 included in the electronic device 1510 and the token requester server 1524 included in the payment server 1520.

According to various embodiments of the present disclosure, the payment service server 1522 may provide an operation cycle associated with the token (e.g., token life management), using the token requester server 1524 included in the payment server 1520.

According to various embodiments of the present disclosure, the token server 1532 may provide a notification service associated with the token, using the token requester server 1524.

According to various embodiments of the present disclosure, the token requester server 1524 may provide a payment method to the electronic device 1510, using a payment network solution. For example, the token requester server 1524 may determine a payment method proper for the user, using the tokenization service, an operating cycle associated with the token, and/or a notification service associated with the token.

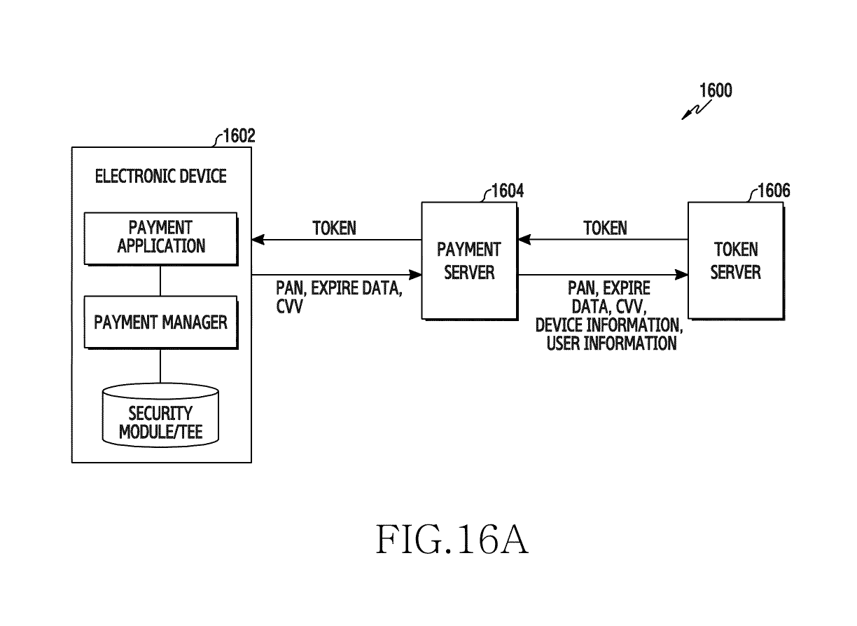

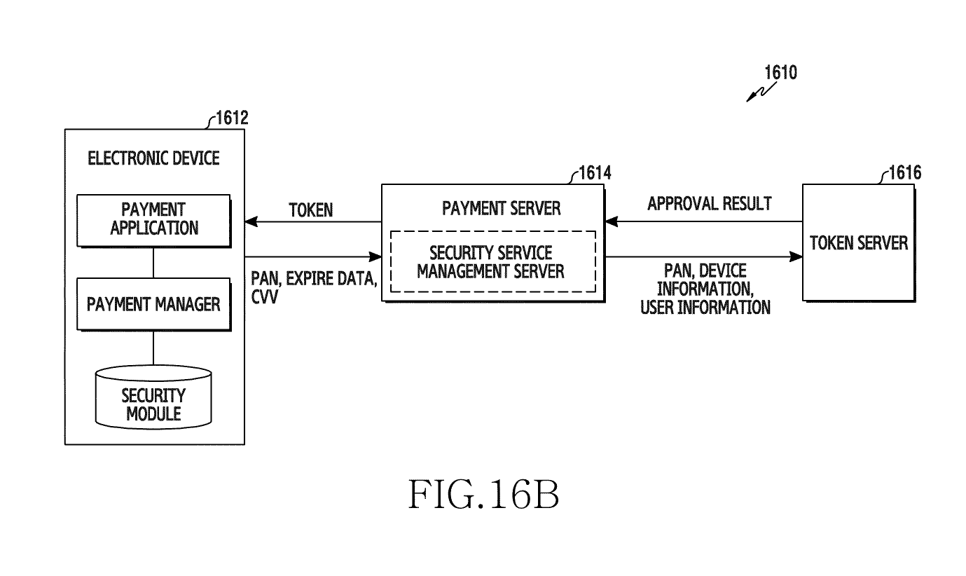

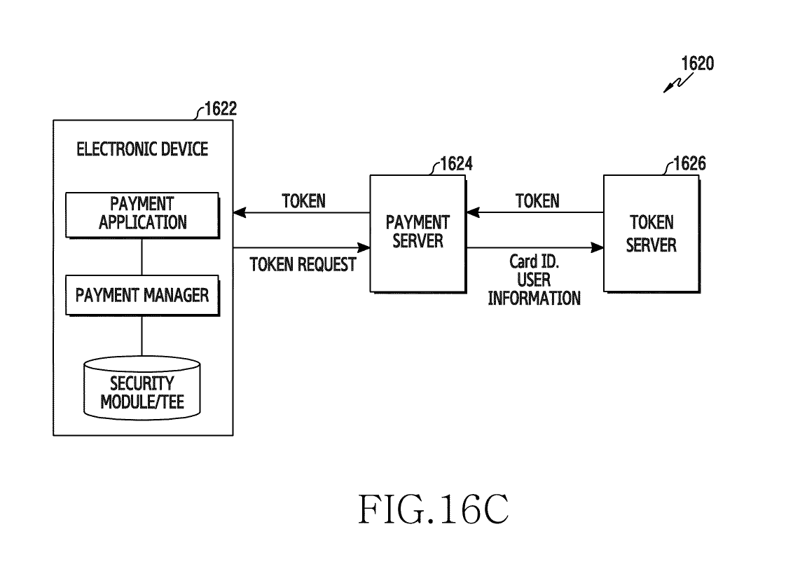

FIGS. 16A to 16C illustrate flow diagrams of a first, a second, and a third token issuance operations of an electronic device according to various embodiments of the present disclosure.

According to various embodiments of the present disclosure, the token issuance operation may be changed according to the country. For example, the token issuance operation may be changed according to the United States of America, Europe, or Republic of Korea.

Referring to FIG. 16A, a signal flow 1600 of a first token issuance operation is illustrated, according to an embodiment of the present disclosure.

The first token issuance operation may include, for example, an electronic device 1602, a payment server 1604, or a token server 1606. The electronic device 1602 may include, for example, a payment application, a payment manager, a security module, or a TEE.

According to various embodiments of the present disclosure, the electronic device 1602 may acquire card-related information through a sensor functionally connected to the electronic device 1602. The card-related information may be used in, for example, a card registration operation. The sensor may include, for example, an OCR. The card-related information may include, for example, at least one among PAN, valid period, and CVV. For example, the sensor may be operated using the payment application included in the electronic device 1602.

According to various embodiments of the present disclosure, the payment application included in the electronic device 1602 may transfer the card-related information to the payment server 1604. The payment server 1604 may include, for example, a payment service server or token requester server, and the card-related information may be transferred between the payment service server and the token requester server.

According to an embodiment of the present disclosure, the payment server (e.g., the token requester server) 1604 may transfer the card-related information and/or information (e.g., device information or user information) related to the electronic device 1602 to the token server 1606. The information related to the electronic device 1602 may include, for example, information of a device having requested the first token issuance operation.

According to an embodiment of the present disclosure, the token server 1606 may issue (generate) a token based on the information received from the payment server 1604. According to an embodiment of the present disclosure, the token server 1606 may transfer a token based on the information received from the payment server 1604. The token server 1606 may transfer the token to, for example, the token requester server included in the payment server 1604.

According to an embodiment of the present disclosure, the payment server 1604 may transfer the token to the electronic device 1602. The payment server 1604 may transfer a token from, for example, the token requester server included in the payment server 1604, to the electronic device 1602.

According to an embodiment of the present disclosure, the electronic device 1602 may store, in the security module or the TEE, the token received from the payment server 1604. For example, the electronic device 1602 may store the token in the security module or the TEE, which is a security area, to control access from the outside.

According to an embodiment of the present disclosure, the electronic device 1602 may store, in the general memory (e.g., memory included in the REE), the token received from the payment server 1604.

According to an embodiment of the present disclosure, one or more tokens may be issued (generated) based on a payment method (e.g., OTP or call center) performed by the electronic device 1602.

According to an embodiment of the present disclosure, one token may be issued (generated) corresponding to the electronic device 1602. For example, a first token may be included in the first electronic device while a second token is included in the second electronic device. The first token and the second token may be different from each other.

According to an embodiment of the present disclosure, the token may be activated based on an authentication operation (e.g., ID&V). For example, the token may be stored in the electronic device 1602 and activated based on the authentication operation. The authentication operation may include, for example, an identification. The identification may be conducted by, for example, a financial server.

Referring to FIG. 16B, a signal flow 1610 of a second token issuance operation is illustrated, according to an embodiment of the present disclosure.

The second token issuance operation may include, for example, an electronic device 1612, a payment server 1614, or a token server 1616. The electronic device 1612 may include at least one among, for example, a payment application, a payment manager, and a security module. Further, the payment server 1614 may include, for example, a security service management server.

According to various embodiments of the present disclosure, the electronic device or an electronic device may acquire card-related information through a sensor functionally connected to the electronic device. The card-related information may be used in, for example, a card registration operation. The sensor may include, for example, an OCR. The card-related information may include, for example, at least one among PAN, valid period, and CVV. The sensor may be operated using the electronic device or the payment application included in the electronic device.

According to various embodiments of the present disclosure, the payment application included in the electronic device 1612 may transfer the card-related information to the payment server 1614. The payment server 1614 may include, for example, a payment service server or token requester server, and the card-related information may be transferred between the payment service server and the token requester server.

According to one embodiment of the present disclosure, the payment server 1614 may transfer the card-related information to the security service management server included in the payment server 1614. The security service management server may be included and internally operate in, for example, the payment server 1614 or located outside of the payment server 1614. For example, the security service management server may be included in another device (e.g., an external device) different from the payment server 1614, and may be functionally connected to the payment server 1614 to transmit or receive the card-related information.

According to one embodiment of the present disclosure, the security service management server may transfer the card-related information and/or information (e.g., device information or user information) related to the electronic device 1612 to the token server 1616. The information related to the electronic device 1612 may include, for example, information of a device having requested the second token issuance operation.

According to one embodiment of the present disclosure, the token server 1616 may perform an authentication operation based on the information received from the payment server 1614. The token server 1616 may perform an authentication operation, for example, based on the card-related information and/or the information related to the electronic device 1612.

According to one embodiment of the present disclosure, the token server 1616 may transfer a result (e.g., a success or a failure) of the authentication operation to the security service management server included in the payment server 1614.

According to one embodiment of the present disclosure, the security service management server may issue (generate) a token based on the card-related information and/or the information related to the electronic device 1612.

According to one embodiment of the present disclosure, the security service management server may store the token in a security area (e.g., a security module) included in the electronic device 1612. For example, the security service management server may have an authority (e.g., a security module access authority) for access to the security area of the electronic device 1612. Further, the security service management server may store the token in the security area of the electronic device 1612, using the access authority. Further, the token may be transferred from the security service managing server to the electronic device 1612.

According to one embodiment of the present disclosure, the electronic device 1612 may store the token in the security module, which is a security area, to control access from the outside.

According to one embodiment of the present disclosure, one or more tokens may be issued (generated) based on a payment method (e.g., OTP or call center) performed by the electronic device 1612.

According to one embodiment of the present disclosure, one token may be issued (generated) corresponding to the electronic device 1612. For example, a first token may be included in the first electronic device while a second token is included in the second electronic device. The first token and the second token may be different from each other.

According to one embodiment of the present disclosure, the token may be activated based on an authentication operation (e.g., ID&V). For example, the token may be stored in the electronic device 1612 and activated based on the authentication operation. The authentication operation may include, for example, an identification. The identification may be conducted by, for example, a financial server.

Referring to FIG. 16C, a signal flow 1620 of a third token issuance operation is illustrated, according to an embodiment of the present disclosure.

The third token issuance operation may include, for example, an electronic device 1622, a payment server 1624, or a token server 1626. The electronic device 1622 may include, for example, a payment application, a payment manager, a security module, or a TEE.

According to various embodiments of the present disclosure, the electronic device or an electronic device may acquire card-related information through a sensor functionally connected to the electronic device. The card-related information may be used in, for example, a card registration operation. The sensor may include, for example, an OCR. The card-related information may include, for example, at least one among PAN, valid period, and CVV. The sensor may be operated using the payment application included in the electronic device.

According to one embodiment of the present disclosure, the electronic device or an electronic device may perform an authentication operation (e.g., ID&V). The authentication operation, for example, an identification, may be performed using the payment application.

According to one embodiment of the present disclosure, the electronic device 1622 may perform the card registration and/or the identification when performing the payment function. For example, the electronic device 1622 may perform the card registration and the identification in order to perform the payment function, and the card registration and the identification may refer to a standby (preparation) state for the payment function.

According to one embodiment of the present disclosure, the electronic device 1622, the payment server 1624, and the token server 1626 may share information associated with the card registration and the identification. For example, the electronic device 1622, the payment server 1624, and the token server 1626 may share at least one type of information among PAN, valid term, CVV, device information, and user information.

According to one embodiment of the present disclosure, a token associated with the third token issuance operation may be issued (generated) when payment is performed using the payment function.

According to various embodiments of the present disclosure, the payment application included in the electronic device 1622 may perform user authentication in order to perform the payment function. For example, the user authentication may include secret code authentication, pattern authentication, or biometric information authentication.

According to one embodiment of the present disclosure, when the user authentication is successful (e.g., authentication completion), the payment application may perform the third token issuance operation with respect to the payment server 1624. The third token issuance operation may include, for example, a token request.

According to one embodiment of the present disclosure, based on the token request, the payment server 1624 may transfer card information (e.g., card Identifier) and/or user information to the token server 1626. The information related to the electronic device 1622 may include, for example, information of a device having requested the third token issuance operation.

According to one embodiment of the present disclosure, the token server 1626 may issue (generate) a token based on the information received from the payment server 1624.

According to one embodiment of the present disclosure, the token server 1626 may transfer a token based on the information received from the payment server 1624.

According to one embodiment of the present disclosure, the payment server 1624 may transfer the token to the electronic device 1622.

According to one embodiment of the present disclosure, the electronic device 1622 may store, in the security module or the TEE, the token received from the payment server 1624. For example, the electronic device 1622 may store the token in the security module or the TEE, which is a security area, to control access from the outside.

According to one embodiment of the present disclosure, the electronic device 1622 may store, in the general memory (e.g., memory included in the REE), the token received from the payment server 1624.

According to one embodiment of the present disclosure, the electronic device 1622 may not store, in the storage area (e.g., memory) included in the electronic device 1622, the token received from the payment server 1624. For example, the electronic device 1622 may use the token in the payment function instead of storing the token in the storage area.

According to one embodiment of the present disclosure, the storage area of the token may be changed based on a payment method (e.g., OTP or call center) performed by the electronic device 1622. For example, the token may be stored in the security module or the TEE when the payment method is OTP, and may not be stored in the electronic device 1622 when the payment method is call center.

According to various embodiments of the present disclosure, the token may include use time or valid time. For example, use of the token may be restricted when a certain time (e.g., three hours or one day) has passed from the issuance (generation) of the token.

According to various embodiments of the present disclosure, the token may include card information. For example, the token may include disposable card information (OTC, one time card).

According to various embodiments of the present disclosure, an electronic device may include a housing, a display exposed on one side of the housing, an input device integrally formed with the display, mounted on the housing, or wirelessly connected to the electronic device, a user authentication device integrally formed with the display, or is mounted on the housing, a conductive pattern positioned inside the housing, and configured to transmit a signal to an external transaction device, a first communication circuit electrically connected to the conductive pattern, a second communication circuit configured to provide cellular and/or short-range communication, a processor electrically connected to the display, the authentication device, the first communication circuit, and the second communication circuit, and a memory electrically connected to the processor, and configured to store token information used for payment, wherein the memory stores instructions that, when executed, cause the processor to receive a first user input through the input device, display, after receiving the first user input, in a selected array of a plurality of images representing a plurality of payment cards used for the payment using the first communication circuit, wherein at least one image of the plurality of images is larger in size than other images of the plurality of images, receive a second user input for selecting one of the plurality of images, receive user authentication information through the user authentication device, and transmit, at least partly in response to the second user input and the authentication information, a signal generated based on the token information, to the external transaction device through the first communication circuit and the conductive pattern.

According to various embodiments of the present disclosure, the selected array may include one of a spiral array, a circular array, a tiled array, a three dimensional ring array, a fence-shaped array, or a matrix array.

According to various embodiments of the present disclosure, the selected array is rendered in 3 dimensions, wherein the at least one image has a first size, and the other images have a size or sizes smaller than the first size, and/or wherein the at least one image is laid in front of the other images, and/or laid over a portion of the other images.

According to various embodiments of the present disclosure, the one or more images may be clearer than the other images.

According to various embodiments of the present disclosure, the other images may include the back sides of the corresponding payment cards.

According to various embodiments of the present disclosure, the tiled array may include one or more images representing objects that are not payment cards.

According to various embodiments of the present disclosure, the instructions may cause the processor to select the payment card represented by the one or more images, based at least partly on, a payment history of the user and/or information received from the outside through the second communication circuit.

According to various embodiments of the present disclosure, the input device may include at least one of a touch panel, a microphone, a home button, or a touch screen, and the authentication device may include at least one of a biometric authentication device or at least a part of a touch screen that receives a pin (personal identification number) input or a pattern input.

According to various embodiments of the present disclosure, the signal generated based on the token information is a magnetic signal.

According to various embodiments of the present disclosure, the signal generated based on the token information is in compliance with the NFC protocol.

According to various embodiments of the present disclosure, an electronic device may include a housing, a display exposed on one side of the housing, an input device integrally formed with the display, mounted on the housing, or wirelessly connected to the electronic device, a user authentication device integrally formed with the display, or is mounted on the housing, a conductive pattern positioned inside the housing, and configured to transmit a signal to an external transaction device, a first communication circuit electrically connected to the conductive pattern, a second communication circuit configured to provide cellular and/or short-range communication, a processor electrically connected to the display, the user authentication device, the first communication circuit, and the second communication circuit, and a memory electrically connected to the processor, and configured to store token information used for payment and information on a plurality of payment cards, wherein the memory stores instructions that, when executed, cause the processor to receive a first user input through the input device, receive information on at least one of the transaction merchandise or a payment card through the second communication circuit, select, after receiving the first user input, one of the plurality of payment cards based at least partly on at least one of the received information or a payment history, display the selected card on the display, receive user authentication information through the authentication device, and after receiving the authentication information, transmit a signal generated based on the token information, to the external transaction device through the first communication circuit and the conductive pattern.

According to various embodiments of the present disclosure, the received information may comprise at least one of discount information, subscription information, or membership point information associated with the payment card.

According to various embodiments of the present disclosure, the instructions further cause the processor to, after receiving the first user input, display a selected array of a plurality of images representing a plurality of payment cards used for the payment using the first communication circuit, wherein at least one image of the plurality of images is larger in size than other images of the plurality of images.

According to various embodiments of the present disclosure, the selected array is rendered in 3 dimensions, wherein the at least one image has a first size, and the other images have a size or sizes smaller than the first size, and/or wherein the at least one image is laid in front of the other images, and/or laid over a portion of the other images.

According to one embodiment of the present disclosure, an electronic device may include a housing, a display exposed on one side of the housing, an input device integrally formed with the display, mounted on the housing, or wirelessly connected to the electronic device, a user authentication device integrally formed with the display, or is mounted on the housing, a conductive pattern positioned inside the housing, and configured to transmit a signal to an external transaction device, a first communication circuit electrically connected to the conductive pattern, a second communication circuit configured to provide cellular and/or short-range communication, a processor electrically connected to the display, the user authentication device, the first communication circuit, and the second communication circuit, and a memory, electrically connected to the processor, and configured to store token information used for payment and information on one or more membership accounts, wherein the memory stores instructions that, when executed, cause the processor to receive a first user input through the input device, receive user authentication information through the authentication device, after receiving the authentication information, transmit a signal generated based on the token information, to the external transaction device through the first communication circuit and the conductive pattern, receive information indicating the completion of payment through the second communication circuit, display, on the display, first information related to a membership account, the first information having been created based on the information indicating the completion of the payment, receive a second user input through the input device, and in response to the second user input, transmit second information related to the membership account through the second communication circuit.

According to various embodiments of the present disclosure, the instructions further cause the processor to, after receiving the first user input, display a selected array of a plurality of images representing a plurality of payment cards used for the payment using the first communication circuit, wherein at least one image of the plurality of images is larger in size than other images of the plurality of images.

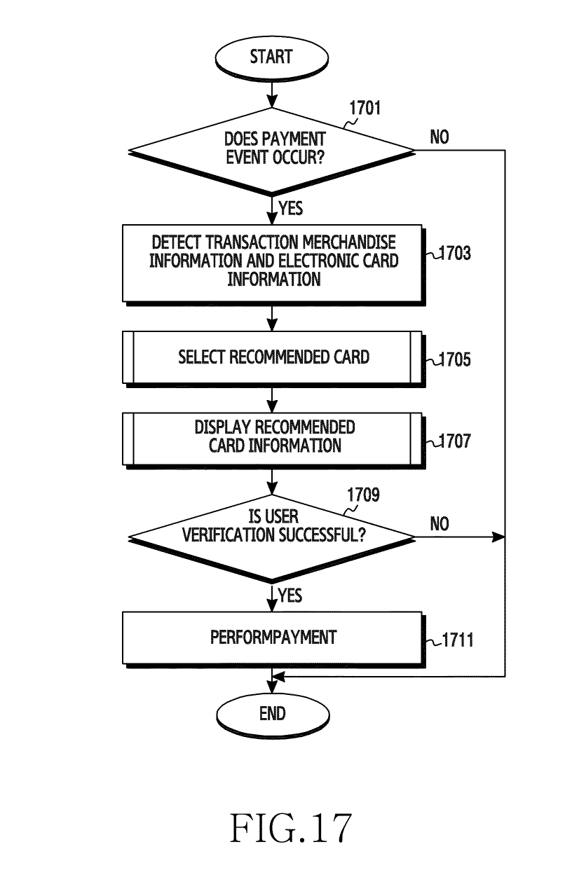

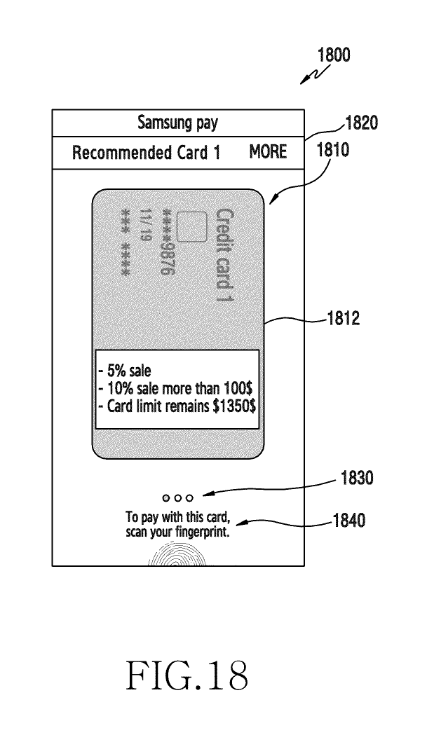

FIG. 17 illustrates a flowchart for providing card recommendation information in an electronic device according to various embodiments of the present disclosure. FIG. 18 illustrates a screen configuration for displaying card recommendation information in an electronic device according to various embodiments of the present disclosure. Hereinafter, the operation of providing the card recommendation information by using the screen configuration of FIG. 18 will be described. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 17, in operation 1701, the electronic device may identify whether a payment event for providing the payment service occurs. For example, the processor 120 may identify whether an execution event of the payment application occurs. For example, the execution event of the payment application may be created by at least one of an icon selection input for the payment application, the detection of a gesture that matches the payment application, or the detection of the motion of the electronic device 101, which matches the payment application.

In operation 1703, when the payment event occurs, the electronic device may detect the transaction merchandise information and the electronic card information. For example, the processor 120 may detect the transaction merchandise information that contains at least one of the price or the purchase terms of the transaction merchandise through the input/output interface 150 or the communication interface 170. For example, the processor 120 may detect, from the financial server or the memory 130, the electronic card information that contains at least one of the total purchased amount, the payment limit, the point collection rate, or discount policies of each electronic card that is registered in the electronic device 101.

In operation 1705, the electronic device may select one or more recommended cards based on the transaction merchandise information and the electronic card information. For example, the processor 120 may select one or more electronic cards to be recommended for payment from among one or more electronic cards that are registered in the electronic device 101 (e.g., the payment application) based on the transaction merchandise information and the electronic card information. For example, the processor 120 may select one or more electronic cards to be recommended for payment based on the purchase price and terms desired by the user, the total purchased amount by the user until now, the total purchased amount of the card, the payment limit of the card, the point collection rate, the discount policies and amount, and the like. In an additional embodiment of the present disclosure, if the user purchases the goods priced at $1,000 and the balance of the payment limit for Electronic Card 2, which is preferentially recommended, is $390, the processor 120 may further recommend Electronic Card 3 that has an enough balance remaining of the limit. For example, the processor 120 may select a plurality of electronic cards to be recommended for payment. Additionally or alternatively, the processor 120 may select one or more recommended cards for payment by additionally considering at least one of the payment history or the location information of the electronic device 101.

In operation 1707, the electronic device may display, on the display, the information on one or more recommended cards that are selected based on the transaction merchandise information and the electronic card information.

Referring to FIG. 18, for example, the processor 120 may control the display 160 to display a service screen 1800 of the payment application, which contains recommended card information 1810. For example, the service screen 1800 of the payment application may include a virtual card 1812, the recommended card information 1810, a menu 1820, overall card information 1830, authentication guidance information 1840. The recommended card information 1810 may contain at least one of the card identification information (e.g., the name or number), the discount terms (e.g., a 5% discount and a 10% discount for the purchase of $100 or more), or the payment limit (e.g., $1,350). The menu 1820 may include application identification information (e.g., the name) and a detailed item (MORE) related to the application configuration. When a selection input for the detailed item (MORE) is detected, the processor 120 may provide a detailed screen interface in relation to the overall virtual card configuration or the virtual card operation method configuration. The overall card information 1830 may include information on the number of virtual card objects. In FIG. 18, the overall card information 1830 may show the state in which three virtual card objects are registered in the payment application (or the electronic device 101). The overall card information 1830 may represent the order of the virtual card objects that are currently displayed. The authentication guidance information 1840 may contain information to guide authentication methods (e.g., the fingerprint recognition), which are necessary for operating the virtual card objects that are currently displayed.

In operation 1709, the electronic device may identify whether the user authentication has been successful to provide the payment service by using the recommended card. For example, the processor 120 may identify whether the user authentication has been successful by comparing the fingerprint information that is obtained through the fingerprint sensor with the fingerprint information that is pre-registered in the electronic device 101. For example, if the fingerprint information that is obtained through the fingerprint sensor is the same as the fingerprint information that is pre-registered in the electronic device 101, the processor 120 may determine that the user authentication is successful. Here, the case of the same fingerprint information may include the case where a matching rate of the fingerprint information that is obtained through the fingerprint sensor and the fingerprint information that is pre-registered in the electronic device 101 exceeds a reference value.

If the user authentication has failed, the electronic device may terminate the present algorithm to provide the payment service. For example, the processor 120 may output authentication failure information through at least one of a graphic, a sound, or light.

If the user authentication has been successful, the electronic device may perform the payment by using the recommended card in operation 1711. For example, in the case of the MST scheme, the processor 120 may output the payment information (e.g., token information) of the recommended card to the payment terminal through a magnetic field in order to thereby perform the payment by using the recommended card. For example, in the case of the NFC scheme, the processor 120 may output the payment information (e.g., token information) of the recommended card to the payment terminal according to the NFC communication method in order to thereby perform the payment by using the recommended card. For example, in the case of the bar code scheme, the processor 120 may control the display 160 to display a bar code corresponding to the payment information of the recommended card.

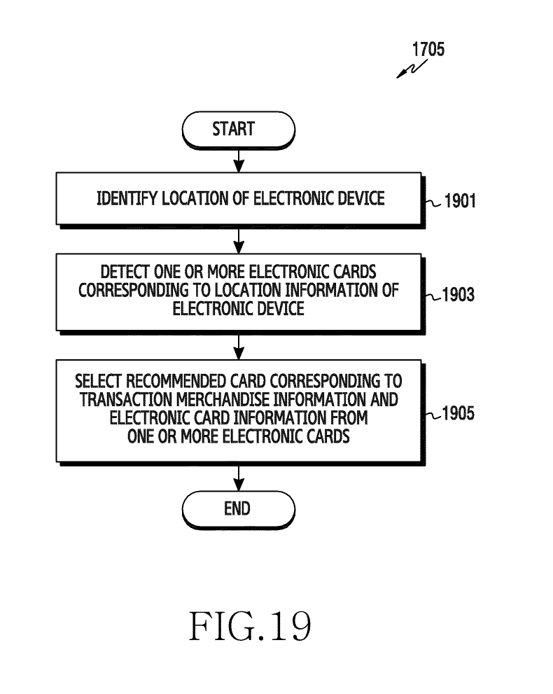

FIG. 19 illustrates a flowchart for selecting a recommended card based on location information in an electronic device according to various embodiments of the present disclosure. The following description will be made of the operation for selecting the recommended card in operation 1705 of FIG. 17. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 19, in operation 1901, the electronic device may identify the location of the electronic device to provide the payment service. For example, the processor 120 may estimate the location of the electronic device 101 (e.g., store information) to provide the payment service by using a positioning technique, such as satellite signals or a home LBS (location based service). For example, the processor 120 estimate the location of the electronic device 101 (e.g., store information) to provide the payment service by using beacons received through the short-range wireless communication (e.g., BT or BLE) or data that is received from the base station of a cellular network (e.g., LTE). For example, in the case of performing the online shopping, the processor 120 may detect unique identification information of the online store and site in order to thereby estimate the location of the electronic device 101 (e.g., store information) to provide the payment service.

In operation 1903, the electronic device may detect one or more electronic cards corresponding to the location information of the electronic device. For example, the processor 120 may detect one or more electronic cards that are available at the location of the electronic device 101 from among one or more electronic cards that are registered in the electronic device 101 (e.g., the payment application).

In operation 1905, the electronic device may select one or more recommended cards from among one or more electronic cards corresponding to the location information of the electronic device based on the transaction merchandise information and the electronic card information. For example, the processor 120 may select one or more electronic cards to be recommended for payment from among one or more electronic cards that are available at the location of the electronic device 101 based on the transaction merchandise information and the electronic card information.

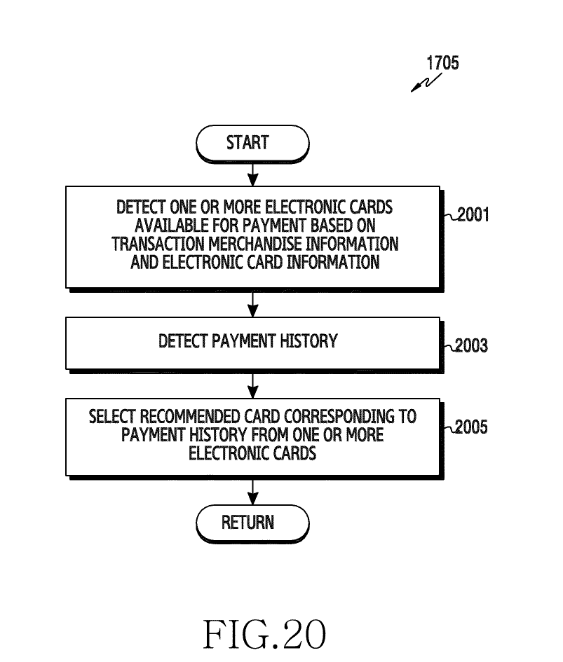

FIG. 20 illustrates a flowchart for selecting a recommended card based on a payment history in an electronic device according to various embodiments of the present disclosure. The following description will be made of the operation for selecting the recommended card in operation 1705 of FIG. 17. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 20, in operation 2001, the electronic device may detect one or more electronic cards that are available for payment based on the transaction merchandise information and the electronic card information. For example, the processor 120 may detect one or more electronic cards that are available for the payment for the transaction merchandise from among one or more electronic cards that are registered in the payment application based on the transaction merchandise information and the electronic card information. For example, the processor 120 may detect at least one electronic card, of which the balance of the payment limit is more than the price of the transaction merchandise, from among one or more electronic cards that are registered in the payment application.

In operation 2003, the electronic device may detect the payment history of the electronic device. For example, processor 120 may detect the payment information that has been previously performed through the payment application. For example, the payment information, which has been previously performed, may contain at least one of the transaction date and time, the electronic card information, or the transaction amount.

In operation 2005, the electronic device may select one or more recommended cards based on the payment history from among one or more electronic cards that are selected based on the transaction merchandise information and the electronic card information. For example, the processor 120 may select one or more electronic cards to be used for the payment based on the payment history (e.g., the number of usage times, the usage location, the used amount, and the like) of at least one electronic card that is detected based on the transaction merchandise information and the electronic card information. For example, the processor 120 may select one or more electronic cards that have been previously used for the payment at the payment location of the electronic device 101 based on the payment history of the electronic card.

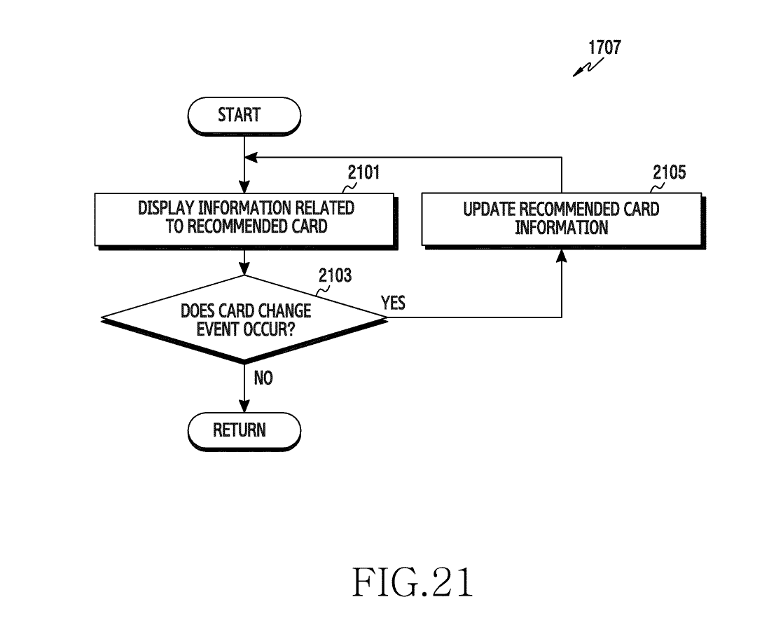

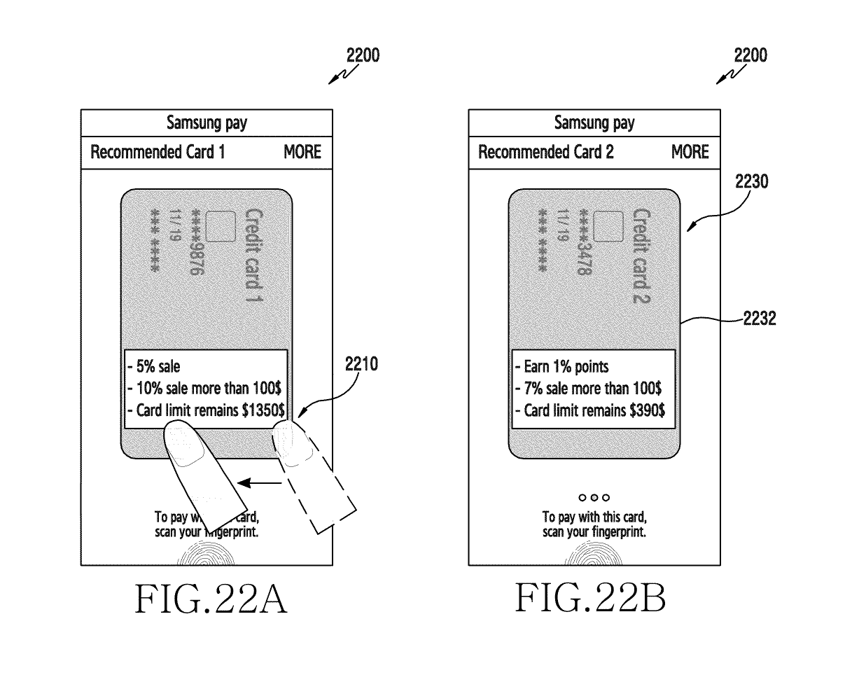

FIG. 21 illustrates a flowchart for changing a recommended card in an electronic device according to various embodiments of the present disclosure. FIGS. 22A and 22B illustrate screen configurations for changing a recommended card in an electronic device according to various embodiments of the present disclosure. The following description will be made of the operation for displaying the recommended card in operation 1707 of FIG. 17 by using the screen configuration of FIGS. 22A and 22B. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 21, in operation 2101, if the electronic device selects the recommended card to provide the payment service (e.g., the operation 1705 of FIG. 17), the electronic device may display one or more pieces of information that is related to the recommended card. For example, the processor 120 may control the display 160 to display, on the service screen 1800, the recommended card information 1810 that contains at least one of the card identification information, the discount terms, the payment limit, or the total purchased amount, as shown in FIG. 18.

In operation 2103, the electronic device may identify whether a card change event for changing the recommended card occurs.

Referring to FIG. 22A, for example, the processor 120 may identify whether the touch movement (e.g., a swiping or a dragging) 2210 information for changing the card is detected in a service screen 2200 of the payment application, which contains the recommended card information. For example, the processor 120 may identify whether a selection input for an icon that matches the card change event is detected. For example, the processor 120 may identify whether a gesture that matches the card change event is detected.

In operation 2105, when the electronic device detects the occurrence of the card change event for changing the recommended card, the electronic device may update the recommended card information that is displayed on the display.

Referring to FIG. 22B, for example, the service screen 2200 of the payment application may include a virtual card 2232 and recommended card information 2230. For example, if the card change event occurs, the processor 120 may select, as the recommended card, the electronic card of which the priority is one level lower than the priority of the recommended card that is displayed on the display 160. The processor 120 may control the display 160 to display the recommended card information 2230 that is selected in response to the card change event. For example, the recommended card information 2230 may contain at least one of the card identification information (e.g., the name or number), the discount terms (e.g., a 1% discount and a 7% discount for the purchase of $100 or more), or the payment limit (e.g., $3,900).

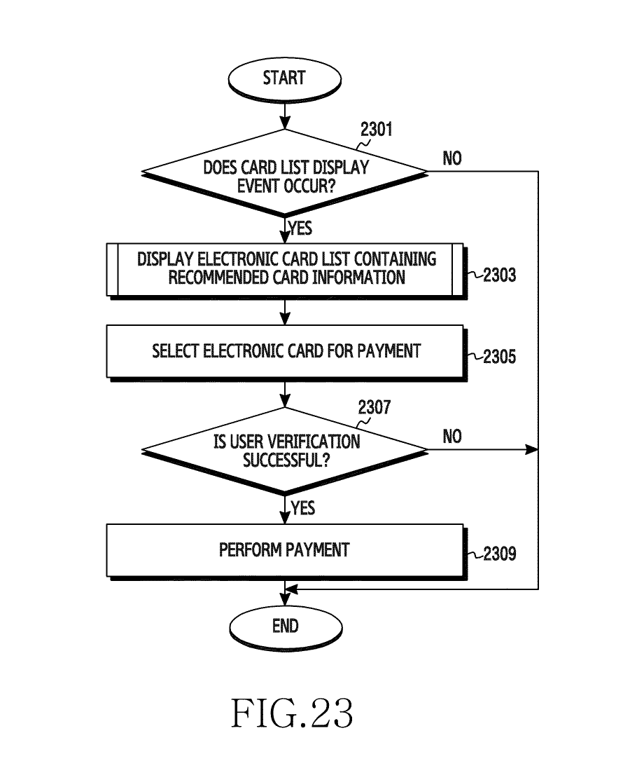

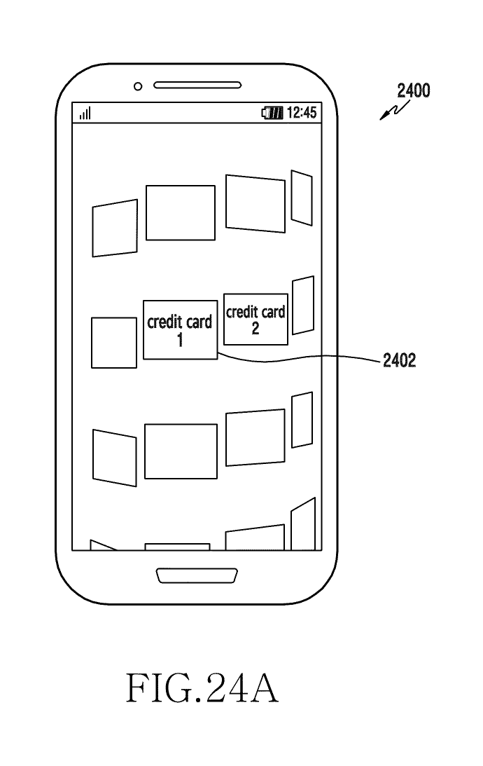

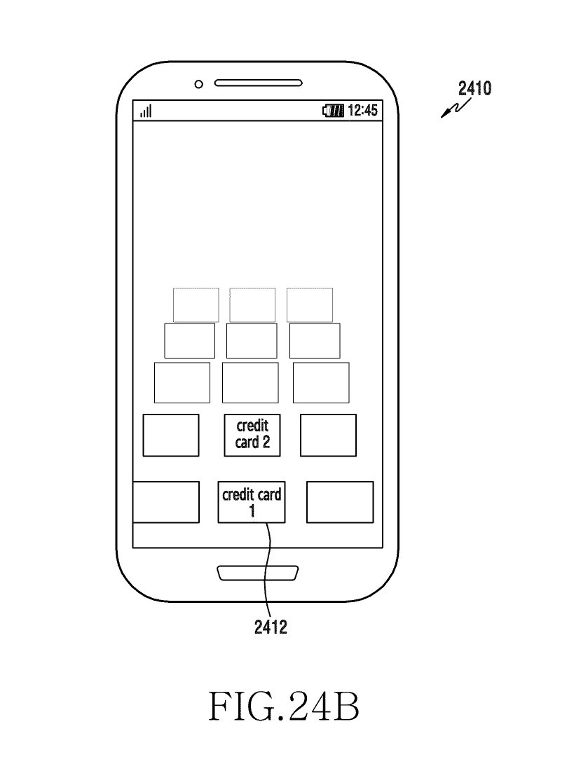

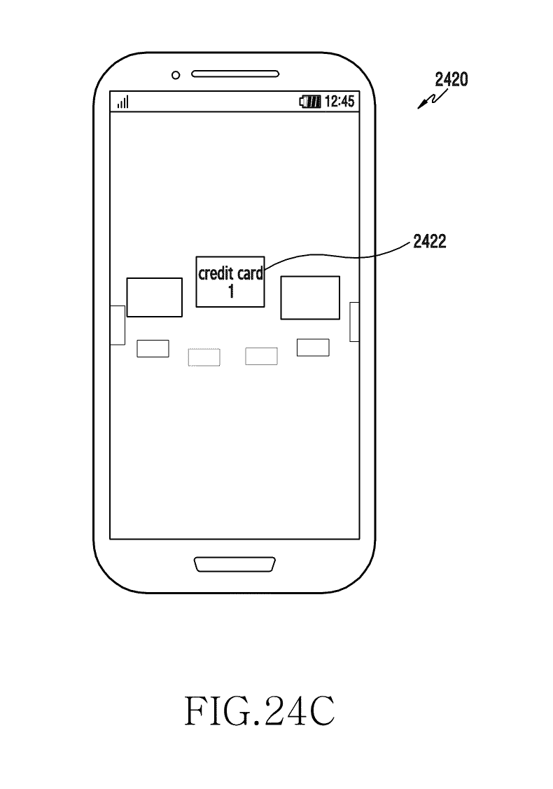

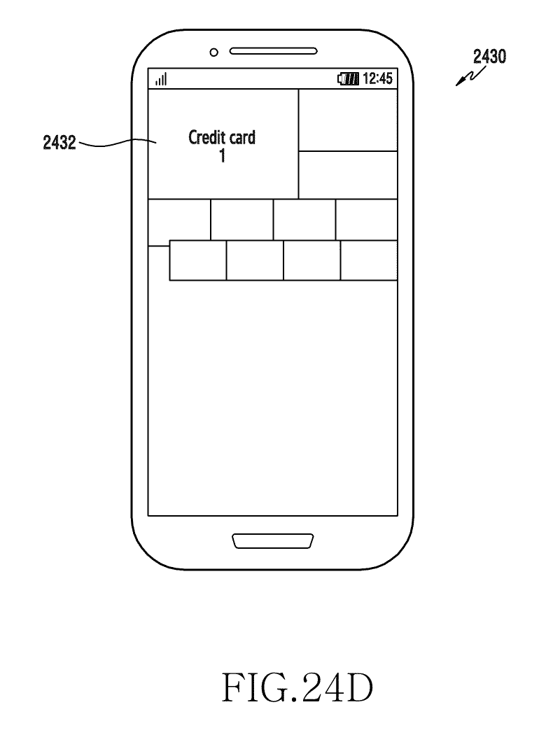

FIG. 23 illustrates a flowchart for providing an electronic card list in an electronic device according to various embodiments of the present disclosure. FIGS. 24A to 24D illustrate screen configurations for displaying an electronic card list in an electronic device according to various embodiments of the present disclosure. The following description will be made of the operation for displaying the electronic card list by using the screen configuration of FIGS. 24A to 24D. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 23, in operation 2301, the electronic device may identify whether a card list display event for displaying an electronic card list occurs. For example, the processor 120 may identify whether the card list display event occurs during the execution of the payment application. For example, the card list display event may be created by at least one of a selection input for a card list display icon, the detection of a gesture that matches the card list display event, or the detection of the movement of the electronic device 101, which matches the card list display event.

In operation 2303, when the card list display event occurs, the electronic device may display, on the display, the electronic card list that contains one or more pieces of recommended card information.

Referring to FIG. 24A, for example, the processor 120 may control the display 160 to display one or more electronic cards, which are registered in the electronic device 101, in a spiral array type 2400. The processor 120 may differently set the graphic variables (e.g., colors, sizes, shadows, transparency, or frame lines) such that one or more pieces of recommended card information, which is selected based on at least one of the electronic card information, the payment history, or the location information, are distinguished from other cards (2402).

Referring to FIG. 24B, for example, the processor 120 may control the display 160 to display one or more electronic cards, which are registered in the electronic device 101, in a matrix array type 2410. The processor 120 may differently set the graphic variables such that one or more pieces of recommended card information, which is selected based on at least one of the electronic card information, the payment history, or the location information, are distinguished from other cards (2412). For example, the matrix array type 2410 may include a card array type in which respective lines for display the electronic cards are differently displayed in at least one of the size, the transparency, the clarity, the shade, or the frame lines of the card in order to provide the perspective of the electronic card list.

Referring to FIG. 24C, for example, the processor 120 may control the display 160 to display one or more electronic cards, which are registered in the electronic device 101, in a three dimensional ring array type 2420. The processor 120 may differently set the graphic variables such that one or more pieces of recommended card information, which is selected based on at least one of the electronic card information, the payment history, or the location information, are distinguished from other cards (2422). For example, the three dimensional ring array type 2420 may display back side information of one or more other electronic cards, except for the recommended card information.

Referring to FIG. 24D, for example, the processor 120 may control the display 160 to display one or more electronic cards, which are registered in the electronic device 101, in a tiled array type 2430. The processor 120 may differently set the graphic variables such that one or more pieces of recommended card information, which is selected based on at least one of the electronic card information, the payment history, or the location information, are distinguished from other cards (2432). For example, the processor 120 may control the display 160 to display one or more electronic cards, which are registered in the electronic device 101, in either a circular array type or a fence-shaped array type. Additionally or alternatively, if another card is moved to the recommended card area based on input information (e.g., a dragging input), which is detected through the input/output interface 150, the processor 120 may configure the corresponding card to be the recommended card.

In operation 2305, the electronic device may select one or more electronic cards that have been used for the payment service from the electronic card list. For example, the processor 120 may select, as the electronic card to be used for the payment service, the electronic card that is touched by the user from among the electronic card list displayed on the display 160.

In operation 2307, the electronic device may identify whether the user authentication has been successful in order to provide the payment service by using one or more electronic cards. For example, the processor 120 may identify whether the user authentication has been successful based on biometric information (e.g., the fingerprint or iris) that is obtained through the biometric recognition sensors or based on a password that is obtained through the input/output interface 150.

If the user authentication has failed, the electronic device may terminate the present algorithm to provide the payment service. For example, the processor 120 may output authentication failure information through at least one of a graphic, a sound, or light.

If the user authentication has been successful, the electronic device may perform the payment by using one or more electronic cards that are selected for the payment service in operation 2309. For example, the processor 120 may perform the payment by using at least one payment scheme among the MST scheme, the NFC scheme, or the bar code scheme.

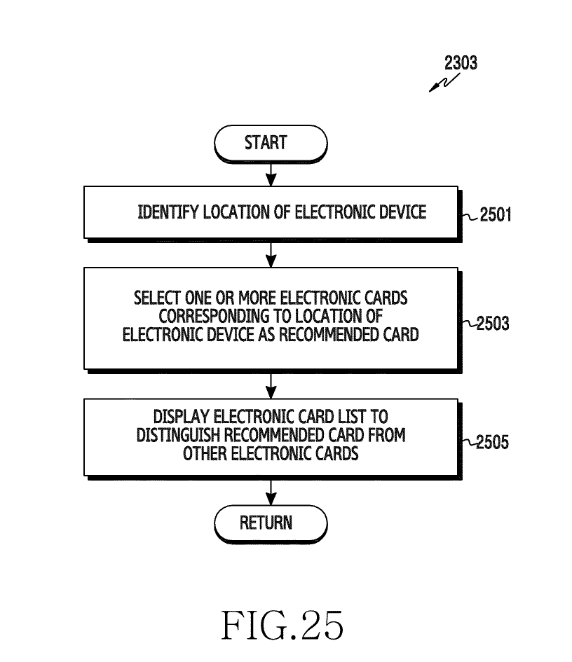

FIG. 25 illustrates a flowchart for providing card information selected based on location information in an electronic device according to various embodiments of the present disclosure. The following description will be made of the operation for displaying the electronic card list in operation 2303 of FIG. 23. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 25, in operation 2501, when the card list display event occurs (e.g., the operation 2301 of FIG. 23), the electronic device may identify the location of the electronic device. For example, the processor 120 may estimate the location of the electronic device 101 by using positioning techniques (e.g., a GPS or triangulation) of the electronic device. The processor 120 may detect the store information corresponding to the location of the electronic device. For example, the processor 120 may estimate the location of the electronic device 101 (e.g., the store information) by using the location information (e.g., a beacon) that is received through the short-range wireless communication (e.g., BT or BLE).

In operation 2503, the electronic device may select, as the recommended card, one or more electronic cards corresponding to the location information of the electronic device. For example, the processor 120 may select, as the recommended card, one or more electronic cards that have usage histories at the location of the electronic device 101 from among one or more electronic cards that are registered in the payment application (e.g., the electronic device 101). For example, the processor 120 may select, as the recommended card, one or more electronic cards that are available at the location of the electronic device 101 from among one or more electronic cards that are registered in the payment application.

In operation 2505, the electronic device may display, on the display, the electronic card list that contains one or more pieces of recommended card information. For example, the processor 120 may control the display 160 to display the electronic card list in at least one of the spiral array, the circular array, the tiled array, the three dimensional ring array, the fence-shaped array, or the matrix array. In this case, the processor 120 may change the graphic variables (e.g., the color, the size, the shadow, the transparency, or the frame lines) of the recommended card such that the recommended card is distinguished from other cards.

According to various embodiments of the present disclosure, in order to provide the recommended card information corresponding to the location of the electronic device, the electronic device may configure a location-based recommended menu of the electronic card as follows.

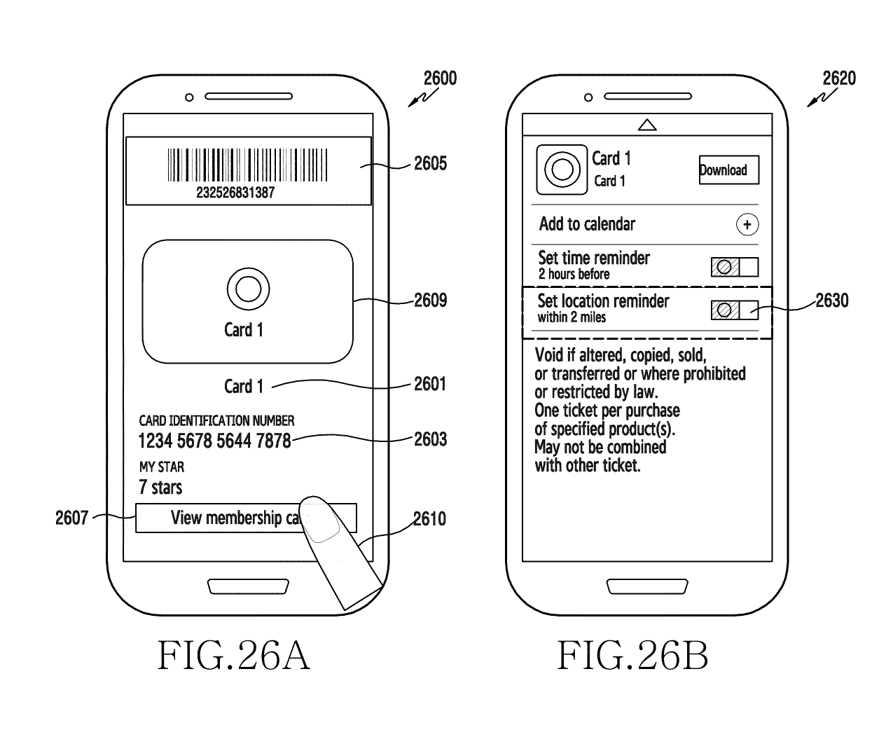

FIGS. 26A and 26B illustrate screen configurations for configuring a menu in order to select an electronic card based on location information in an electronic device according to various embodiments of the present disclosure. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 26A, when the first electronic card is selected, the electronic device may display information 2600 on the first electronic card. For example, the first electronic card information may contain a name 2601 of the first electronic card, a card number 2603, a bar code 2605 corresponding to the first electronic card, a menu 2607, or an icon 2609 of the electronic card.

Referring to FIG. 26B, when detecting a selection input 2610 for the menu 2607 of the first electronic card information 2600, the electronic device may display detailed items 2620 related to the first electronic card. When the electronic device is to provide the first electronic card information based on the location of the electronic device, the electronic device may configure a location providing menu 2630 to be in the active state among the detailed items 2620 related to the first electronic card. Accordingly, in the case where the electronic device is located in the place related to the first electronic card, the electronic device may display the first electronic card information on the display.

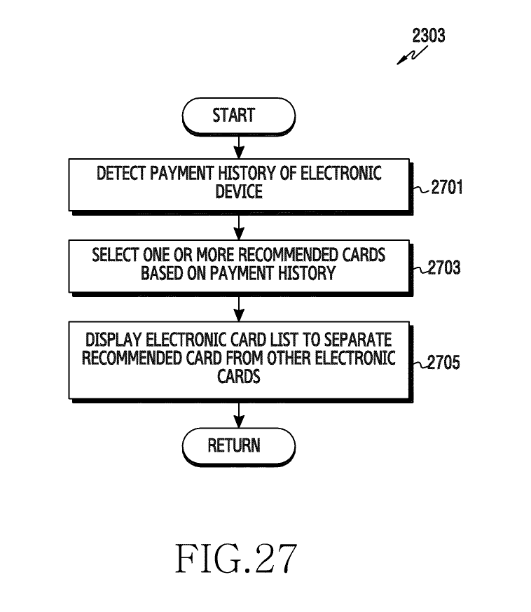

FIG. 27 illustrates a flowchart for providing card information that is selected based on a payment history in an electronic device according to various embodiments of the present disclosure. The following description will be made of the operation for displaying the electronic card list in operation 2303 of FIG. 23. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 27, in operation 2701, when the card list display event occurs (e.g., the operation 2301 of FIG. 23), the electronic device may detect the payment history of the electronic device. For example, the processor 120 may detect the payment history that contains at least one of the transaction date and time, the electronic card information, or the transaction amount in relation to the payment that has been previously performed in the electronic device 101. For example, the processor 120 may detect the payment history of the electronic device 101 from the memory 130 or the external devices (e.g., the payment server or the financial server).

In operation 2703, the electronic device may select, as the recommended card, one or more electronic cards based on the payment history. For example, the processor 120 may select one or more recommended cards based on the payment histories (e.g., the number of usage times, the usage location, the used amount, and the like) of one or more electronic cards that are registered in the electronic device 101 (e.g., the payment application).

In operation 2705, the electronic device may display, on the display, the electronic card list such that at least one piece of the recommended card information is distinguished from other cards. For example, the processor 120 may display the recommended card to be distinct from other cards by using graphic factors of the recommended card in the electronic card list. For example, the display 160 may display the electronic card list in at least one of the spiral array, the circular array, the tiled array, the three dimensional ring array, the fence-shaped array, or the matrix array.

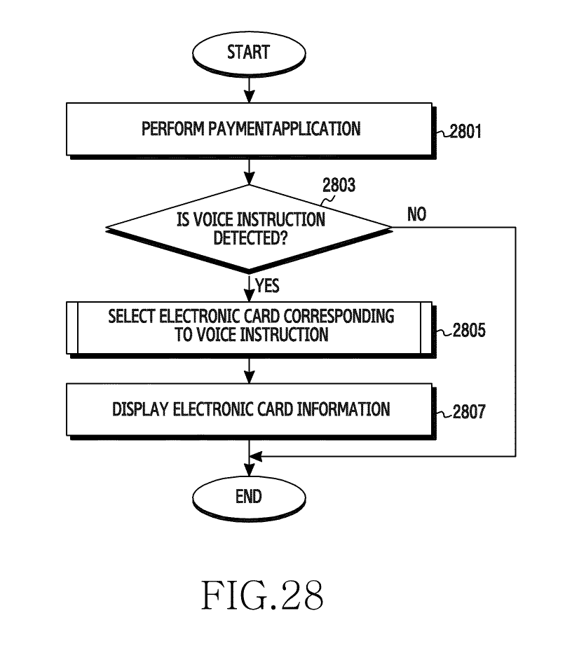

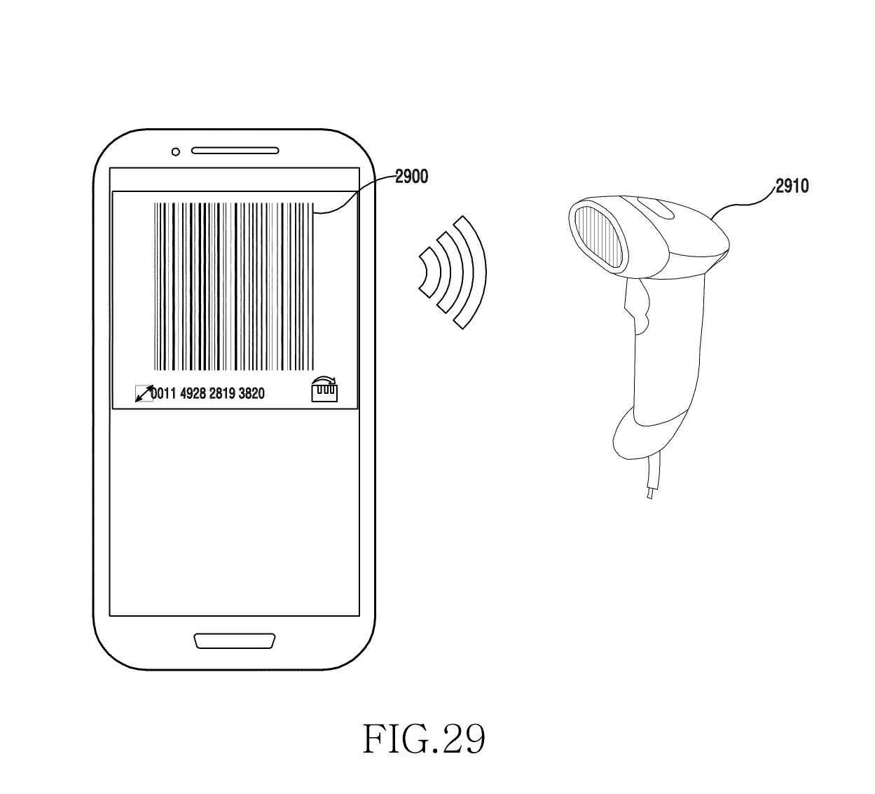

FIG. 28 illustrates a flowchart for providing an electronic card based on a voice instruction in an electronic device according to various embodiments of the present disclosure. FIG. 29 illustrates a screen configuration for displaying an electronic card that is selected based on a voice instruction in an electronic device according to various embodiments of the present disclosure. The following description will be made of the operation of displaying the electronic card information by using the screen configuration of FIG. 29. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 28, in operation 2801, the electronic device may execute the payment application. For example, the processor 120 may control the display 160 to display a service screen of the payment application in response to the occurrence of the execution event of the payment application.

In operation 2803, the electronic device may identify whether a voice instruction for selecting the electronic card is detected while the payment application is in progress. For example, the processor 120 may identify whether the voice instruction for selecting the electronic card, such as “Inform me of my membership card! ”, “Where is the mart membership number?”, or “Find discount coupons!”, is detected while the payment application is in progress. For example, if the voice instruction, which is obtained through the microphone, contains a certain instruction (e.g., the membership card, the membership number, the discount coupon, and the like) for selecting the card, the processor 120 may determine that the voice instruction for selecting the electronic card has been detected.

In operation 2805, when the voice instruction for selecting the electronic card is detected, the electronic device may select one or more electronic cards corresponding to the voice instruction from among one or more electronic cards that are registered in the electronic device. For example, the electronic cards registered in the electronic device may include one or more electronic cards that are registered in the payment application of the electronic device.

In operation 2807, the electronic device may display, on the display, the electronic card information corresponding to the voice instruction.

Referring to FIG. 29, for example, if the electronic card information corresponding to the voice instruction is the membership card, the processor 120 may control the display 160 to display a bar code 2900 corresponding to the membership card which can be scanned with a scanner 2910. Additionally or alternatively, the display 160 may further display the image, the card number, or the membership grade of the membership card.

According to various embodiments of the present disclosure, if there is no electronic card corresponding to the voice instruction among one or more electronic cards that are registered in the electronic device, the electronic device may extract the payment-related information (e.g., the discount coupon information) corresponding to the voice instruction, and may display the same on the display. For example, the electronic device may obtain the payment-related information corresponding to the voice instruction from the memory of the electronic device or from the external device.

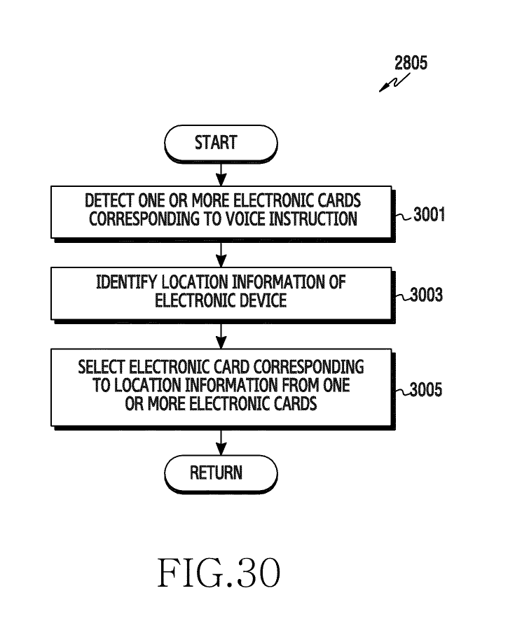

FIG. 30 illustrates a flowchart for selecting an electronic card based on a voice instruction and location information in an electronic device according to various embodiments of the present disclosure. The following description will be made of the operation for selecting the electronic card in operation 2805 of FIG. 28. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 30, in operation 3001, when the electronic device detects the voice instruction for selecting the electronic card (e.g., the operation 2803 of FIG. 28), the electronic device may detect one or more electronic cards corresponding to the voice instruction among one or more electronic cards that are registered in the electronic device. For example, the processor 120 may detect one or more electronic cards corresponding to the voice instruction (e.g., the membership card, the membership number, or the discount coupons) for selecting the card from among one or more electronic cards that are registered in the payment application of the electronic device 101.

In operation 3003, the electronic device may identify the location of the electronic device for the selection of the electronic card. For example, the processor 120 may estimate information on the store where the electronic device 101 is located through the location estimation for the electronic device 101. For example, the processor 120 may receive the location information, in which the electronic device 101 is located (e.g., the store information), through the short-range wireless communication (e.g., BT or BLE).

In operation 3005, the electronic device may select one or more electronic cards corresponding to the location information of the electronic device from among one or more electronic cards corresponding to the voice instruction. For example, the processor 120 may select one or more electronic cards that are available at the location of the electronic device 101 from among one or more electronic cards corresponding to the voice instruction. For example, the processor 120 may select one or more electronic cards that have usage histories at the location of the electronic device 101 from among one or more electronic cards corresponding to the voice instruction.

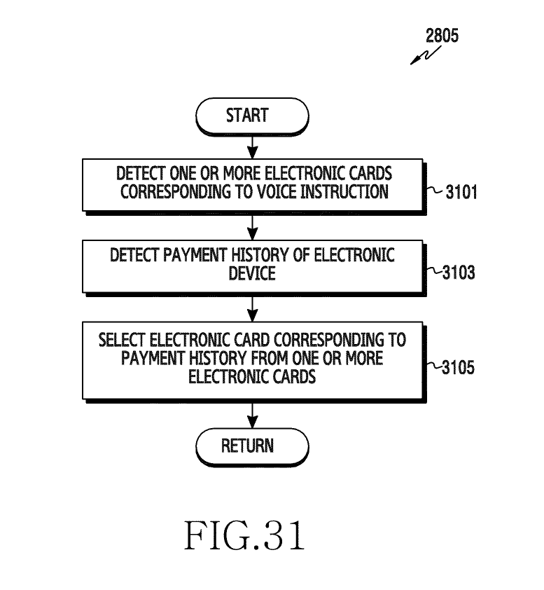

FIG. 31 illustrates a flowchart for selecting an electronic card based on a voice instruction and a payment history in an electronic device according to various embodiments of the present disclosure. The following description will be made of the operation for selecting the electronic card in operation 2805 of FIG. 28. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 31, in operation 3101, when the electronic device detects a voice instruction for selecting the electronic card (e.g., the operation 2803 of FIG. 28), the electronic device may detect one or more electronic cards corresponding to the voice instruction among one or more electronic cards that are registered in the electronic device. For example, when the processor 120 detects the voice instruction during the execution of the payment application, the processor 120 may detect a command for selecting the electronic card from the voice instruction. The processor 120 may detect one or more electronic cards corresponding to the command for selecting the electronic card from among one or more electronic cards that are registered in the payment application of the electronic device 101.

In operation 3103, the electronic device may detect the payment history of the electronic device. For example, the processor 120 may detect the payment histories for one or more electronic cards corresponding to the voice instruction. For example, the processor 120 may detect the payment information that has been previously performed through the payment application of the electronic device 101.

In operation 3105, the electronic device may select the recommended card from among one or more electronic cards corresponding to the voice instruction based on the payment history. For example, the processor 120 may select one or more recommended cards based on the payment histories (e.g., the number of usage times, the usage location, the used amount, and the like) of one or more electronic cards corresponding to the voice instruction. For example, the processor 120 may select, as the recommended card, one or more electronic cards that have the usage histories from among one or more electronic cards corresponding to the voice instruction based on the payment history of the electronic device 101.

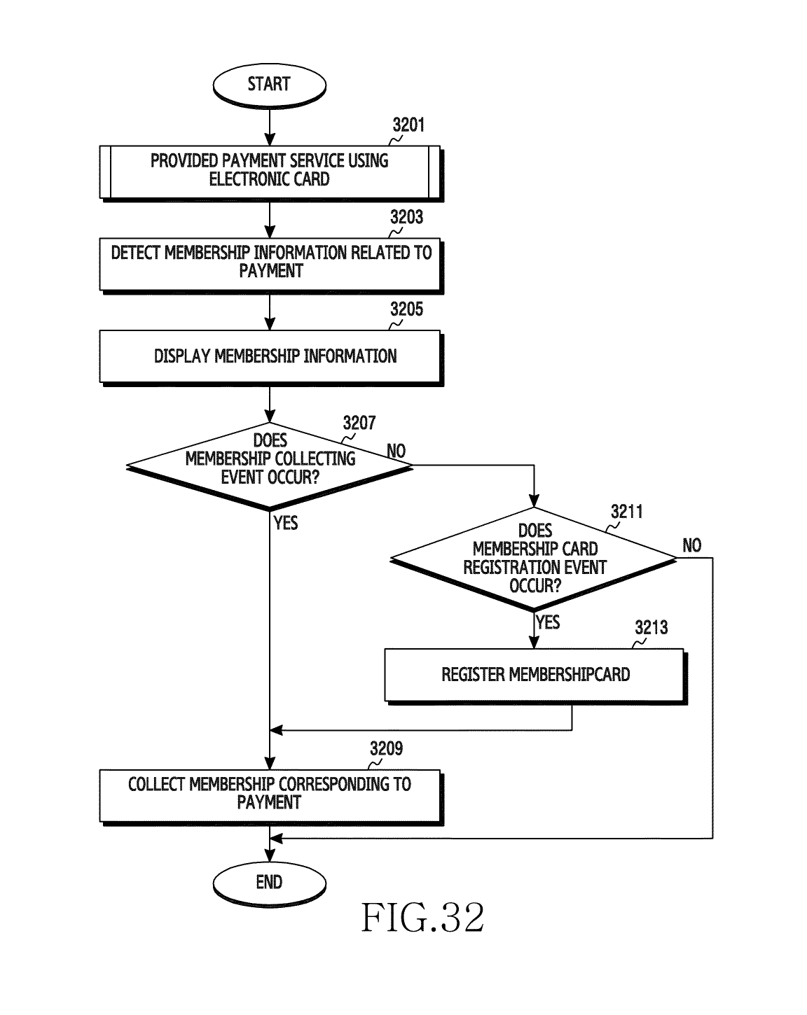

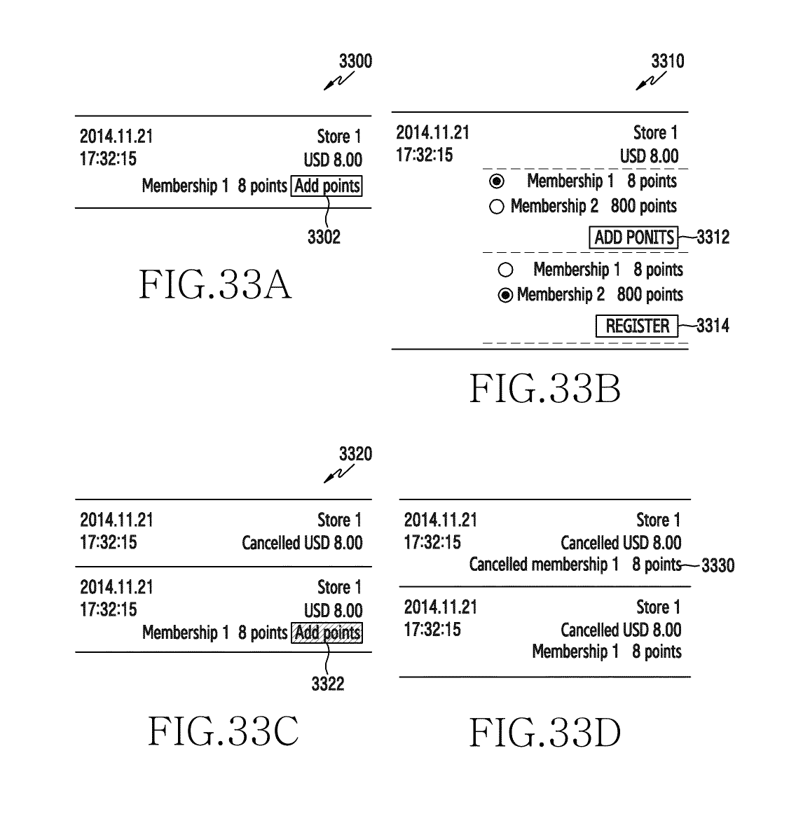

FIG. 32 illustrates a flowchart for providing membership information in an electronic device according to various embodiments of the present disclosure. FIGS. 33A to 33D illustrate screen configurations for displaying membership information in an electronic device according to various embodiments. The following description will be made of the operation for displaying the membership information by using the screen configuration of FIGS. 33A to 33D. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 32 of the present disclosure, in operation 3201, the electronic device may provide the payment service by using the electronic card. For example, the processor 120 may provide the payment service by using the recommended card as shown in operation 1701 to operation 1711 of FIG. 17. For example, the processor 120 may provide the payment service by using one or more electronic cards that are selected from the electronic card list as shown in operation 2301 to 2309 of FIG. 23. For example, the processor 120 may provide the payment service by using the electronic card corresponding to the voice instruction as shown in operation 2801 to operation 2807 of FIG. 28.

In operation 3203, the electronic device may detect the membership information that is related to the payment. For example, the processor 120 may select one or more membership cards corresponding to the electronic card, which has been used for the payment, or corresponding to the payment location from among one or more membership cards that are registered in the payment application of the electronic device 101. For example, the processor 120 may extract one or more pieces of membership information, which can be collected, to correspond to the electronic card, which has been used for the payment, or the payment location. For example, the processor 120 may obtain the membership information related to the payment through the memory 130 or the external device.

In operation 3205, the electronic device may display, on the display, the membership information related to the payment.

Referring to FIG. 33A, for example, the processor 120 may control the display 160 to display membership card information 3300 that is registered in the electronic device 101 that can collect the membership (e.g., points) in relation to the payment. The membership card information 3300 may contain a menu (e.g., “ADD POINT”) 3302 for the collection of the membership.

Referring to FIG. 33B, for example, a menu 3302 for collecting the membership may include link information for the collection of the membership. For example, the processor 120 may control the display 160 to display a plurality of pieces of membership card information 3310 by which the payment-related membership (e.g., points) can be collected. The membership card information 3310 may include a menu 3312 for collecting the membership and a menu (e.g., “REGISTER”) 3314 for registering the membership card. For example, the menu 3314 for the membership card registration may contain link information on the site for the membership card registration.

In operation 3207, the electronic device may identify whether a membership collecting event occurs. For example, the processor 120 may identify whether a selection input for the “ADD POINT” menu 3302 is detected in the membership card information 3300 that is displayed on the display 160 as shown in diagram FIG. 33A. For example, if the selection input for the “ADD POINT” menu 3302 is detected, the processor 120 may determine that the membership collecting event has occurred.

In operation 3209, if the membership collecting event occurs, the electronic device may collect the membership (e.g., points) corresponding to the membership card payment. For example, if the payment of $8 is made as shown in diagram FIG. 33A, the processor 120 may add the points corresponding to $8 to membership card 1.

In operation 3211, if the membership collecting event does not occur, the electronic device may identify whether the membership card registration event occurs. For example, the processor 120 may detect a selection input for the “REGISTER” menu 3314 in the membership card information 3310 that is displayed on the display 160 as shown in diagram FIG. 33B. For example, if the selection input for the “REGISTER” menu 3314 is detected, the processor 120 may determine that the membership card registration event has occurred.

In operation 3213, if the membership card registration event occurs, the electronic device may register the corresponding membership card in the electronic device. For example, if the membership card registration event occurs, the processor 120 may provide a UI for the membership card registration. The processor 120 may register the membership card in the payment application of the electronic device 101 based on the information related to the membership card, which is input through the UI for the membership card registration.

In operation 3209, when the membership card is registered, the electronic device may collect the membership (e.g., points) corresponding to the membership card payment. For example, if membership card 2 is registered as shown in diagram FIG. 33B, the processor 120 may add the points corresponding to $8 to membership card 2.

According to various embodiments of the present disclosure, if the payment is cancelled, the electronic device may update the membership information to correspond to the payment cancellation.

Referring to FIGS. 33C and 33D, for example, the processor 120 may display the menu (e.g., “ADD POINT”) 3322 for collecting the membership to be in the inactive state, or may eliminate the display of the menu 3322 for collecting the membership in membership card information 3320 related to the corresponding payment. For example, the processor 120 may additionally display the cancellation information 3330 of the membership in relation to the corresponding payment.

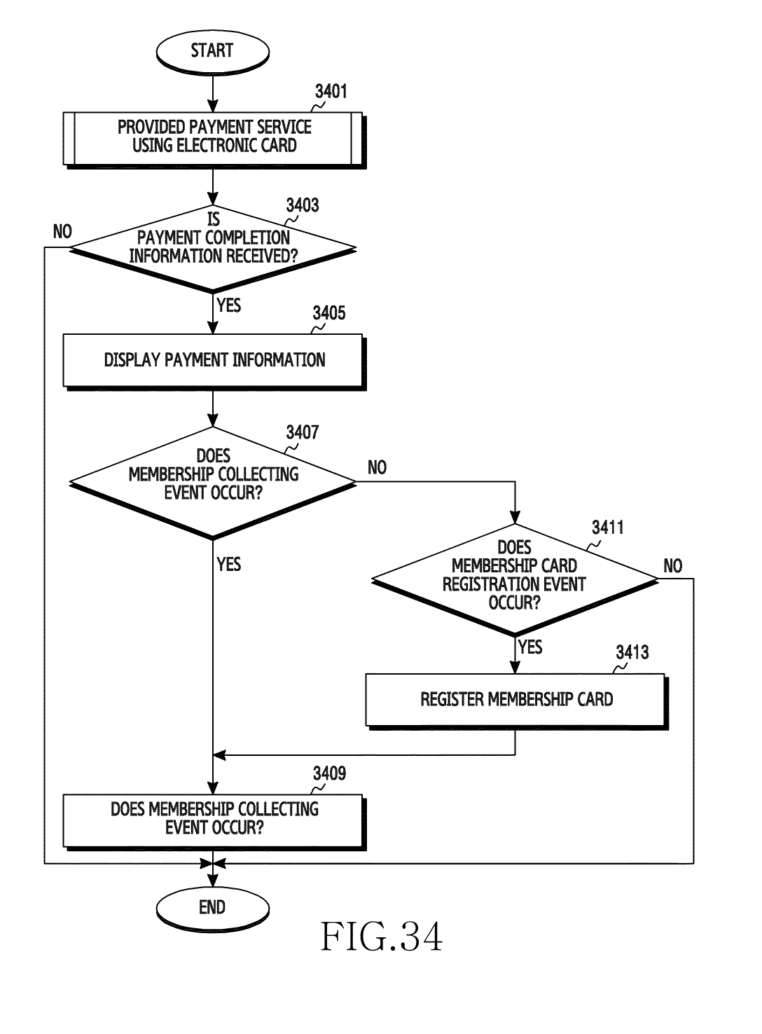

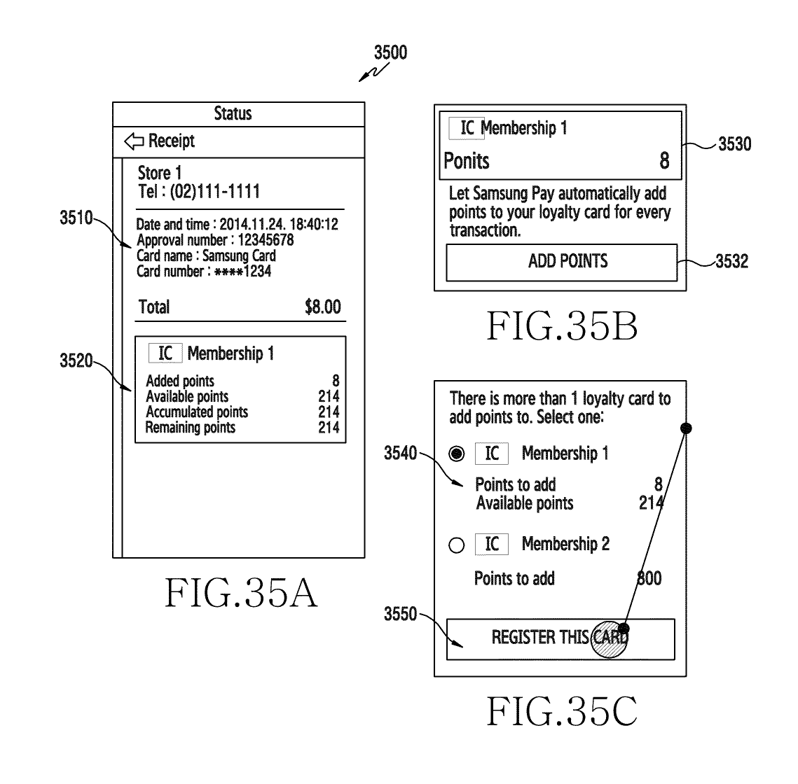

FIG. 34 illustrates a flowchart for providing payment information in an electronic device according to various embodiments of the present disclosure. FIGS. 35A to 35C illustrate screen configurations of payment information in an electronic device according to various embodiments of the present disclosure. The following description will be made of the operation for displaying the payment information by using the screen configuration of FIGS. 35A to 35C. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIG. 34, in operation 3401, the electronic device may provide the payment service by using the electronic card. For example, the processor 120 may provide the payment service by using one or more electronic cards as shown in operation 1701 to operation 1711 of FIG. 17, operation 2301 to operation 2309 of FIG. 23, or operation 2801 to operation 2807 of FIG. 28.

In operation 3403, the electronic device may identify whether payment completion information for the payment service is received. For example, the processor 120 may identify whether the payment completion information is received from the payment server 620 or the financial server 640.

In operation 3405, when the payment completion information is received, the electronic device may display the payment information for the payment service on the display.

Referring to FIG. 35A, for example, the processor 120 may control the display 160 to display a receipt 3500 containing the transaction information. For example, the receipt 3500 may contain the transaction information 3510 that contains at least one of the transaction date and time, the approval number, the electronic card information, the transaction amount, or the membership information. Additionally or alternatively, the receipt 3500 may further contain membership information 3520 corresponding to the transaction information.

Referring to FIG. 35B, for example, the membership information 3520 may contain one or more pieces of membership card information 3530 corresponding to the transaction information among one or more membership cards that are registered in the payment application of the electronic device 101.

Referring to FIG. 35C, for example, the membership information 3520 may contain a plurality of pieces of membership card information 3540 that can be collected to correspond to the transaction information.

In operation 3407, the electronic device may identify whether the membership collecting event occurs. For example, the processor 120 may identify whether a selection input for the menu 3532 (“ADD POINT”) for collecting the membership is detected in the membership information 3530 that is displayed on the display 160 as shown in diagram FIG. 35B. For example, if the selection input for the “ADD POINT” 3532 is detected, the processor 120 may determine that the membership collecting event has occurred.

In operation 3409, if the membership collecting event occurs, the electronic device may collect the membership (e.g., points) corresponding to the membership card payment. For example, the processor 120 may add 8 points corresponding to the transaction information to membership card 1.

In operation 3411, if the membership collecting event does not occur, the electronic device may identify whether the membership card registration event occurs. For example, the processor 120 may detect whether a selection input for the menu (“REGISTER”) 3550 for the membership card registration is detected in the membership information 3540 that is displayed on the display 160 as shown in diagram FIG. 35C. For example, if the selection input for the “REGISTER” 3550 is detected, the processor 120 may determine that the membership card registration event has occurred.

In operation 3413, if the membership card registration event occurs, the electronic device may register the corresponding membership card in the electronic device. For example, if the membership card registration event occurs, the processor 120 may register the membership card in the payment application of the electronic device 101 through the UI for the membership card registration.

In operation 3409, when the membership card is registered, the electronic device may collect the membership (e.g., points) corresponding to the membership card payment.

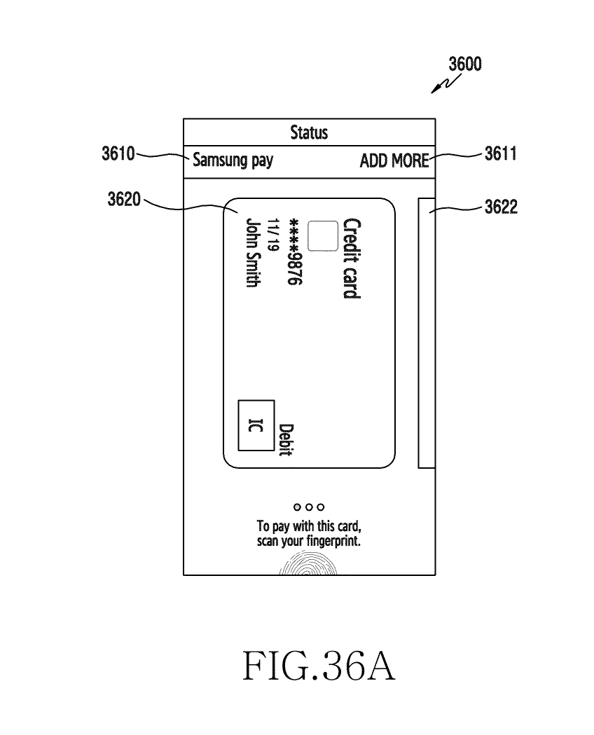

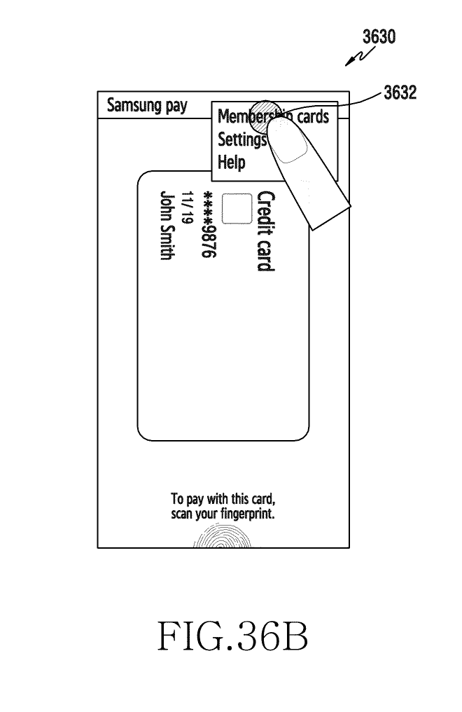

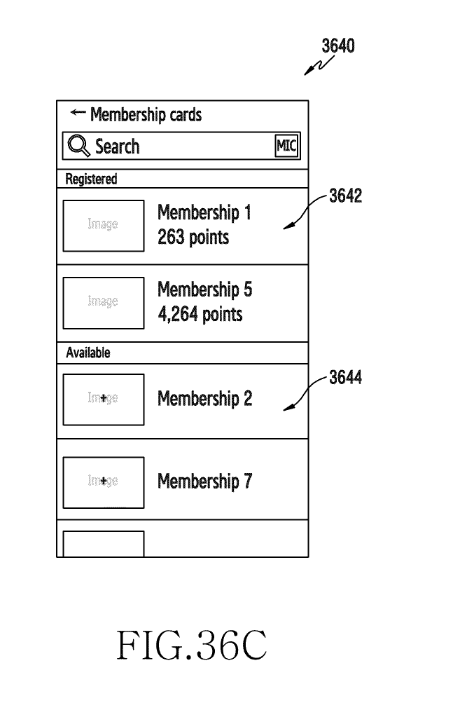

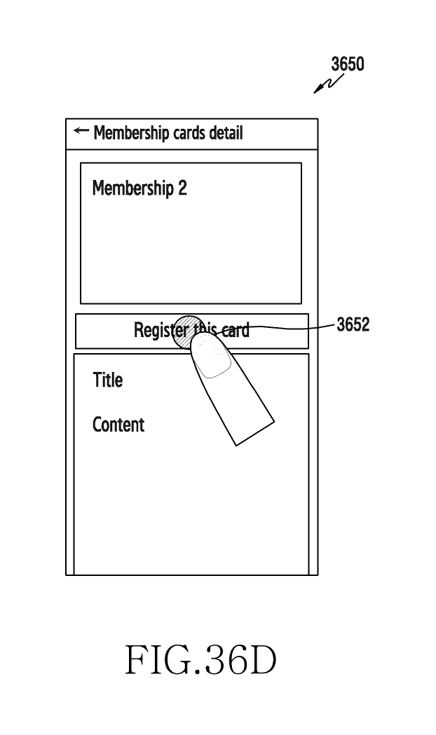

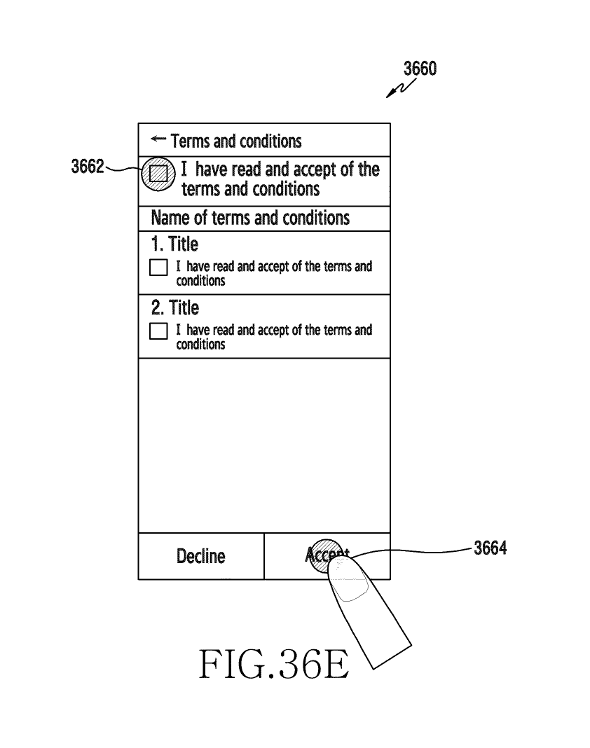

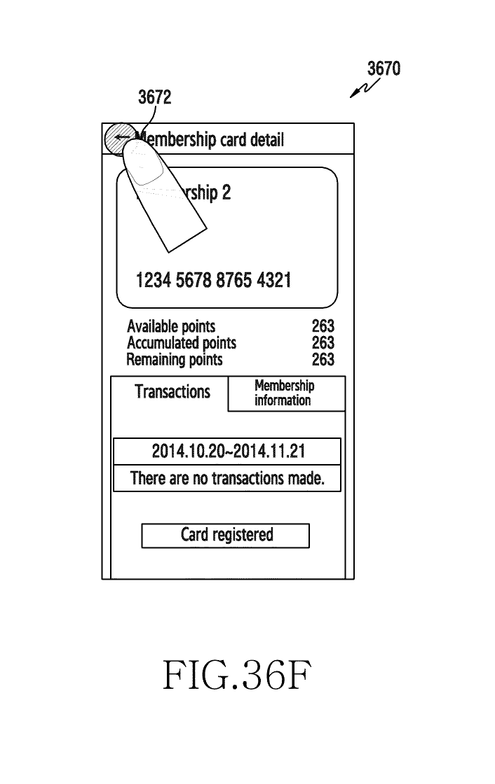

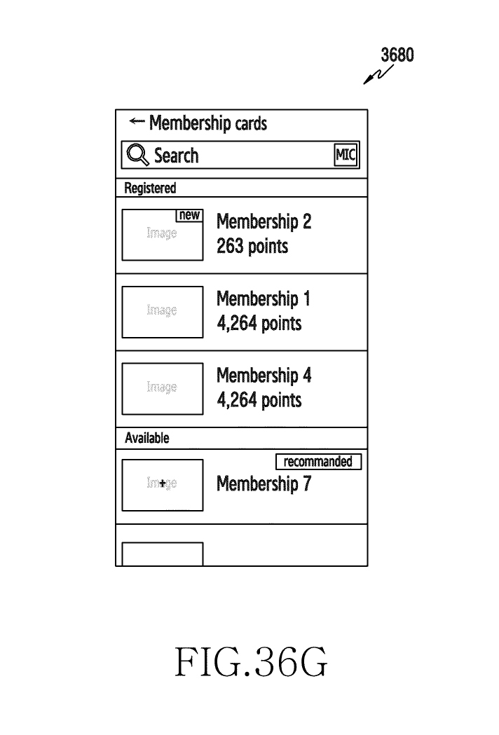

FIGS. 36A to 36G illustrate a UI for registering a membership card in an electronic device according to various embodiments of the present disclosure. According to one embodiment of the present disclosure, the electronic device may include the electronic device 101 of FIG. 1, the electronic device 201 of FIG. 2, at least some (e.g., the processor 120) of the electronic device 101, or at least some (e.g., the processor 210) of the electronic device 201.

Referring to FIGS. 36A to 36G, the electronic device may execute the payment application based on the user input. For example, when a user input of sweeping from the bottom bezel area to the display occurs, the processor 120 may execute the payment application. The processor 120 may display, through the display 160, electronic card information 3600 on one or more electronic cards among the electronic cards that are registered in the electronic device 101 as shown in FIG. 36A. For example, the electronic card information 3600 may contain a menu 3610, a first electronic card icon 3620, and a second electronic card icon 3622.

According to one embodiment of the present disclosure, the menu 3610 may contain application identification information (e.g., the name) and a detailed item (MORE) 3611 that is related to the configuration of the application. For example, when the processor 120 detects a selection input for the detailed item (MORE) 3611, the processor 120 may display an additional menu 3630 for operating virtual cards as shown in FIG. 36B.

According to one embodiment of the present disclosure, the first electronic card icon 3620 may include a specified card. For example, the first electronic card icon 3620 may include an icon that corresponds to the electronic card that has most recently been used. For example, the first electronic card icon 3620 may include an icon that corresponds to the recommended card that is selected based on at least one of the transaction merchandise information, the electronic card information, the payment history, or the location information.

According to one embodiment of the present disclosure, the second electronic card icon 3622 may include a card that is to be changed in response to the card change event. For example, the second electronic card icon 3622 may include an icon that corresponds to the electronic card that has most recently been used after the electronic card corresponding to the first electronic card icon. For example, the second electronic card icon 3622 may include an icon that corresponds to the electronic card of which the recommendation priority is one level lower than the recommendation priority of the electronic card corresponding to the first electronic card icon.

According to one embodiment of the present disclosure, when the electronic device detects a selection input for a membership card registration menu 3632 in the additional menus 3630 of FIG. 36B, the electronic device may display a membership card list 3640 as shown in FIG. 36C. For example, the membership card list 3640 may separately include a list 3642 of the membership cards that are registered in the electronic device 101 and a list 3644 of the membership cards that can be registered in the electronic device 101.

According to one embodiment of the present disclosure, when the electronic device detects a selection input for membership card 3 from among the membership card list 3644 of FIG. 36C, which can be registered (3646), the electronic device may display a detailed information screen 3650 of membership card 3 through the display 160 as shown in FIG. 36D. For example, the detailed information screen 3650 of membership card 3 may contain the icon of membership card 3, the name of membership card 3, a link address related to the registration, and a registration configuration menu. For example, the registration configuration menu may match the link address related to the registration.

According to one embodiment of the present disclosure, when the electronic device detects a selection input for the registration configuration menu in the detailed information screen 3650 of membership card 3 in FIG. 36D (3652), the electronic device may display, on the display 160, a terms-and-conditions screen 3660 of membership card 3 as shown in FIG. 36E. For example, the terms-and-conditions screen 3660 may contain the terms and conditions for using membership card 3 and information 3662 for selecting whether the user agrees to the corresponding terms and conditions. For example, at least some of the information constituting the terms-and-conditions screen 3660 may be obtained from the payment server 620 or the financial server 640.

According to one embodiment of the present disclosure, when the electronic device detects a selection input for an approval menu in the terms-and-conditions screen 3660 of Membership Card 3 in FIG. 36E in operation 3664, the electronic device may identify whether the user agrees to the terms and conditions. If the user agrees to the terms and conditions, the electronic device may display additional information 3670 on Membership Card 3 through the display 160 as shown in FIG. 36F.

For example, if the user agrees to the terms and conditions, the electronic device may obtain the additional information on Membership Card 3 from the payment server 620 or the financial server 640, and may display the same on the display. For example, the additional information on Membership Card 3 may contain the number for Membership Card 3, the collected points, the remaining points, or the used points, which is registered in the electronic device.

According to one embodiment of the present disclosure, when the electronic device detects a selection input for the membership list display menu in the additional information 3670 of Membership Card 2 in FIG. 36F in operation 3672, the electronic device may add Membership Card 2 to the membership card list that is registered in the electronic device 101, and may display the same on the membership list display menu 3680 as shown in FIG. 36G.

According to various embodiments of the present disclosure, a method of operating an electronic device, which includes a display, an input device, a user authentication device, a conductive pattern configured to transmit a magnetic signal to an external payment device, a first communication circuit electrically connected to the conductive pattern, a second communication circuit configured to provide cellular and/or short-range communication, a memory, and a processor, may include receiving a first user input through the input device, displaying, after receiving the first user input, in a selected array, a plurality of images representing a plurality of payment cards used for the payment by using the first communication circuit such that at least one of the plurality of images is greater than other images, receiving a second user input for selecting one of the plurality of images, receiving user authentication information through the user authentication device, and transmitting, based on, at least in part, the second user input and the authentication information, a magnetic signal, which is generated based on token information, to the external payment device through the first communication circuit and the conductive pattern.

According to various embodiments of the present disclosure, the method may further include selecting the payment card displayed by the one or more images based on, at least in part, a payment history of the user and/or information received from the outside through the second communication circuit.

According to various embodiments of the present disclosure, a method of operating an electronic device, which includes a display, an input device, a user authentication device, a conductive pattern configured to transmit a magnetic signal to an external payment device, a first communication circuit electrically connected to the conductive pattern, a second communication circuit configured to provide cellular and/or short-range communication, a memory, and a processor, may include receiving a first user input through the input device, receiving information on the transaction merchandise and/or the payment card through the second communication circuit, selecting, after receiving the first user input, one of a plurality of payment cards based on, at least in part, the received information and/or a payment history, displaying the selected card on the display, receiving user authentication information through the authentication device, and transmitting, after receiving the authentication information, a magnetic signal, which is generated based on the token information, to the external payment device through the first communication circuit and the conductive pattern.

According to various embodiments of the present disclosure, a method of operating an electronic device, which includes a display, an input device, a user authentication device, a conductive pattern configured to transmit a magnetic signal to an external payment device, a first communication circuit electrically connected to the conductive pattern, a second communication circuit configured to provide cellular and/or short-range communication, a memory, and a processor, may include receiving a first user input through the input device, receiving user authentication information through the authentication device, transmitting, after receiving the authentication information, a magnetic signal, which is generated based on token information, to the external payment device through the first communication circuit and the conductive pattern, receiving information indicating the completion of the payment through the second communication circuit, displaying, on the display, the first information related to a membership account created based on the information indicating the completion of the payment, receiving a second user input through the input device, and transmitting, in response to the reception of the second user input, the second information related to the membership account through the second communication circuit.

The term “module” used in the present document, for example, may refer to a unit that includes one of hardware, software, or firmware, or a combination thereof. The “module,” for example, may be interchangeably used with the terms, such as a unit, a logic, a logical block, a component, a circuit, and the like. The “modules” may be the minimum unit of a component, which is integrally formed, or a portion thereof. The “module” may be the minimum unit, which performs one or more functions, or a portion thereof. The “module” may be implemented mechanically or electronically. For example, the “module” may include at least one of an application specific integrated circuit (ASIC) chip, a field-programmable gate array (FPGA), or a programmable logic device, which is known or will be developed in the future, and which performs some operations.

At least some of the device (e.g., modules or functions) or the method (e.g., operations), according to various embodiments of the present disclosure, for example, may be implement by instructions that are stored, in the form of a program module, in a computer-readable storage medium. When the instruction is executed by the processor (e.g., the processor 120), one or more processors may perform the function corresponding to the instruction. The computer-readable storage medium, for example, may be the memory 130.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

The module or the program module, according to various embodiments of the present disclosure, may include one or more elements described above, exclude some of them, or further include other elements. The operations performed by the module, the program module, or other elements, according to various embodiments of the present disclosure, may be executed in a sequential, parallel, iterative, or heuristic method. In addition, some operations may be executed in a different order, or may be omitted, or other operations may be added. In addition, the embodiments disclosed in the present document are intended for the explanation and understanding of the technical matter, and shall not limit the scope of the technology described in the present document. Accordingly, the scope of the present disclosure should be construed to encompass all modifications or various other embodiments based on the technical concept of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a housing;
a display exposed on one side of the housing;
an input device integrally formed with the display, mounted on the housing, or wirelessly connected to the electronic device;
a user authentication device integrally formed with the display, or mounted on the housing;
a conductive pattern positioned inside the housing, and configured to transmit a signal to an external transaction device;
a first communication circuit electrically connected to the conductive pattern;
a second communication circuit configured to provide at least one of cellular or short-range communication;
a processor electrically connected to the display, the authentication device, the first communication circuit, and the second communication circuit; and
a memory electrically connected to the processor, and configured to store token information used for payment,
wherein the memory stores instructions that, when executed, cause the processor to:
receive a first user input through the input device,
display, after receiving the first user input, a selected array of a plurality of images representing a plurality of payment cards used for the payment using the first communication circuit, wherein at least one image of the plurality of images is larger in size than other images of the plurality of images,
receive a second user input for selecting one of the plurality of images,
receive user authentication information through the user authentication device, and
transmit, at least partly in response to the second user input and the authentication information, a signal generated based on the token information, to the external transaction device through the first communication circuit and the conductive pattern.

2. The electronic device of claim 1, wherein the selected array comprises one of a spiral array, a circular array, a tiled array, a three dimensional ring array, a fence-shaped array, or a matrix array.

3. The electronic device of claim 2,
wherein the selected array is rendered in 3 dimensions,
wherein the at least one image has a first size, and the other images have a size or sizes smaller than the first size, and/or
wherein the at least one image is laid in front of the other images, and/or laid over a portion of the other images.

4. The electronic device of claim 2, wherein the at least one image is clearer than the other images.

5. The electronic device of claim 2, wherein the other images include the back sides of the corresponding payment cards.

6. The electronic device of claim 2, wherein the tiled array comprises one or more images representing objects that are not payment cards.

7. The electronic device of claim 1, wherein the instructions cause the processor to select the payment card represented by the at least one image, based at least partly on, at least one of a payment history of the user or information received from the outside through the second communication circuit.

8. The electronic device of claim 1,
wherein the input device comprises at least one of a touch panel, a microphone, a home button, or a touch screen, and
wherein the authentication device comprises at least one of a biometric authentication device or at least a part of a touch screen that receives a personal identification number (PIN) input or a pattern input.

9. The electronic device of claim 1, wherein the signal generated based on the token information is a magnetic signal.

10. The electronic device of claim 1, wherein the signal generated based on the token information is in compliance with the NFC protocol.

11. An electronic device comprising:
a housing;
a display exposed on one side of the housing;
an input device integrally formed with the display, mounted on the housing, or wirelessly connected to the electronic device;
a user authentication device integrally formed with the display, or mounted on the housing;
a conductive pattern disposed in the housing, and configured to transmit a signal to an external transaction device;
a first communication circuit electrically connected to the conductive pattern;
a second communication circuit configured to provide at least one of cellular or short-range communication;
a processor electrically connected to the display, the user authentication device, the first communication circuit, and the second communication circuit; and
a memory electrically connected to the processor, and configured to store token information used for payment and information on a plurality of payment cards,
wherein the memory stores instructions that, when executed, cause the processor to:
receive a first user input through the input device,
receive information on at least one of the transaction merchandise or a payment card through the second communication circuit,
select, after receiving the first user input, one of the plurality of payment cards based at least partly on at least one of the received information or a payment history,
display the selected card on the display,
receive user authentication information through the authentication device, and
after receiving the authentication information, transmit a signal generated based on the token information, to the external transaction device through the first communication circuit and the conductive pattern.

12. The electronic device of claim 9, wherein the received information comprises at least one of discount information, subscription information, or membership point information associated with the payment card.

13. The electronic device of claim 11, wherein the signal generated based on the token information is a magnetic signal.

14. The electronic device of claim 11, wherein the signal generated based on the token information is in compliance with the NFC protocol.

15. The electronic device of claim 11, wherein the instructions further cause the processor to:
display, after receiving the first user input, a selected array of a plurality of images representing a plurality of payment cards used for the payment using the first communication circuit, wherein at least one image of the plurality of images is larger in size than other images of the plurality of images.

16. The electronic device of claim 15,
wherein the selected array is rendered in 3 dimensions,
wherein the at least one image has a first size, and the other images have a size or sizes smaller than the first size, and/or
wherein the at least one image is laid in front of the other images, and/or laid over a portion of the other images.

17. An electronic device comprising:
a housing;
a display exposed on one side of the housing;
an input device integrally formed with the display, mounted on the housing, or wirelessly connected to the electronic device;
a user authentication device integrally formed with the display, or mounted on the housing;
a conductive pattern disposed in the housing, and configured to transmit a signal to an external transaction device;
a first communication circuit electrically connected to the conductive pattern;
a second communication circuit configured to provide at least one of cellular or short-range communication;
a processor electrically connected to the display, the user authentication device, the first communication circuit, and the second communication circuit; and
a memory, electrically connected to the processor, and configured to store token information used for payment and information on one or more membership accounts,
wherein the memory stores instructions that, when executed, cause the processor to:
receive a first user input through the input device,
receive user authentication information through the authentication device, transmit, after receiving the authentication information, a signal generated based on the token information, to the external transaction device through the first communication circuit and the conductive pattern,
receive information indicating the completion of payment through the second communication circuit,
display, on the display, first information related to a membership account, the first information having been created based on the information indicating the completion of the payment,
receive a second user input through the input device, and
transmit, in response to the second user input, second information related to the membership account through the second communication circuit.

18. The electronic device of claim 17, wherein the signal generated based on the token information is a magnetic signal.

19. The electronic device of claim 17, wherein the signal generated based on the token information is in compliance with the NFC protocol.

20. The electronic device of claim 17, wherein the instructions further cause the processor to:
display, after receiving the first user input, a selected array of a plurality of images representing a plurality of payment cards used for the payment using the first communication circuit, wherein at least one image of the plurality of images is larger in size than other images of the plurality of images.
